(19) United States
(12) Patent Application Publication
(10) Pub. No.: US 2025/0391951 A1
(43) Pub. Date: Dec. 25, 2025

(54) BI-DIRECTIONAL COOLANT FLOW IN MODULAR AND SCALABLE BATTERY PACKS

(71) Applicant: PACCAR INC, Bellevue, WA (US)

(72) Inventors: Yang CHEN, Bellevue, WA (US); Mingyang JIA, Bellevue, WA (US); Greg W. BONSEN, Bellevue, WA (US)

(21) Appl. No.: 18/992,902

(22) PCT Filed: Jul. 11, 2023
(86) PCT No.: PCT/US2023/027411

§ 371 Date: Jan. 9, 2025

Related U.S. Application Data
(60) Provisional application No. 63/388,608, filed on Jul. 12, 2022.
(60) Provisional application No. 63/388,609, filed on Jul. 12, 2022.
(60) Provisional application No. 63/388,610, filed on Jul. 12, 2022.
(60) Provisional application No. 63/388,612, filed on Jul. 12, 2022.
(60) Provisional application No. 63/388,613, filed on Jul. 12, 2022.
(60) Provisional application No. 63/388,615, filed on Jul. 12, 2022.
(60) Provisional application No. 63/388,616, filed on Jul. 12, 2022.
(60) Provisional application No. 63/388,618, filed on Jul. 12, 2022.
(60) Provisional application No. 63/388,619, filed on Jul. 12, 2022.

(51) Int. Cl. H01M 10/6557; H01M 10/48; H01M 10/613; H01M 10/6568; H01M 50/249; H01M 50/258

(52) U.S. Cl. CPC H01M 10/6557; H01M 10/482; H01M 10/486; H01M 10/613; H01M 10/6568; H01M 50/249; H01M 50/258; H01M 2200/10; H01M 2220/20

(57) ABSTRACT

A battery pack includes battery cells arranged in an array to form a battery module layer. Multiple layers are vertically stacked with thermal management devices, such as active heat exchangers in the form of battery cold plates, above and below each layer to form a multi-layer battery stack that may be held in compression by a battery pack frame. The multi-layer battery stack and battery pack frame are surrounded by a battery enclosure, which has flat sealing surfaces to ensure robust sealing. The battery pack is associated with a thermal management system for cooling and heating the battery cells of the battery pack. The battery thermal management system provides cooling and heating by alternating cooling flow directions to achieve uniform temperature distribution. The battery pack may also include a vent detection sensor and vent isolators to detect and mitigate effects of a battery thermal runaway event. Multiple battery packs of a common form factor can be combined in parallel in different arrangements for different vehicles to optimize electric vehicle range, performance, and weight distribution. The battery system can be, charged, discharged, controlled, and thermally managed either by a centralized system or distributed system.

### CROSS-REFERENCE TO RELATED APPLICATIONS

This application claims the benefit of U.S. Provisional Patent Application Nos. 63/388,608, 63/388,609, 63/388,610, 63/388,612, 63/388,613, 63/388,615, 63/388,616, 63/388,618, 63/388,619, each filed on Jul. 12, 2022, the entire disclosures of which are herein incorporated by reference for all purposes.

### BACKGROUND

### Technical Field

The present disclosure generally relates to battery packs, such as, for example, modular and scalable battery packs to meet energy requirements of different applications including battery packs that feature multi-layer battery stacks that effectively utilize space and increase energy density of the battery packs.

The present disclosure also generally relates to internal and external aspects of battery pack form factors, such as, for example, aspects of battery cell stacks, battery pack frames, battery enclosures, and the like.

The present disclosure also generally relates to techniques for heating and cooling battery packs, including, but not limited to, heating and cooling form factors, systems, arrangements, and techniques to provide effective cooling functionality during use of the battery pack or effective heating functionality during, for example, cold starts of the battery pack.

The present disclosure also generally relates to techniques associated with battery cell and/or battery enclosure venting, including but not limited to techniques for detecting an occurrence of a battery thermal runaway event and for mitigation of venting gas and debris of the battery pack following the battery thermal runaway event.

### Description of the Related Art

Electric vehicles have seen a rapid increase in popularity in recent years based on environmental concerns associated with internal combustion engines, and other factors. A known electric vehicle includes a battery to power an electric motor that is mechanically coupled to the wheels of the vehicle to generate vehicle movement via electric power provided by the battery pack. Electric vehicles range is limited by the capacity of the battery pack and the capacity of charging stations. This becomes particularly prominent for long-haul commercial vehicles.

Further, during cooling processes of a known battery, battery cells located on an upstream side of the flow of the heat exchange media can have a lower temperature than other battery cells in the battery pack, while batteries on the downstream side of the flow can have a higher temperature than other battery cells in the battery pack. This has a significant impact on battery cell capacity fade and impedance growth. The battery cells located on the downstream side are exposed to higher temperature and therefore the capacity fades more quickly. This creates a challenge for battery balancing and shortens battery life.

In addition, batteries for electric vehicles undergo temperature and pressure changes during operation that can lead to problems without proper venting. For example, if battery cells are damaged by overcharging, manufacturing defects, or other causes, the cells vent matter, such as hot gas and debris, during a thermal runaway event. The vented matter from one cell can cause other nearby cells to likewise vent matter, leading to a condition where rapidly increasing temperatures and pressures released by the cells exceed the venting capability of an enclosure around the cells. This can result in failure of the enclosure, as well as potentially more serious and dangerous outcomes such as a battery fire.

Moreover, for vehicles with various wheelbase and packaging space, a variety of battery packs need to be designed due to the limitation of the existing battery form factors. Frequently, the packaging space cannot be utilized effectively which limits the range of the vehicles.

### BRIEF SUMMARY

The present disclosure is generally directed to battery packs and is particularly, but not exclusively, directed to battery packs and related battery technology for electric vehicles. The battery packs and related technology described herein may be particularly useful for implementation in commercial vehicles, including long-haul tractors, but the concepts discussed herein are not necessarily limited thereto and may be applied equally to other electric vehicles and electric vehicle batteries and related battery systems, as well as potentially other fields.

A battery pack includes a plurality of battery cells arranged in an array to form a battery module layer. Each battery cell may be a prismatic type battery cell and may have a significantly greater length than thickness. Multiple battery module layers can be stacked in a vertical arrangement with thermal management devices such as active heat exchangers in the form of battery cold plates positioned above and/or below each layer to form a multi-layer battery stack. A battery pack frame includes frame elements that may support the battery cold plates and hold the battery cold plates in compression against the battery cells provided therebetween. The battery pack frame may also apply a compressive force to the multi-layer battery stack generally to hold the battery cells in place. The multi-layer battery stack and battery pack frame are surrounded by a battery enclosure that may be provided in a number of different form factors. For example, the battery enclosure may have a multi-part construction that is joined together in a waterproof seal around the multi-layer battery stack and the frame. In some instances, the battery enclosure may be an at least two-part shell that defines crumple zones to protect the multi-layer battery stack.

The battery cold plates in the battery pack enable heating and cooling of the battery cells via communication with a thermal management system that feeds a heat transfer medium through internal passages of the cold plates. The thermal management system may include valves or other devices for periodically reversing a direction of flow of the heat transfer medium to assist in balancing a temperature between battery cells located at the upstream and downstream ends of the heat transfer medium path. The battery pack may also include one or more vent detection sensors in the form of a pressure sensor and/or a gas sensor to detect whether a thermal runaway event (i.e., a venting event) has occurred with one or more of the battery cells. Upon detection of the thermal runaway event, the one or more sensors may provide instructions, signals, or data to a status indicator to provide at least one warning indication to a user, such as an occupant and/or driver of the vehicle.

In some embodiments, the frame members of the battery pack frame have integrated vent isolation functionality to mitigate the effects of a thermal runaway event associated with one or more of the cells. Alternatively, vent isolation functionality may be provided by vent isolators that are separate structures coupled to the frame and in communication with the battery cells. During a thermal runaway event, the vent isolators direct the discharged matter, which may be hot gas and entrained debris, away from the battery cells and towards a debris collection space. The vent isolators prevent the discharged matter from one cell from reaching a vent of an adjacent cell to mitigate damage to adjacent vents. The battery pack may also include one or more dams protecting the battery cells to further mitigate damage thereto during a thermal runaway event.

Multiple battery packs can be combined in parallel in different arrangements to increase electric vehicle range while also being positionable to optimize weight distribution for different vehicles. The multiple layers of the multi-layer battery stack utilize available space effectively and increase energy density. The battery packs may be associated with a centralized heating and cooling system, or distributed heating and cooling systems, or a combined arrangement (e.g., centralized cooling, distributed heating) to further improve thermal performance. The battery packs may be associated with a centralized battery management system (BMS) for providing centralized monitoring and control functionality for the common battery packs; or a master-slave battery management system (BMS) for providing distributed monitoring and control functionality. Furthermore, the battery packs may be associated with a centralized charging system comprising a single charger for charging the battery packs; or a distributed charging system comprising a plurality of chargers for charging the battery packs. In addition, the modular nature of the battery packs significantly reduces maintenance downtime and potential charging downtime because packs can be switched out without negatively impacting the entire battery pack system.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings may not necessarily be drawn to scale in some figures. The figures do not describe every aspect of the teachings disclosed herein and do not limit the scope of the claims.

FIG. 1 is a top plan view of a chassis of a commercial vehicle including an arrangement of common battery packs secured to the chassis.

FIG. 2 is a perspective view of one of the battery packs of the commercial vehicle of FIG. 1.

FIG. 3 shows a cross-sectional view of the battery pack of FIG. 2.

FIG. 4 is an enlarged detail view of the cross-section of the battery pack of FIG. 3.

FIG. 5 is a perspective view of a battery module layer of the battery pack.

FIG. 6 is a perspective view of a multi-layer battery stack comprising a plurality of the battery module layers of FIG. 5 stacked together.

FIG. 7 is a perspective view of an example embodiment of a battery cell of the battery packs.

FIG. 8 is a perspective view of another example embodiment of a battery cell that may be used in connection with the battery packs disclosed herein.

FIG. 9 is a perspective view of another embodiment of a battery pack for a commercial vehicle with a battery pack enclosure omitted to reveal underlying details of the battery pack.

FIG. 10 is another perspective view of the battery pack of FIG. 9.

FIG. 11 is a perspective view of a battery module layer of the battery pack of FIG. 9.

FIG. 12 is a perspective view of battery module layers of another embodiment of a multi-layer battery stack.

FIG. 13 is a perspective view of components of the multi-layer battery stack of FIG. 12 with cutaway portions to reveal internal passages thereof.

FIG. 14 are top plan views of the chassis of a collection of commercial vehicles having different vehicle attributes (e.g., wheelbase) showing different arrangements of battery packs secured thereto to optimize vehicle power and vehicle range of each commercial vehicle.

FIG. 15 is a perspective view showing an alternative configuration of a battery pack.

FIG. 16 is a perspective view showing another alternative configuration of a battery pack.

FIG. 17 shows a sequence of assembling sub-modules of battery cells together to form a battery module layer of a battery stack.

FIG. 18 shows another sequence of assembling sub-modules of battery cells together to form battery module layers of a battery stack.

FIG. 19 shows an assembly of sub-modules of battery cells together between opposing cold plates of a battery stack.

FIG. 20 shows a sequence of assembling a sub-module of battery cells together using a sub-module bracket.

FIG. 21 shows battery cells being installed on a thermal management device in the form of an active heat exchanger or, more specifically, a battery cold plate.

FIG. 22 shows the battery cells of FIG. 21 installed on the thermal management device.

FIG. 23 shows battery cells being installed on a thermal management device in the form of an active heat exchanger or, more specifically, a battery cold plate, according to yet another embodiment.

FIG. 24 shows the battery cells of FIG. 23 installed on the thermal management device.

FIG. 25 shows an effect of temperature cycles on battery cell capacity fade.

FIG. 26 shows an effect of temperature on battery cell impedance growth.

FIG. 27 shows a schematic of a thermal management system for battery cells.

FIG. 28A shows a thermal management system, according to one example embodiment, in a first configuration.

FIG. 28B shows the thermal management system of FIG. 28A in a second configuration.

FIG. 29A shows a thermal management system, according to one example embodiment, in a first configuration.

FIG. 29B shows the thermal management system of FIG. 29A in a second configuration.

FIG. 30 shows a battery pack enclosure according to another example embodiment.

FIG. 31 shows an embodiment of a battery pack with a battery pack enclosure.

FIG. 32 is a detail view of area A of the battery pack and battery pack enclosure of FIG. 31.

FIG. 33 shows another battery pack within another battery pack enclosure according to another example embodiment.

FIG. 34A shows a battery pack enclosure in an ordinary working configuration according to another example embodiment.

FIG. 34B shows the battery pack enclosure of FIG. 34A in the event of a side impact according to another example embodiment.

FIG. 35 is an exploded view of end parts coupleable to the battery pack enclosure of FIG. 31.

FIG. 36 shows the assembled battery pack enclosure with end plates of FIG. 33.

FIG. 37 shows a first view of a battery pack end cap according to another example embodiment.

FIG. 38 shows a second view of the battery pack end cap of FIG. 37.

FIG. 39 is a schematic cross-sectional view of an embodiment of a battery pack and battery pack enclosure.

FIG. 40 shows portions of another battery pack enclosure according to another example embodiment.

FIG. 41 is a schematic representation of a thermal runaway condition of the battery cell and/or the battery cell enclosure.

FIG. 42 is a schematic representation of a battery pack with vent protection functionality.

FIG. 43 shows a vent isolator and an array of battery cells of the battery pack of FIG. 42.

FIG. 44 shows the vent isolator of FIG. 43.

FIG. 45 shows the vent isolator of FIG. 44 with separators between vent apertures.

FIG. 46 shows an embodiment of the battery pack of FIG. 42.

FIG. 47 is a cross-sectional view of the battery pack of FIG. 46 along line A-A in FIG. 46.

FIG. 48 is an isometric view of a further battery pack with vent protection functionality.

FIG. 49 is a cross-sectional view of an array of battery cells of the further battery pack of FIG. 48 along line B-B in FIG. 48.

FIG. 50 shows a battery pack with venting detection aspects.

FIG. 51 is a graphical representation of detected pressure in a battery enclosure over time.

FIG. 52 is a graphical representation of detected gas concentration in a battery enclosure over time.

FIG. 53 is a block diagram of a controller suitable for executing an embodiment of a battery pack that performs at least some techniques described in the present disclosure, as well as various devices and/or computing systems connected thereto.

### DETAILED DESCRIPTION

In the following description, certain specific details are set forth in order to provide a thorough understanding of various disclosed embodiments. However, embodiments may be practiced without one or more of these specific details, or with other methods, components, materials, etc. In other instances, well-known structures associated with battery technology have not been shown or described in detail to avoid unnecessarily obscuring descriptions of the embodiments.

Persons of ordinary skill in the relevant art will understand that the present disclosure is illustrative only and not in any way limiting. Other embodiments of the presently disclosed battery devices, systems and methods readily suggest themselves to such skilled persons having the assistance of this disclosure.

### Modular and Scalable Battery Packs

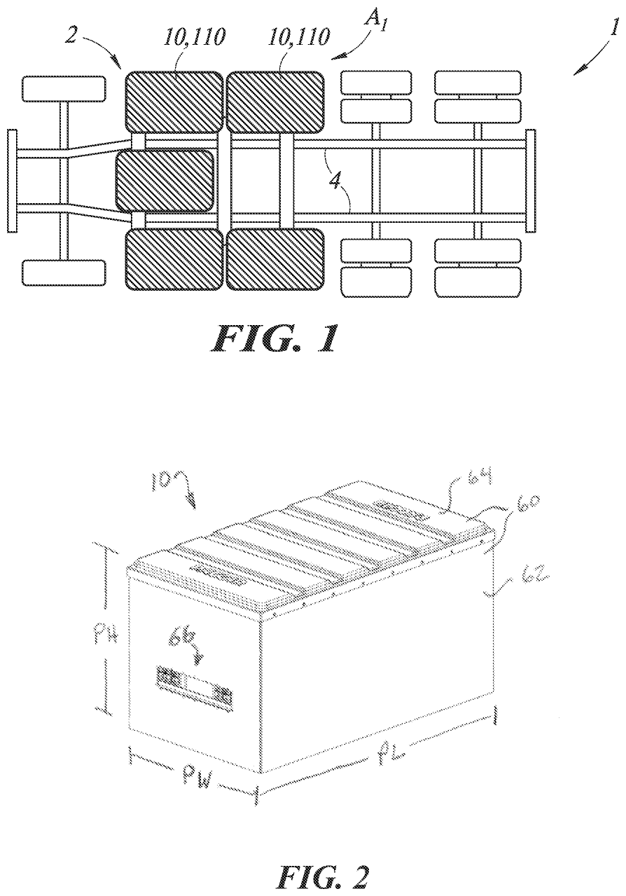

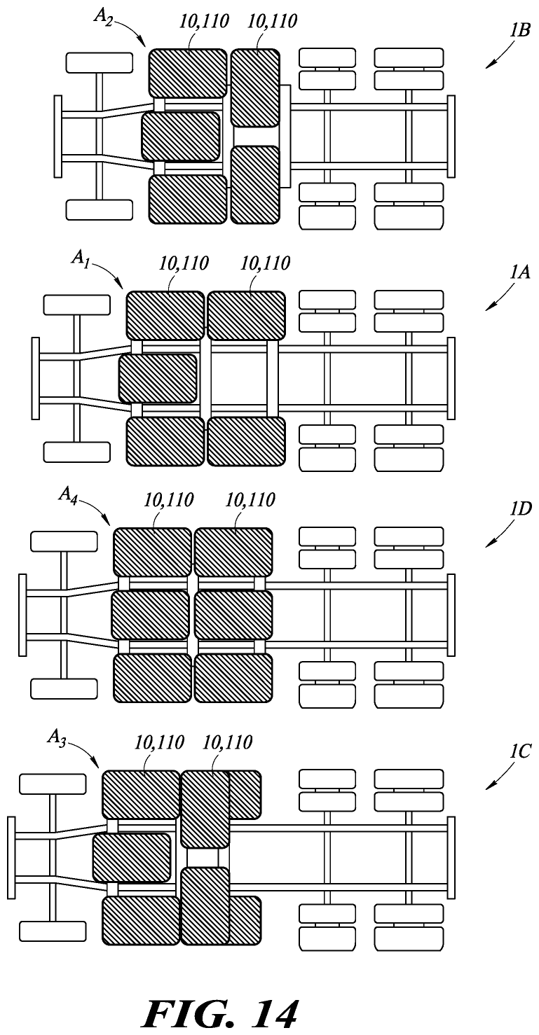

With reference to FIG. 1, a chassis 2 of a commercial vehicle 1 is shown in plan view with an arrangement A₁ of common battery packs 10, 110 secured to the chassis 2. Unless the context and language clearly dictates otherwise, the use of “common” herein with respect to a battery pack means multiple battery packs of an identical or nearly identical form factor. In particular, an arrangement of five common battery packs 10, 110 is shown with a respective pair of the battery packs 10, 110 secured to each of opposing sides of rails 4 of the chassis 2 and with one of the battery packs 10, 110 secured in line with a centerline of the chassis 2. As will be appreciated from a review of the present disclosure, however, the battery packs 10, 110 may be arranged in a variety of different arrangements (e.g., arrangements A₁, A₂, A₃ A₄, of FIG. 14) having a varying number of battery packs 10, 110 to optimize vehicle power and vehicle range of a host commercial vehicle for a particular make of vehicle or a particular desired performance profile. In addition, the battery packs 10, 110 may be arranged in different configurations to optimize weight distribution. To be clear, the arrangement A₁ of battery packs 10, 110 in FIG. 1 is a non-limiting example of one arrangement that may be particularly well suited for applications such as long-haul tractors.

In some instances, for example, a host vehicle may utilize between and including two and ten battery packs for any given application, namely, two, three, four, five, six, seven, eight, nine or ten battery packs. In addition, with respect to a fleet or collection of vehicles, it is appreciated that different configurations may be used for different vehicles, including at least one configuration for one vehicle in which a number of the common battery packs is different than a number of the common battery packs in another one of the configurations for another vehicle.

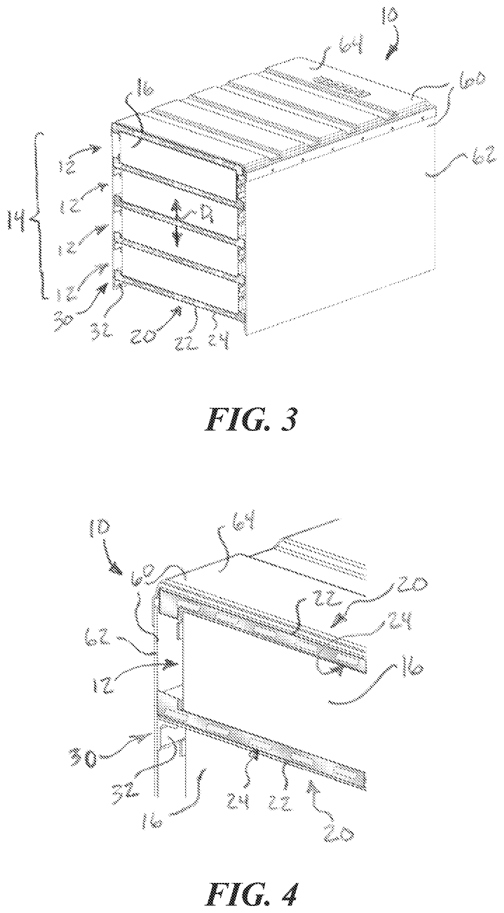

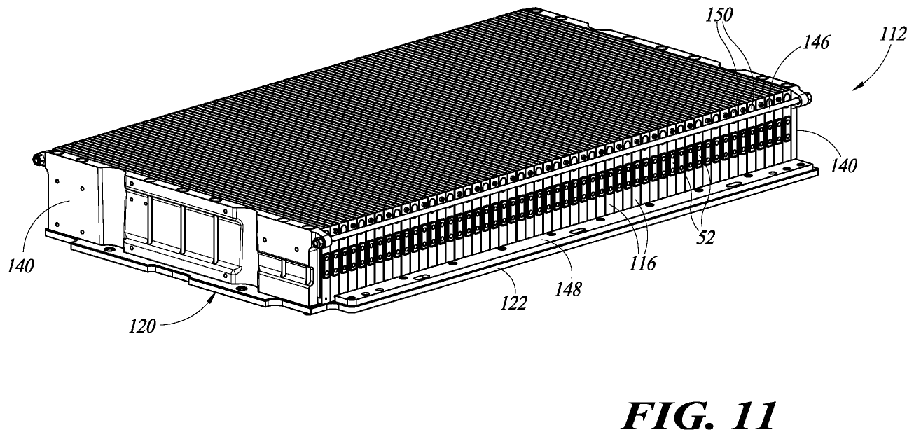

According to embodiments disclosed herein, a battery system for a commercial vehicle 1 may be provided that includes one standard size battery pack 10, 110 that is packaged in a modular arrangement A₁ in the vehicle 1, with the configuration of the battery packs 10, 110 in the system providing flexible, scalable capacity to the vehicle 1. The system provides scalable capacity with the addition of another battery pack 10, 110 to increase performance and range. Individual battery packs 10, 110 are made up of battery cells 16, 116 (see, e.g., FIGS. 3 through 11) arranged in series to attain a target voltage, for example, from 600V to 1200V. Advantageously, the battery system is modular and can add a battery pack 10, 110 connected in parallel with each other battery pack 10, 110 to increase the power, energy storage capability, and the range for the intended duty cycle of the vehicle 1. In this manner, it is appreciated that the battery pack system may use a common form factor of a battery pack 10, 110 for each of a plurality of battery packs connected in parallel to form the battery pack system in all arrangements A₁ and vehicles 1 within, for example, a fleet or a collection of vehicles, as described in further detail herein.

FIGS. 2 through 6 and FIGS. 9 through 11 show additional details of such a common battery pack 10 and a common battery pack 110, respectively, and FIG. 14 shows additional example arrangements A₁, A₂, A₃, A₄ of such battery packs 10, 110 on a fleet or a collection of vehicles 1 having different vehicle attributes (e.g., wheelbase).

With reference to FIGS. 2 through 6, a battery pack 10 is shown according to an example embodiment that is particularly well suited to serve as a common battery pack 10 that may be combined in parallel together with other like battery packs 10 to optimize vehicle power and vehicle range, as well as to be arranged in different arrangements on a vehicle to optimize weight distribution. As shown in FIG. 2, the battery pack 10 may be provided in a form factor having a generally rectangular shape with a pack length PL, a pack height PH, and a pack width PW. In one particularly advantageous embodiment for long-haul tractors and other commercial vehicles, the battery pack 10 may be provided in a form factor having a generally rectangular shape with a pack length PL of 1100±150 mm, a pack height PH of 600±100 mm, and a pack width PW of 600±100 mm.

As shown best in the cross-sectional view of FIG. 3, the battery packs 10 include a plurality of battery module layers 12 stacked to form a multi-layer battery stack 14, with each battery module layer 12 including a plurality of battery cells 16 arranged in an array and connected in series with each other and all other battery cells 16 of the battery pack 10. Again, a sufficient number of the battery cells 16 may be connected together in series to provide a target battery pack voltage, for example, in a range of between and including 600V and 1200V that is common to each of the common battery packs 10. The common battery packs 10 can then be connected in parallel with each other to increase vehicle power and vehicle range of a host commercial vehicle 1 as desired or required.

To increase energy density, it is advantageous to provide the battery cells 16 of the battery pack 10 in the plurality of module layers 12. Unless the context and language clearly dictates otherwise, the term “energy density” should be construed broadly to include both volumetric energy density (i.e., Watt hours per Liter) and gravimetric energy density (i.e., Watt hours per kilogram). While the illustrated embodiment of FIG. 3 shows four stacked battery module layers 12, it is appreciated that the number of battery module layers 12 may vary and include two, three, four, five or more battery module layers 12. Further, in some lower capacity applications, a single battery layer 12 may be provided. For a given vehicle, or for a fleet or a collection of vehicles, it is advantageous in some embodiments to provide a same number of battery module layers 12 in the battery packs 10 thereof such that the battery packs 12 have a common form factor for the particular vehicle, or for the fleet or the collection of vehicles.

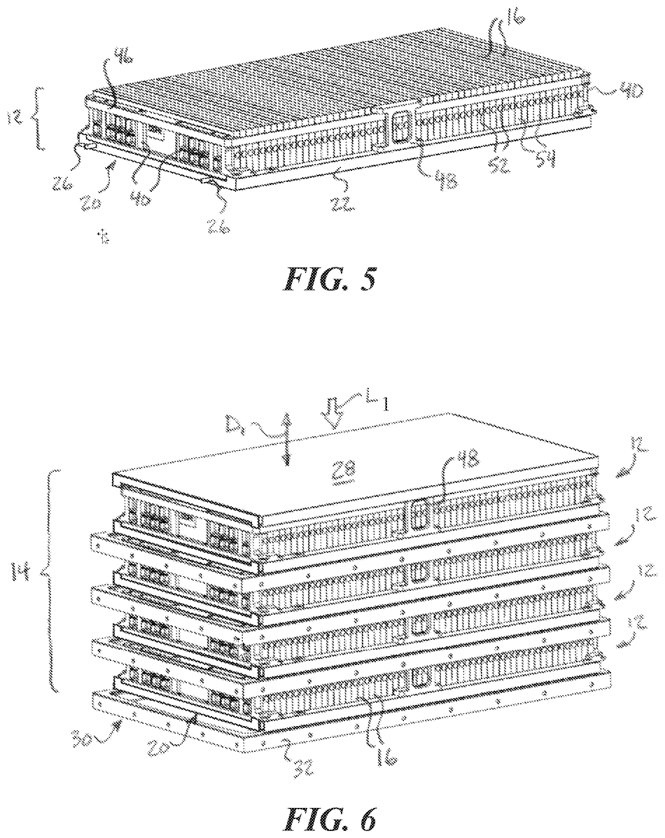

With reference to FIGS. 3 to 6, the plurality of battery module layers 12 may be stacked in a vertical direction D₁ (FIG. 6) to form a multi-layer battery stack 14 with each battery module layer 12 including a plurality of the battery cells 16 arranged in a linear array. Each battery module layer 12 may further include a thermal management device 20, such as an active heat exchanger (also referred to as a cold plate), that is in direct thermal engagement with the array of battery cells 16 to provide cooling or heating of the battery cells 16 in operation.

The battery pack 10 may further include a battery pack frame 30 including a plurality of frame members 32, wherein each battery module layer 12 is secured to a respective frame member 32 to support the battery module layers within the battery pack 10. In some advantageous embodiments, the frame members 32 may be arranged to apply a compressive load L₁ (FIG. 6) on the battery module layers 12 to assist in maintaining the battery module layers 12 of the multi-layer battery stack 14 in thermal contact with each other. In this manner, cooling and heating of the battery cells 16 may be carried out more efficiently via the thermal management devices 20 of the battery pack 10. As an example, each frame member 32 may be provided in the form of a structural support frame at a periphery of the battery pack 10. The structural support frame may comprise, for example, angle iron components secured around a periphery of the battery pack 10 and the battery module layers 12 that may be secured directly or indirectly to each structural support frame. In some instances, the thermal management device 20 of each battery module layer 12 may be secured directly to a respective one of the structural support frames to support the array of battery cells 16 thereon. The structural support frames may be spaced such that as each battery module layer 12 is stacked on a prior layer and secured to the structural support frame (e.g., via a bolted arrangement), the thermal management device 20 of the overlying battery module layer 12 is pressed into contact with the battery cells 16 of the underlying battery module layer 12, or an intervening structure (e.g., a heat transfer pad), to maintain the battery module layers 12 of the multi-layer battery stack 14 in close thermal contact with each other.

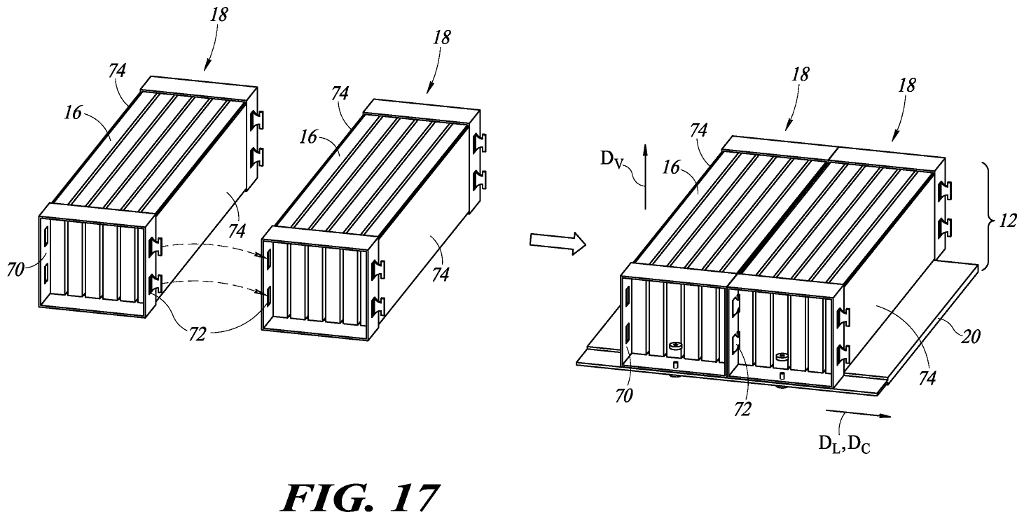

With reference to FIG. 5, each battery module layer 12 may further include one or more anchors 40 to assist in securing the array of battery cells 16 to the thermal management device 20 of the battery module layer 12. According to the illustrated embodiment of FIG. 5, for example, anchors 40 in the form of anchor castings are provided at each of the ends of the array of battery cells 16 and secured to the thermal management device 20 via bolted connections to hold the array of battery cells 16 in position on the thermal management device 20 and to assist in maintaining the battery cells 16 in contact with each other. For each battery module layer 12, all of the battery cells 16 of the battery module layer 12 may be compressed together. For example, for each battery module layer 12, all of the battery cells 16 of the battery module layer 12 may be compressed together with the aid of a compression band 46 encircling the array of battery cells 16. In other instances, compression brackets may be secured to the battery cells 16 with tie rods or other devices for pressing the battery cells 16 together. Although the example embodiment of the battery module layer 12 shown in FIG. 5 is shown with all of the battery cells 16 compressed together, it is appreciated that in other embodiments that the battery cells 16 may be compressed together in sub-modules (e.g., sub-modules 18 of FIGS. 17 through 20) to maintain contact between the battery cells 16 or intervening structures of each sub-module, with the sub-modules then fixedly secured together to form the array of battery cells 16, as discussed in greater detail elsewhere.

With reference to FIG. 5, each battery module layer 12 may further include one or more standoffs or structural supports 48 to interface with an adjacent battery module layer 12 including, for example, the thermal management device 20 of an overlying battery module layer 12. Advantageously, the one or more standoffs or structural supports 48 may be provided on opposing sides of the battery module layer 12 in a respective intermediate position along a longitudinal length of the battery module layer 12 to assist in supporting the overlying thermal management device 20 and minimize or prevent undesirable deflection of the overlying thermal management device 20. In addition, the standoffs or structural supports 48 may similarly serve as anchors (akin to anchors 40) for the plurality of battery cells 16 to assist in locating and maintaining the battery cells 16 of the battery module layer 12 in place. As shown, the one or more standoffs or structural supports 48 may be shaped or include features to avoid obstructing components on the end faces 54 of the battery cells 16, such as the electrode terminals 52.

With reference now to FIG. 6, the battery cells 16 of each the battery module layer 12 are shown in direct thermal engagement with the thermal management device 20 adjacent and overlying the battery cells 16 such that all of the battery cells 16 of the battery module layer 12 are positioned between two thermal management devices 20 above and below each respective battery module layer 12 to facilitate heat transfer on plural sides of the battery cells 16. Advantageously, the linear array of battery cells 16 of each battery module layer 12 are held in compression between two thermal management devices 20 of the multi-layer battery stack 14 to ensure close thermal contact among all of the battery cells 16 and facilitate efficient cooling of the battery stack 14 during operation, or alternatively, heating of the battery stack 14 during, for example, cold starts of the battery system. Close thermal contact in this context includes contact of the thermal management devices 20 directly with the battery cells 16 or contact via intermediate thermally conductive substrates or materials, such as a thermal paste or a thermal pad.

According to the illustrated embodiment of the battery pack 10 of FIGS. 2 to 6, the thermal management device 20 is provided in the form of an active heat exchanger having at least one liquid heat exchange medium passageway 24 for circulating a liquid heat exchange medium for cooling or heating purposes, and more specifically may be referred to as a battery cold plate 20 that is configured to provide cooling or heating of the battery cells in operation. The battery cold plate 20 of the illustrated embodiment comprises a generally planar manifold 22 and includes at least one heat transfer medium passageway 24 to facilitate the circulation of a heat transfer medium through the manifold 22 during operation to assist in drawing heat away from the battery cells 16 to cool the battery cells 16 or, alternatively, supplying heat to the battery cells 16 to heat the battery cells 16. As shown in FIG. 5, one or more fittings 26 may be provided on the battery cold plate 20 to enable conduits for the heat transfer medium to be attached to the cold plate 20 to enable fluid communication between the heat transfer medium passageway 24 of each cold plate 20 with each other and other components of a thermal management system, such as one or more chillers and one or more heaters to enable the battery cooling and heating functionality described herein.

Notably, according to the illustrated embodiment, each of the battery cells include one or more electrode terminals 52 on an end face 54 of the battery cell 16 which are oriented normal to a direction in which the battery cells 16 are aligned in the array and parallel to major surfaces 28 (FIG. 6) of the battery cold plate 20 that are themselves oriented normal to the stacking direction D₁ of the multi-layer battery stack 14. The major surfaces 28 of the battery cold plates 20 are also perpendicular to a plane of the electrodes in the battery cells 16. In this configuration, electrical bus bar connections for the battery cell 16 may be maintained on a side of the battery stack 14 and enable upper and lower surfaces of the array of battery cells 16 to present uninterrupted mating surfaces for interfacing with the overlying and underlying cold plates 20, respectively, and provide a form factor that is particularly well suited for cooling and heating of the battery cells 16.

With reference back to FIGS. 2 and 3, the battery pack 10 further includes a battery enclosure 60 that accommodates, and generally surrounds, the multi-layer battery stack 14 and the battery pack frame 30. The battery enclosure 60 includes an enclosure base 62 and an enclosure cover 64 to fully enclose the multi-layer battery stack 14. The enclosure base 62 and the enclosure cover 64 may be coupled together in a watertight seal to assist in protecting the battery stack 14 from hot debris in the case of a thermal runaway event. In some embodiments, the enclosure base 62 may be provided in the form of a shallow enclosure or tray upon which the battery stack 14 may be assembled and plumbed prior to installation of the enclosure cover 64, as described in more detail elsewhere. As shown in FIGS. 2 and 3, the frame members 32 of the battery pack frame 30 may be secured (e.g., bolted) directly to sidewalls of the battery enclosure 60 to provide a reinforced enclosure for the battery stack 14. As can also be appreciated from FIGS. 2 and 3, the enclosure 60 may be sized and shaped to closely surround the battery stack 14 such that only a relatively small proportion of the interior volume of the battery pack 10 is unoccupied. In this manner, a battery pack 10 with a particularly high energy density is provided.

The battery enclosure 60 may further include one or more interfaces 66 for routing electrical power or signals to and from the battery pack 10 and for routing heat transfer medium to and from the battery pack 10 for cooling or heating purposes. The interface 66 shown in FIG. 2 is shown simply as an aperture in the battery enclosure 60 and more particularly the enclosure base 62, however, it is appreciated that the aperture may be fitted with one of more industrial connectors including electrical connectors for routing electrical power or signals to and from the battery pack 10 and fluid connectors for routing heat transfer medium to and from the battery pack 10, or otherwise include pass-throughs for one or more electrical conduits or heat transfer conduits. All of the connections provided at the one or more interfaces 66 may be sealed or otherwise impenetrable to water ingress into the battery enclosure 60 to maintain a battery enclosure 60 that is watertight.

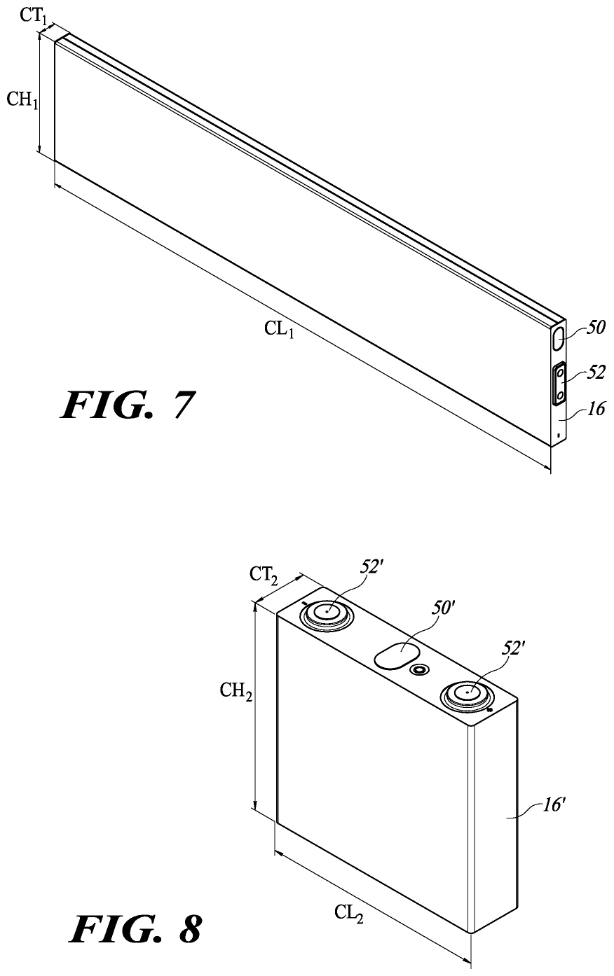

With reference now to FIG. 7, an example embodiment of one battery cell 16 of the plurality of battery cells 16 of the battery packs 10 disclosed herein is shown in isolation. The battery cell 16 may be a prismatic style battery cell and may include uninterrupted surfaces around a body of the cell. The battery cell 16 includes electrode terminals 52 on its end faces 54 that enable a series of the battery cells 16 to be arranged in a tightly packed array as shown, for example, in FIGS. 5 and 6. Vent valves 50 may also be provided on end faces 54 of the battery cell 16 to provide relief of gases to avoid rupturing or other damage to the battery cell 16 under certain conditions or scenarios. As shown in FIG. 7, the battery cell 16 may be provided in a form factor having a generally rectangular prismatic shape with a cell length CL, a cell height CH, and a cell thickness CT. In some instances, the battery cell 16 may have a generally rectangular prismatic shape with a cell length of 520±50 mm, a cell height of 125±10 mm, a cell thickness of 20±5 mm. The battery cell 16 may have a generally high aspect ratio of cell length to cell height. For example, in some embodiments, the aspect ratio of cell length to cell height may be between and include 3:1 to 6:1.

Alternatively, with reference to FIG. 8, another example embodiment of one battery cell 16′ of the battery packs disclosed herein is shown in isolation. The battery cell 16′ may be a prismatic style battery cell and may include uninterrupted surfaces around a body of the cell. The battery cell 16′ includes electrode terminals 52′ on its upper face 54′ that enable a series of the battery cells 16′ to be arranged in a tightly packed array. A vent valve 50′ may also be provided on the upper face 54′ of the battery cell 16′ to provide relief of gases to avoid rupturing or other damage to the battery cell under certain conditions or scenarios. As shown in FIG. 8, the battery cell 16′ is provided in a form factor having a generally rectangular prismatic shape with a cell length CL₂, a cell height CH₂, and a cell thickness CT₂. In some instances, the battery cell 16′ may have a generally rectangular prismatic shape with a cell length of 175±50 mm, a cell height of 150±20 mm, a cell thickness of 45±5 mm. The battery cell 16′ may have a generally moderate aspect ratio of cell length to cell height. For example, in some embodiments, the aspect ratio of cell length to cell height may be between and include 1:1 to 2:1.

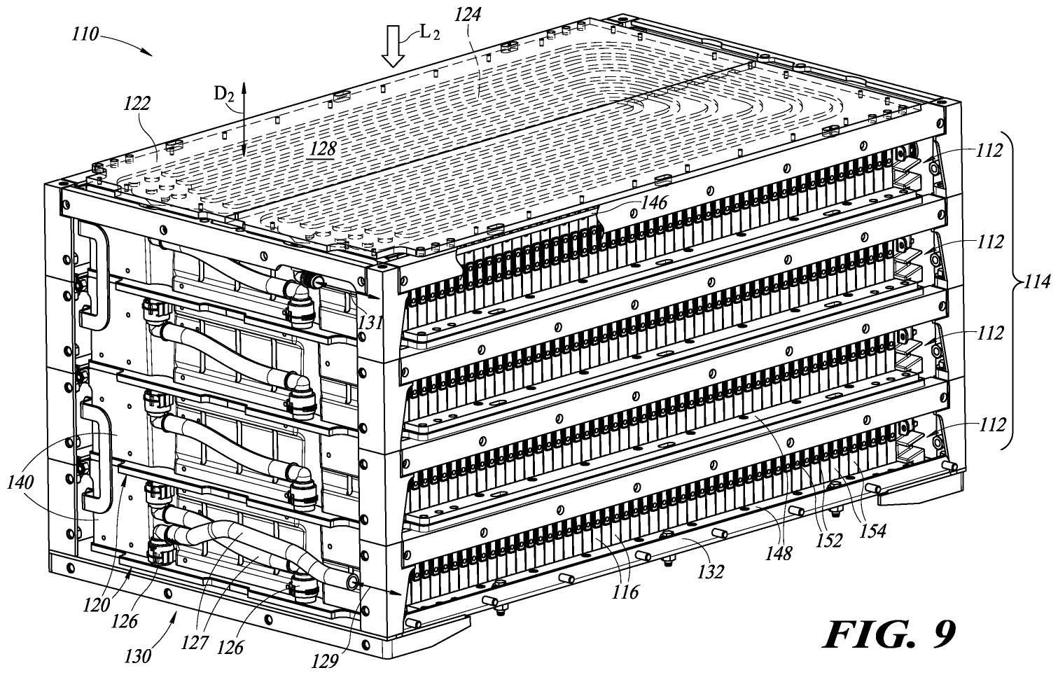

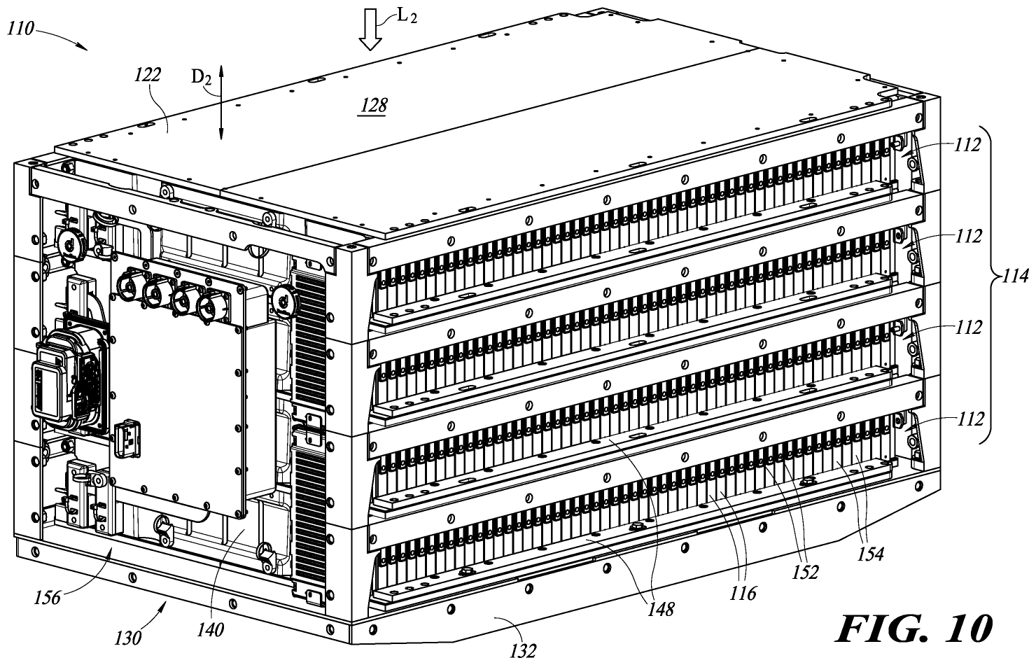

With reference now to FIGS. 9 through 11, a battery pack 110 is shown according to another example embodiment that is particularly well suited to serve as a common battery pack 110 that may be combined in parallel together with other like battery packs 110 to optimize vehicle power and vehicle range, as well as to be arranged in different arrangements on a vehicle to optimize weight distribution. As shown in FIGS. 9 and 10, the battery pack 110 may be provided in a form factor having a generally rectangular shape similar to that of the battery pack 10 of FIGS. 2 through 6. In one particularly advantageous embodiment for long-haul tractors and other commercial vehicles, the battery pack 110 may be provided in a form factor having a generally rectangular shape with a pack length of 1100±150 mm, a pack height of 600±100 mm, a pack width of 600±100 mm.

As shown in FIGS. 9 and 10, the battery pack 110 includes a plurality of battery module layers 112 stacked to form a multi-layer battery stack 114, with each battery module layer 112 including a plurality of battery cells 116 arranged in an array and connected in series with each other and all other battery cells 116 of the battery pack 110. Again, a sufficient number of the battery cells 116 may be connected together in series to provide a target battery pack voltage, for example, in a range of between and including 600V and 1200V that is common to each of the common battery packs 110. The common battery packs 110 can then be connected in parallel with each other to increase vehicle power and vehicle range of a host commercial vehicle 1 as desired or required.

To increase energy density, it is advantageous to provide the battery cells 116 of the battery pack 110 in the plurality of module layers 112. Again, unless the context and language clearly dictates otherwise, the term “energy density” should be construed broadly to include both volumetric energy density (i.e., Watt hours per Liter) and gravimetric energy density (i.e., Watt hours per kilogram). While the illustrated embodiment of FIGS. 9 and 10 shows four stacked battery module layers 112, it is appreciated that the number of battery module layers 112 may vary and include two, three, four, five or more battery module layers 112. Further, in some lower capacity applications, a single battery layer 112 may be provided. For a given vehicle, or for a fleet or a collection of vehicles, it is advantageous in some embodiments to provide a same number of battery module layers 112 in the battery packs 110 thereof such that the battery packs 112 have a common form factor for the particular vehicle, or for the fleet or the collection of vehicles.

With reference to FIGS. 9 through 11, the plurality of battery module layers 112 may be stacked in a vertical direction D₂ to form a multi-layer battery stack 114 with each battery module layer 112 including a plurality of the battery cells 116 arranged in a linear array. Each battery module layer 112 may further include a thermal management device 120, such as an active heat exchanger (also referred to as a cold plate), that is in direct thermal engagement with the array of battery cells 116 to provide cooling or heating of the battery cells 116 in operation.

The battery pack 110 may further include a battery pack frame 130 including a plurality of frame members 132, wherein each battery module layer 112 is secured to a respective frame member 132 to support the battery module layers within the battery pack 110. In some advantageous embodiments, the frame members 132 may be arranged to apply a compressive load L₂ (FIGS. 9 and 10) on the battery module layers 112 to assist in maintaining the battery module layers 112 of the multi-layer battery stack 114 in thermal contact with each other. In this manner, cooling and heating of the battery cells 116 may be carried out more efficiently via the thermal management devices 120 of the battery pack 110. As an example, each frame member 132 may be provided in the form of a structural support frame at a periphery of the battery pack 110. The structural support frame may comprise, for example, angle iron components secured around a periphery of the battery pack 110 and the battery module layers 112 that may be secured directly or indirectly to each structural support frame. In some instances, the thermal management device 120 of each battery module layer 112 may be secured directly to a respective one of the structural support frames to support the array of battery cells 116 thereon. The structural support frames may be spaced such that as each battery module layer 112 is stacked on a prior layer and secured to the structural support frame (e.g., via a bolted arrangement), the thermal management device 120 of the overlying battery module layer 112 is pressed into contact with the battery cells 116 of the underlying battery module layer 112, or an intervening structure (e.g., a heat transfer pad), to maintain the battery module layers 112 of the multi-layer battery stack 114 in close thermal contact with each other.

With continued reference to FIGS. 9 through 11, each battery module layer 112 may further include one or more anchors 148 to assist in securing the array of battery cells 116 to the thermal management device 120 of the battery module layer 112. According to the illustrated embodiment of FIGS. 9 through 11, the anchors 148 are provided in the form of elongated bars or plates positioned adjacent to lower ends of the array of battery cells 116 and secured to the thermal management device 120 via bolted connections to hold the array of battery cells 116 in position on the thermal management device 120 and to assist in maintaining the battery cells 116 in contact with each other. For each battery module layer 112, all of the battery cells 116 of the battery module layer 112 may be compressed together. For example, for each battery module layer 112, all of the battery cells 16 of the battery module layer 112 may be compressed together with the aid of a compression band encircling the array of battery cells 116, as shown in the example embodiment of FIGS. 2 through 6. In other instances, compression brackets 140 may be secured to opposing ends of the battery cells 116 with selectively adjustable tie rods 146 (FIG. 9) or other devices for pressing the battery cells 116 together. Although the example embodiment of the battery module layer 112 shown in FIGS. 9 through 11 is shown with all of the battery cells 116 compressed together, it is appreciated that in other embodiments that the battery cells 116 may be compressed together in sub-modules (e.g., sub-modules 18 of FIGS. 17 through 20) to maintain contact between the battery cells 116 or intervening structures of each sub-module, with the sub-modules then fixedly secured together to form the array of battery cells 116, as discussed in greater detail elsewhere.

With reference to FIGS. 9 and 10, the battery cells 116 of each the battery module layer 112 are shown in direct thermal engagement with the thermal management device 120 adjacent and overlying the battery cells 116 such that all of the battery cells 116 of the battery module layer 112 are positioned between two thermal management devices 120 above and below each respective battery module layer 112 to facilitate heat transfer on plural sides of the battery cells 116. Advantageously, the linear array of battery cells 116 of each battery module layer 112 are held in compression between two thermal management devices 120 of the multi-layer battery stack 114 to ensure close thermal contact among all of the battery cells 116 and facilitate efficient cooling of the battery stack 114 during operation, or alternatively, heating of the battery stack 114 during, for example, cold starts of the battery system. Close thermal contact in this context includes contact of the thermal management devices 120 directly with the battery cells 116 or contact via intermediate thermally conductive substrates or materials, such as a thermal paste or a thermal pad.

According to the illustrated embodiment of the battery pack 110 of FIGS. 9 through 11, the thermal management device 120 is provided in the form of an active heat exchanger having at least one liquid heat exchange medium passageway 124 for circulating a liquid heat exchange medium for cooling or heating purposes, and more specifically may be referred to as a battery cold plate 120 that is configured to provide cooling or heating of the battery cells 116 in operation. The battery cold plate 120 of the illustrated embodiment comprises a generally planar manifold 122 and includes at least one heat transfer medium passageway 124 (FIG. 9) to facilitate the circulation of a heat transfer medium through the manifold 122 during operation to assist in drawing heat away from the battery cells 116 to cool the battery cells 116 or, alternatively, supplying heat to the battery cells 116 to heat the battery cells 116. As shown in FIG. 9, one or more fittings 126 may be provided on the battery cold plate 120 to enable conduits 127 for the heat transfer medium to be attached to the cold plate 120 to enable fluid communication between the heat transfer medium passageway 124 of each cold plate 120 with each other and other components of a thermal management system, such as one or more chillers and one or more heaters to enable the battery cooling and heating functionality described herein.

According to the illustrated embodiment of FIG. 9, the battery cold plate 120 may include a set of liquid heat exchange medium openings (concealed beneath and in fluid communication with the fittings 126) on a same end of the battery pack 110, which serve as an inlet and an outlet for the liquid heat exchange medium. As shown in FIG. 9, the outlet of one of the battery cold plates 120 may be connected to the inlet of an adjacent one of the battery cold plates 120 to enable the liquid heat exchange medium to pass through each of the battery module layers 112 in a continuous path. As also described elsewhere herein, the battery pack may be configured such that the liquid heat exchange medium may flow in alternate directions along the continuous path to provide heating or cooling functionality to the multi-layer battery stack 114 in reversible directions. For example, with reference to FIG. 9, in one configuration, the liquid heat exchange medium may move from a heater or chiller through a conduit to the battery cold plate 120 of a lower one of the battery module layers 112, as indicated by arrows 129, and then circulates through the battery cold plate 120 through one or more liquid heat exchange medium passageways 124 thereof, to be discharged and routed by another conduit 127 to the battery cold plate 120 of an adjacent battery module layer 112, wherein the liquid heat exchange medium then circulates through one or more liquid heat exchange medium passageways 124 of that battery cold plate 120 to be discharged and routed by yet another conduit 127 to the battery cold plate 120 of an adjacent battery module layer 112, and so on until exiting an upper most battery cold plate 120, as indicated by arrows 131. Conversely, as described elsewhere, flow may be reversed such that the liquid heat exchange medium enters the upper most battery module layer 112, indicated by arrows 131, and then circulates sequentially through each of the battery module layers 112 before being discharged from the multi-layer battery stack 114, as indicated by arrows 129. In this manner, all connections for the fittings 126 and conduits 127 for the liquid heat transfer medium may be provided on one end of the multi-layer battery stack 114, and, advantageously separated from electronics, including one or more aspects, modules or components of a battery management system (BMS) 156, which may be provided on an opposing end of the multi-layer battery stack 114, as shown in FIG. 10. According to such an embodiment, there may be provided an electronics side of the pack 110 and a heat transfer medium routing and interface side of the pack 110. In other embodiments, connections and interfaces for electronics and connections and interfaces for the liquid heat transfer medium may be intermixed within the pack 110. In addition, the heat transfer medium may be routed through the battery module layers 112 in a different order or manner than sequentially. For example, the heat transfer medium may be routed through one or more battery module layers 112 in parallel.

Notably, according to the illustrated embodiment of the battery pack 110 of FIGS. 9 through 11, each of the battery cells 116 include one or more electrode terminals 152 on an end face 154 of the battery cell 116 which are oriented normal to a direction in which the battery cells 116 are aligned in the array and parallel to major surfaces 128 of the battery cold plate 120 that are themselves oriented normal to the stacking direction D₂ of the multi-layer battery stack 114. The major surfaces 128 of the battery cold plates 120 are also perpendicular to a plane of the electrodes 152 in the battery cells 116. In this configuration, electrical bus bar connections for the battery cell 116 may be maintained on a side of the battery stack 114 and enable upper and lower surfaces of the array of battery cells 116 to present uninterrupted mating surfaces for interfacing with the overlying and underlying cold plates 120, respectively, and provide a form factor that is particularly well suited for cooling and heating of the battery cells 116.

Alternatively, as shown and described elsewhere herein, each of the battery cells 116 may include one or more electrode terminals on an upper face of the battery cell 116 (similar to battery cell 16′ of FIG. 8), which are oriented parallel to the stacking direction D₂ of the multi-layer battery stack 114. In this regard, the major surfaces 128 of the battery cold plates 120 may be parallel to a plane of the electrodes 152 in the battery cells 116. In this configuration, electrical bus bar connections for the battery cell 116 may be maintained along the upper surface of each battery module layer 112. Also as described elsewhere herein, venting of materials from a venting event of the battery cells 116 may occur along the upper surface of each battery module layer 112.

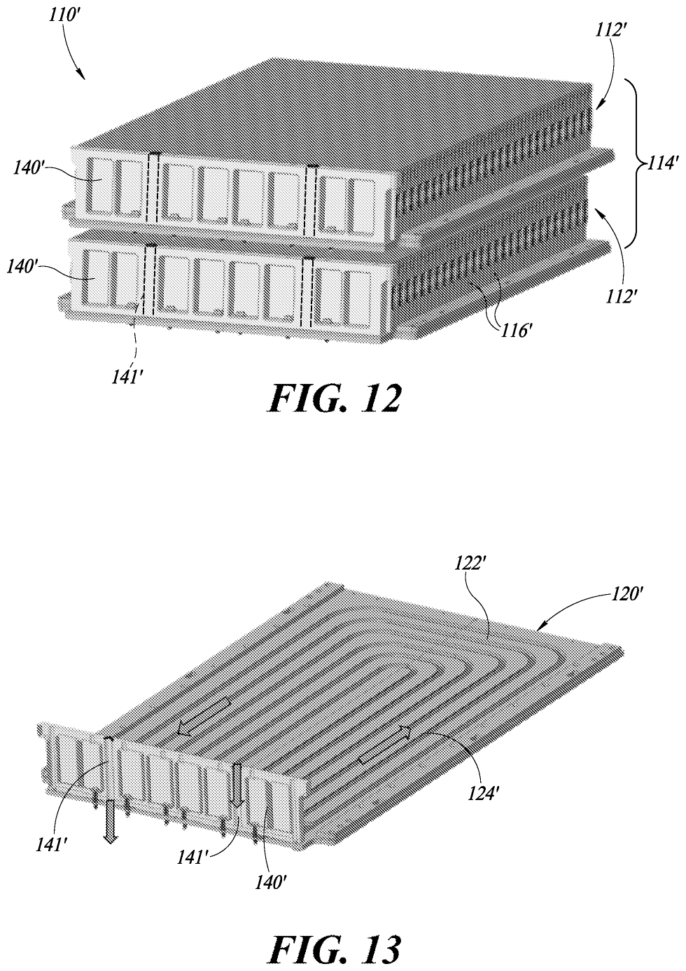

Although the embodiment shown in FIGS. 9 through 11 depicts the use of a plurality of conduits 127 and fittings 126 for routing heat transfer medium between layers of the battery pack 110, it is appreciated that other means of routing the heat transfer medium throughout the battery pack may be provided. For example, according to one variant, the conduits 127 and fittings 126 shown in FIG. 9 may be replaced by a manifold with one or more internal passages that span between adjacent battery cold plates of the battery pack. An example of such an embodiment is shown and described with reference to FIGS. 12 and 13.

As shown in FIG. 12, there is provided a battery pack 110′ that includes a plurality of battery module layers 112′ stacked to form a multi-layer battery stack 114′, with each battery module layer 112′ including a plurality of battery cells 116′ arranged in an array and connected in series with each other and all other battery cells 116′ of the battery pack 110′. Again, a sufficient number of the battery cells 116′ may be connected together in series to provide a target battery pack voltage, for example, in a range of between and including 600V and 1200V that is common to each of a plurality of common battery packs 110′. The common battery packs 110′ can then be connected in parallel with each other to increase vehicle power and vehicle range of a host commercial vehicle as desired or required.

Again, to increase energy density, it is advantageous to provide the battery cells 116′ of the battery pack 110′ in the plurality of module layers 112′. While the illustrated embodiment of FIG. 12 shows only two stacked battery module layers 112′, it is appreciated that the number of battery module layers 112′ may vary and include three, four, five or more battery module layers 112′. Further, in some lower capacity applications, a single battery layer 112′ may be provided. For a given vehicle, or for a fleet or a collection of vehicles, it is advantageous in some embodiments to provide a same number of battery module layers 112′ in the battery packs 110′ thereof such that the battery packs 112′ have a common form factor for the particular vehicle, or for the fleet or the collection of vehicles.

With reference to FIGS. 12 and 13, the plurality of battery module layers 112′ may be stacked in a vertical direction to form a multi-layer battery stack 114′ with each battery module layer 112′ including a plurality of the battery cells 116′ arranged in a linear array. Each battery module layer 112′ may further include a thermal management device 120′, such as an active heat exchanger (also referred to as a cold plate), that is in direct thermal engagement with the array of battery cells 116′ to provide cooling or heating of the battery cells 116′ in operation. Advantageously, unlike the embodiment shown and described with respect to FIGS. 9 through 11, the battery pack 110′ of FIG. 12 is provided with a connecting manifold 140′ that extends between a lower one of the thermal management devices 120′ and an upper one of the thermal management devices 120′ and replaces the conduits 127 and fittings 126 shown in the embodiment of FIGS. 9 through 11. As can be appreciated in the partially cutaway view of FIG. 13, the connecting manifold 140′ includes heat transfer medium passages 141′ arranged to provide fluid communication between the lower thermal management device 120′ and the upper thermal management device 120′ in order to facilitate distribution of a heat transfer medium through each of the lower thermal management device 120′ and the upper thermal management device 120′ during operation to provide heating or cooling functionality for the plurality of battery cells 116′ of the battery module layer(s) 112′. Additionally, each of the lower and upper thermal management devices 120′ may comprise an active heat exchanger (e.g., battery cold plate) having a generally planar manifold 122′ that includes at least one heat transfer medium passageway 124′ (FIG. 13) to facilitate the circulation of the heat transfer medium through the planar manifold 122′ during operation to assist in drawing heat away from the battery cells 116′ to cool the battery cells 116′ or, alternatively, supplying heat to the battery cells 116′ to heat the battery cells 116′.

As shown in FIGS. 12 and 13, the connecting manifold 140′ is positioned at an end of the battery pack 110′ and extends vertically between battery cold plates of the lower and upper thermal management devices 120′. The connecting manifold 140′ is configured to assist in securing the plurality of battery cells 116′ in place within the battery pack 110′ between the lower and upper thermal management devices 120′, and also serves as a structural support between the lower and upper thermal management devices 120′ to help maintain a rigid connection between adjacent thermal management devices 120′ and provide a particularly robust battery stack 114′. The connecting manifold 140′ may also serve as one of opposing hold down members that assist in fixedly securing the battery cells 116′ together within the battery pack 110′ between said hold down members. Notably, connections (e.g., bolted connections) between the connecting manifold 140′ and the thermal management devices 120′ may be located such that the connecting manifold 140′ and an opposing hold down member may apply a compressive force to the battery cells 116′ of the battery module layer 112′. Still further, although not illustrated in FIG. 12, it is appreciated that a compression strap, tie rods or other devices may be provided between the connecting manifold 140′ and an opposing hold down member to assist in applying a compressive load to the battery cells 116′.

With reference to FIG. 13, which shows one of the thermal management devices 120′ and the connecting manifold 140′ with select cutaway sections to reveal internal passages, the connecting manifold 140′ of the illustrated embodiment includes a plurality of heat transfer medium passages 141′ for providing fluid communication between adjacent thermal management devices 120′. As shown in FIG. 13, representative arrows are provided to illustrate one example routing of heat transfer medium through the connecting manifold 140′ and the thermal management device 120′. For instance, heat transfer medium may enter and pass through one passage 141′ of the connecting manifold 140′ after passing through an overlying thermal management device 120′ (not shown in FIG. 13) and then enter an underlying thermal management device 120′ at an opening (e.g., inlet) provided in one region of the underlying thermal management device 120′ that communicates with the aforementioned passage 141′. The heat transfer medium may then circulate through one or more passageways 124′ of the underlying thermal management device 120′ toward an opening (e.g., outlet) provided in another region of the underlying thermal management device 120′, which in turn may be in fluid communication with a passage 141′ of another connecting manifold 140′ of an adjacent layer of the battery pack to provide sequential flow through the battery stack 114′. In this manner, it will be appreciated that at least one of the passages 141′ of each connecting manifold 140′ may be blocked to assist in routing the heat transfer medium through the battery pack in a desired path when the blocked passage is not along the desired path. Moreover, it will be appreciated that the connecting manifolds 140′ of the battery stack 114′ may be configured in various embodiments to route the heat transfer medium through the thermal management devices 120′ of a battery pack 110′ in series, in parallel, or in a combination thereof. Still further, although the example embodiment shows routing of the heat transfer medium via a series of connecting manifolds 140′ on one side of the battery pack 110′, it is appreciated that one or more similarly constructed manifolds may be provided at one or more other sides or locations of the battery pack 110′ to provide a variety of routing options. Other features and benefits of utilizing connection manifolds 140′ in connection with the battery packs described herein will be appreciated by a thorough review of the illustrated embodiments.

With reference now to FIG. 14, it is emphasized here that embodiments of the battery packs 10, 110, 110′ and related battery technology described above and elsewhere throughout this disclosure may be utilized in a common form factor for a particular vehicle, or for a fleet or a collection of vehicles having different vehicle attributes, such as the long-haul tractors 1A, 1B, 1C, 1D depicted in plan view in FIG. 14, that may each have a different wheelbase, other configuration difference, and/or a different performance capability. In addition, as discussed above, for such a fleet or collection of vehicles, the common battery packs 10, 110, 110′ can be arranged in a variety of different configurations or arrangements A₁, A₂, A₃, A₄. Such arrangements A₁, A₂, A₃, A₄ may feature, for example, a different number of battery packs 10, 110, 110′ battery packs 10, 110, 110′ oriented in different directions, and/or battery packs 10, 110, 110′ positioned at different locations or positions on the vehicles 1A, 1B, 1C, 1D. FIG. 14 illustrates in some non-limiting examples four different battery pack arrangements A₁, A₂, A₃, A₄ that are particularly well suited for a fleet of long-haul tractors.

Having a common battery pack 10, 110, 110′ for a particular vehicle, or for a fleet or a collection of vehicles, can be particularly advantageous for a variety of reasons. For example, battery pack 10, 110, 110′ at different locations is exposed to different ambient conditions, the capacity of battery cells 16, 116, 116′ in some battery packs 10, 110, 110′ may drop faster than others. The embodiments described herein may provide common battery packs 10, 110, 110′ with an identical form factor that enable each of the common battery packs 10, 110, 110′ to be exchanged with the others to facilitate periodic rearranging of the common battery packs 10, 110, 110′ on the host vehicle 1A, 1B, 1C, 1D. Or, as another example, common battery packs 10, 110, 110′ having an identical form factor enable any one of the common battery packs 10, 110, 110′ to be replaced with a new battery pack 10, 110, 101′ of the same form factor. This has significant service benefits.

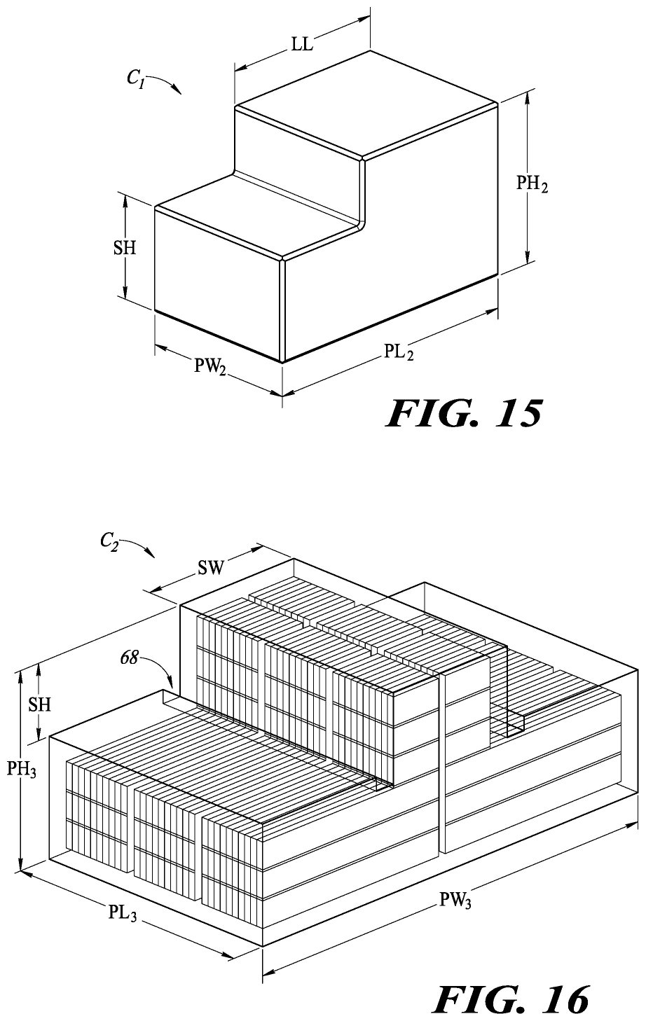

Although embodiments of the battery packs 10, 110, 110′ have been shown and described herein as having a generally rectangular form factor, it is appreciated that battery packs may be provided in a variety of other form factors. For instance, battery packs may be provided in a T-shape, L-shape, boot-shape or stairstep-shape configuration, as shown, for example, in FIGS. 15 and 16.

With reference to FIG. 15, at least one of the battery packs may be provided in a L-shape, boot-shape or stairstep-shape configuration C₁, and may have in one non-limiting example an overall pack length PL₂ of 1100±150 mm, an overall pack height PH₂ of 600±100 mm, an overall pack width PW₂ of 600±100 mm, a lower step height SH of 425±75 mm, and an upper landing length LL of 600±100 mm. Such a L-shape, boot-shape or stairstep-shape configuration C₁ may be particularly advantageous in nesting the battery packs with one or more components of a host vehicle 1, such as the rails 4 of a chassis 2 of a tractor. In particular, a battery pack may be positioned with a lower step portion of the L-shape, boot-shape or stairstep-shape configuration C₁ beneath a rail 4 of the chassis 2. For this purpose, an enclosure of the battery pack may be provided with one or more features, such as rail channels or cavities, to assist in nesting the battery pack with the rails 2.

With reference to FIG. 16, at least one of the battery packs 10, 110 may be provided in a T-shape configuration C₂, and may have in one non-limiting example an overall pack length PL₃ of 1250±150 mm, an overall pack height PH₃ of 600±100 mm, an overall pack width PW₃ of 2200±100 mm, a stem width SW of 600±100 mm, and a stem height SH of 200±75 mm. Such a T-shape configuration C₂ may also be particularly advantageous in nesting the battery packs with one or more components of a host vehicle 1, such as the rails 4 of a chassis 2 of a tractor. In particular, a battery pack may be positioned with a stem portion of the T-shape configuration C₂ nested between rails 4 of the chassis 2. For this purpose, the enclosure of the battery pack may be provided with one or more features, such as rail channels 68, to assist in nesting the battery pack with the rails 4.

Again, the shapes shown in FIGS. 15 and 16 are non-limiting examples and other shapes that are built-up from stacks of linear arrays of battery cells beyond those illustrated are also contemplated.

The battery packs 10, 110, 110′ described herein can further be utilized in connection with a battery pack system having a thermal management system that is centralized or distributed, or a hybrid thereof. For example, the thermal management system may include a centralized chiller for all of the common battery packs 10, 110, 110′ for distributing a heat transfer medium to the common battery packs 10, 110, 110′ for cooling purposes. As another example, the thermal management system may include a plurality of chillers associated with the common battery packs 10, 110, 110′ for distributing a heat transfer medium to the common battery packs 10, 110, 110′ for cooling purposes. As yet another example, the thermal management system may include a respective chiller associated with each of the common battery packs 10, 110, 110′ for routing a heat transfer medium to the common battery pack 10, 110, 110′ for cooling purposes. Similarly, the thermal management system may include a centralized heater for all of the common battery packs 10, 110, 110′ for distributing a heat transfer medium to the common battery packs 10, 110, 110′ for heating purposes. Or, the thermal management system may include a plurality of heaters associated with the common battery packs 10, 110, 110′ for distributing a heat transfer medium to the common battery packs 10, 110, 110′ for heating purposes. For example, the thermal management system may include a respective heater associated with each of the common battery packs 10, 110, 110′ for routing a heat transfer medium to the common battery pack 10, 110, 110′ for heating purposes. Notably, any of the chiller arrangements outlined above can be combined with any of the heater arrangements outlined above. For instance, in some implementations, the thermal management system may include a centralized chiller for all of the common battery packs for distributing a heat transfer medium to the common battery packs for cooling purposes (i.e., a centralized chiller system), and a respective heater associated with each of the common battery packs for routing a heat transfer medium to the common battery packs in a distributed manner for heating purposes (i.e., a distributed heater system).

The battery packs 10, 110, 110′ described herein can further be utilized in connection with a battery pack system having a centralized battery management system (BMS) for providing centralized monitoring and control functionality for the common battery packs; or a master-slave battery management system (BMS) for providing distributed monitoring and control functionality for the common battery packs.

The battery packs 10, 110, 110′ described herein can further be utilized in connection with a battery pack system having a centralized charging system comprising a single charger for charging the common battery packs; or a distributed charging system comprising a plurality of chargers for charging the common battery packs.

In view of the above disclosure, it will be appreciated that vehicles, in particular commercial vehicles, may be provided that include a battery pack system having a plurality of common battery packs in accordance with embodiments of the battery packs described above and elsewhere in this disclosure. The vehicles may include a chassis and the common battery packs may be positionable along the chassis to optimize a weight distribution of the vehicles. For instance, the vehicles may be long-haul tractors having different wheelbases and the battery packs may be arranged differently to distribute weight differently in each vehicle to account for various differences in the tractors. The chassis, which may be a chassis of a long-haul tractor, may include chassis rails and the battery packs may be positioned under the chassis rails or alongside the chassis rails. The battery packs may be arranged in a common plane or may be arranged at one or more different elevations, and may be arranged in a common pack orientation or different pack orientations. Further, a fleet of the vehicles may have a drive system that is common among the vehicles regardless of a number of the common battery packs that are connected in parallel for each vehicle.

Battery Packs with Sub-Modular Construction

Although the embodiment of the battery pack 10 illustrated in FIGS. 2 to 6 and the embodiment of the battery pack 110 illustrated in FIGS. 9 through 11 discussed above each depicts all of the battery cells 16, 116 of the battery module layer 12, 112 as being arranged together as a single compressed array of battery cells 16, 116 it is appreciated that embodiments of the battery packs 10, 110 disclosed herein may feature battery module layers 12, 112 that are formed from a plurality of sub-modules 18. For example, as shown in FIG. 17, discrete subsets of the plurality of battery cells 16 of a given battery module layer 12 may be held together in sub-modules 18 with each sub-module 18 being configured to be fixedly secured to the thermal management device 20 (e.g., active heat exchanger or battery cold plate) and/or an adjacent sub-module 18. In the illustrated embodiment, for example, subsets of six individual battery cells 16 are held together in sub-modules 18 by opposing sub-module brackets 70 secured to each of opposing ends of the battery cells 16. Alternatively, the discrete subsets of the battery cells 16 may be held together in the sub-modules 18 via one or more straps, clamps or other coupling arrangements. The straps, brackets 70, clamps or other coupling arrangements may be configured to hold the battery cells 16 of each sub-module 18 together in a rigid manner to enable each sub-module 18 to be independently manipulated in space during assembly of the sub-modules 18 into one or more battery module layers 12 of a multi-layer battery stack. Further, the straps, brackets 70, clamps or other coupling arrangements enable the battery cells 16 to be held together absent structural adhesive in some embodiments. The omission of structural adhesive may provide manufacturing and other benefits, such as the recycling of battery cells 16 after the battery pack 10 is removed from the vehicles. In other embodiments, a structural adhesive and/or a thermal adhesive or paste may be provided between the battery cells 16.

As shown in FIG. 17, the sub-modules 18 are connectable together in at least a longitudinal direction D_{L} which is aligned with a direction D_{C} in which the battery cells 16 of the battery module layer 12 extend in the array. The sub-modules 18 may be connected together, for example, by fasteners, latches, interlocks 72 or other connecting devices or means. Additionally, the sub-modules 18 may be connectable together in a vertical direction D_{V} which is normal to the direction D_{C} in which the battery cells 16 of the battery module layer 12 extend in the array. The connections may be made, for example, at the straps, brackets 70 or clamp arrangements that hold the battery cells 16 of the sub-modules 18 together.

In the example embodiment of the battery pack stack of FIG. 17, the sub-modules 18 are fixedly connected together by interlocks 72 provided on the sub-module brackets 70, and fixedly secured to the underlying thermal management device 20 by fasteners (e.g., bolts). The fasteners may be aligned with, or recessed with respect to, an outer peripheral edge of the thermal management device 20. The straps, brackets 70, clamps or other coupling arrangements may be configured to fix each sub-module 18 to the underlying thermal management device 20 in a manner that urges the battery cells 16 into contact with the thermal management device 20 or an intervening thermally conductive material (e.g., thermal paste or thermal pad). This may be accomplished by drawing the battery cells 16 into close thermal contact with the thermal management device 20 or an intervening thermally conductive material as bolts are tightened into the thermal management device 20, and more particularly a perimeter portion of the thermal management device 20.

While only a portion of a single battery module layer 12 comprising two sub-modules 18 is shown in FIG. 17, it is appreciated that numerous sub-modules 18 may be provided, such as, for example, three, four, five, six, seven, eight, nine, ten or more sub-modules 18 for any given battery module layer 12. In addition, it is appreciated that the sub-modules 18 may be built up in a multi-directional array to form two or more battery module layers 12, including three, four, five, six, or more battery module layers 12 stacked in the vertical direction D_{V}. In an embodiment, the sub-modules in a given battery module layer 12 are connectable together in the longitudinal direction D_{L} via the interlocks 72 to form the given layer 12, while the assembled battery module layers 12 are stacked and coupled to other layers with fasteners (e.g., bolts). Alternatively, the connection between each layer 12 in the stacked arrangement may be accomplished via interlocks 72 or other coupling arrangements to eliminate bolted connections in the battery stack.

With continued reference to FIG. 17, each sub-module 18 may comprise one or more end plates 74 that provide thermal insulation and/or a protective shield between the sub-module 18 and one or more adjacent sub-modules 18. Additionally, fire retardant material (not illustrated) may be provided between adjacent sub-modules 18. The fire retardant material may be secured to or integrated with each sub-module 18, or may be provided as a separate element between adjacent sub-modules 18 for fire protection purposes. In addition, or alternatively, each sub-module 18 may comprise fire retardant material between each of at least some of the battery cells 16 of the sub-module 18. Furthermore, in some embodiments, each sub-module 18 may comprise thermal resistant material (e.g., a thermal insulator) between each of at least some of the battery cells 16 of the sub-module 18 to prevent or delay the propagation of thermal runaway.

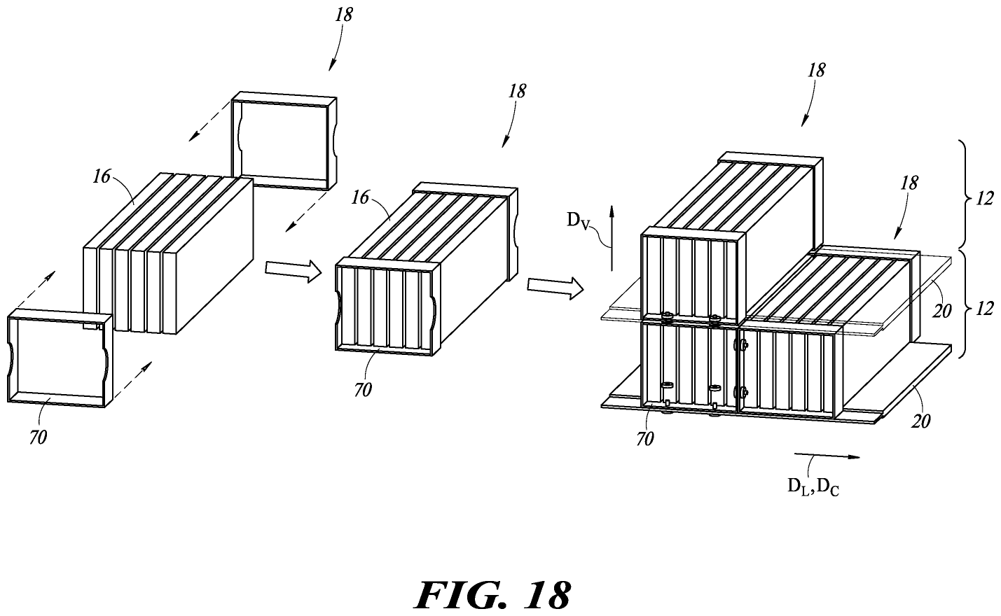

FIG. 18 illustrates a variant in which the sub-modules 18 are connected together and to adjacent thermal management devices 20 by fasteners. As shown, the sub-modules 18 may be built up in a multi-directional array to form a plurality of battery module layers 12. Notably, in the vertical direction D_{V}, the sub-modules 18 are connected together via the intermediary of an intervening thermal management device 20 (e.g., battery cold plate). In this arrangement, the fasteners may pass through each of the upper and lower sub-modules 18, and more particularly the sub-module brackets 70, as well as the thermal management device 20 to secure all of the components together. In addition, as shown in the leftmost illustrations of FIG. 18, the sub-module brackets 70 (or straps, clamps or other coupling arrangements) may extend beyond end faces of the battery cells 16 and include clearance for an elongated bus bar to span across the end faces of the battery cells 16.

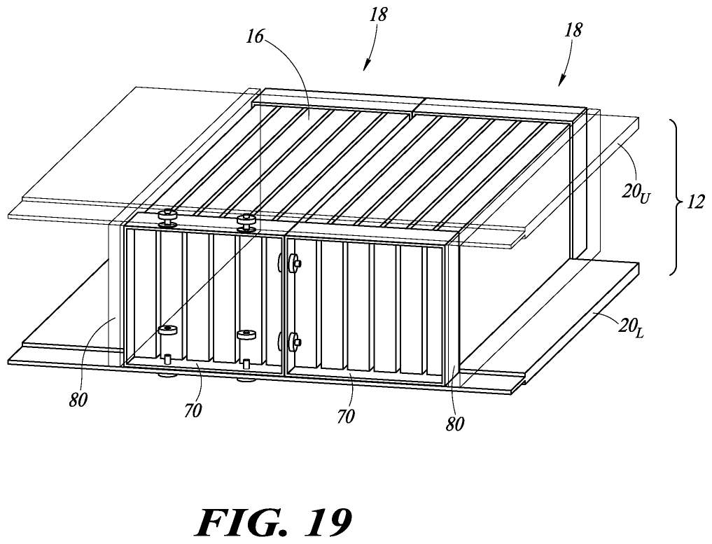

FIG. 19 illustrates a further variant in which a plurality of structural supports 80 are positioned to extend between a lower thermal management device 20L of one battery module layer 12 and an upper thermal management device 20u of an overlaying battery module layer 12 to support the upper thermal management device 20u in position above the lower thermal management device 20L and to assist in eliminating or reducing appreciable deflection of the upper thermal management device 20L. The structural supports 80 may be removably attached to the lower and upper thermal management devices 20, or formed integrally therewith. Each structural support 80 may comprise an elongate form factor that extends an entirety or substantially an entirety of a longitudinal length of the battery cells 16, or beyond. The structural supports 16 may comprise at least two structural supports that are spaced apart along a longitudinal length of the battery module layer 12 with at least some of the battery cells 16 positioned therebetween. The structural supports 80 may comprise at least three structural supports that are spaced apart along a longitudinal length of the battery module layer 12 in equidistant intervals with at least some of the battery cells 16 positioned between adjacent structural supports 80. Each of the structural supports 80 may be positioned immediately next to one of the sub-modules 18. The structural supports 80 may be provided at ends of the battery module layer 12 to serve as a shield to protect the battery cells 16 therebetween. The structural supports 80 may interface with the one or more of the straps, brackets 70, clamps or other coupling arrangements that hold each of the sub-modules 18 together, or otherwise cover at least a portion of the straps, brackets 70, clamps or other coupling arrangements. The structural supports 80 may provide thermal insulation between some of the battery cells 16 in the battery module layer 12 and others of the battery cells 16 in the battery module layer 12. The structural supports 80 may be covered at least in part with a thermal insulation material and/or a fire retardant material.

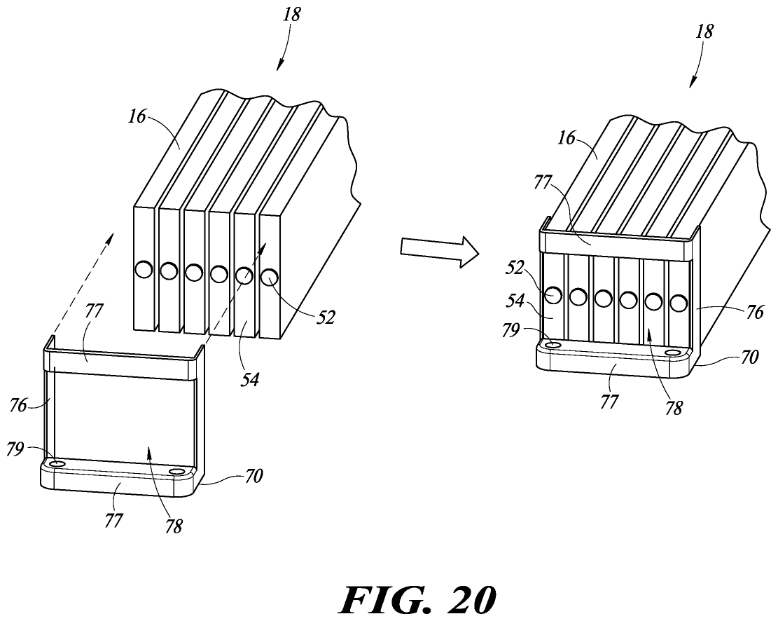

FIG. 20 shows a sequence of assembling a sub-module 18 of battery cells 16 together using a variant of a sub-module bracket 70. The sub-module bracket 70 is configured to be fastened to an underlying structure, such as, for example, the thermal management device 20. The sub-module bracket 70 includes sidewalls 76 that are spaced to hold a select number of individual battery cells 16 (in this case five battery cells 16) together in close contact. The sub-module bracket 70 may further include a window 78 or clearance aligned with the end faces 54 of the battery cells 16 such that the electrode terminals 52, for example, can be accessed and connected together by a bus bar arrangement and to an electrical system of the host vehicle. The sub-module bracket 70 (or alternatively, straps, clamps or other coupling arrangements) may be configured to hold the battery cells 16 of each sub-module 18 together in compression. This may be accomplished by compression of a pad in between cells 16, elastic deformation of the sidewalls 76 of the sub-module bracket 70, or by other devices or means, such as, for example, tie rods or clamping mechanisms. The sub-module bracket 70 further includes end structures 77 extending between and integrally formed with the sidewalls 76 and arranged normal to the sidewalls 76. The end structures 77 are structured to interface with the end faces 54 of the battery cells and assist in preventing lateral movement of the cells 16 in the stack while also providing structural support to the sub-module 18. The end structures 77 and the sidewalls 76 cooperate to maintain close contact of the cells 16 with the thermal management device 20 in multiple directions. An upper end structure may have a generally thinner form factor while a lower end structure may extend away from the end faces 54 of the cells 16 to provide means for the connection of the bracket 70 to the underlying structure, such as a fastener apertures 79.

Cold Plate with Integral Fins

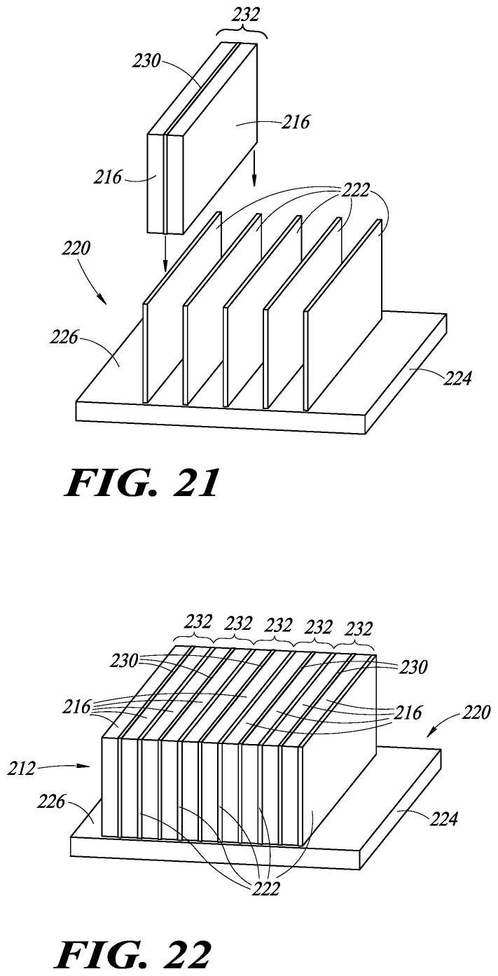

With reference now to FIG. 21, a battery pack according to a further embodiment is provided, which includes a thermal management device in the form of a heat exchanger 220 having a plurality of integral fin members 222. In some advantageous instances, the heat exchanger 220 is an active heat exchanger, which includes one or more internal passageways through which a heat exchange medium is actively circulated during operation, and may also be referred to herein as a battery cold plate (despite that it may provide both cooling and heating functionality). As shown in FIG. 21, the heat exchanger 220 has a main body 224, through which a heat exchange medium may flow. The main body 224 of the heat exchanger 220 has a first major surface 226 that faces upward as illustrated in FIG. 21. The first major surface 226 may be planar or substantially planar. In some alternative embodiments, a heat exchange medium does not flow through the main body 224, and the main body is coupled to another component which provides the heat exchange functionality of the system, such as a separate heat exchanger component interfaced with the main body 224. In such alternatives, the main body 224 may be in direct contact with the heat exchanger component, with no non-metallic materials, including adhesives, between a base of the main body 224 and the heat exchanger.

As illustrated in FIG. 21, the heat exchanger 220 includes the fin members 222, each of which includes a relatively thin sheet or plate of material that extends directly outward from (e.g., perpendicular to) the first major surface 226 of the heat exchanger 220, as well as directly across the first major surface 226 of the heat exchanger 220. A thickness of each of the fin members 222 is substantially smaller than a thickness of the main body 224 of the heat exchanger 220. Each of the fin members 222 extends parallel to or substantially parallel to each of the other fin members 222. Each of the fin members 222 is integrally or monolithically formed with the main body 224 of the heat exchanger 220 at the first major surface 226 thereof. For example, the fin members 222 and the main body 224 can be formed of metallic materials and the fin members 222 can be welded to the main body 224. Alternatively, the fin members 222 and the main body 224 can be formed together from a single piece of larger material, such as by machining or by casting the fin members 222 and the main body 224 as a single piece of material.

FIG. 21 also illustrates a plurality of battery cells 216 being installed on the heat exchanger 220. As illustrated in FIG. 21, the battery cells 216 can be installed on the heat exchanger 220 in pairs, where each pair of battery cells 216 includes a fire retardant material and/or a compression pad 230 positioned between the pair of battery cells 216. Thus, the first retardant material and/or the compression pad 230 can be sandwiched between the pair of battery cells 216 to form a battery cell unit 232, where the entire battery cell unit 232, but only a single battery cell unit 232, can be installed between an adjacent pair of the fin members 222 of the heat exchanger 220, such as by moving the battery cell unit 232 vertically downward as illustrated in FIG. 21, and toward the first major surface 226 of the main body 224 of the heat exchanger in a direction perpendicular to the first major surface 226. In some embodiments, outer surfaces of the battery cell unit 232, that is, a first major surface of a first one of the battery cells 216 and a first major surface of a second one of the battery cells 216 opposite to the first one of the battery cells 216, can be bonded to the adjacent fin members 222, such as by chemical bonding, such as by an adhesive, glue, epoxy, etc., which may include a thermal paste and/or thermal adhesive. In other instances, each battery cell unit 232 may be installed between opposing fins 222 without chemical bonding, and, in some instances, may be held by compression fit or the like.

FIG. 22 illustrates a plurality of battery cell units 232 installed on the heat exchanger 220 as described for the battery cell unit 232 including the battery cells 216. As illustrated in FIG. 22, each of the battery cells 216 and each of the fin members 222 have the same height, or substantially the same height, in a direction extending away from the first major surface 226 of the main body 224 of the heat exchanger 220. Furthermore, the battery cells 216 and the fin members 222 each have a respective first major surface and a respective second major surface opposite to the first major surface, where each of these major surfaces of each of the battery cells 216 and the fin members 222 have the same, or substantially the same, surface area. As illustrated in FIG. 22, the plurality of battery cell units 232 installed on the heat exchanger 220 form a battery module layer 212 composed of a plurality of individual battery cells 216. In such a system, the fin members 222 provide structural support for the individual battery cells 216 and the battery module layer 212, that is, they can act as anchors for the cells 216. The fin members 222 also increase the heat exchange capacity of the heat exchanger 220 (enhancing its heating and/or cooling performance) and improve heat transfer between the cells 216 and the heat exchanger 220, by increasing a degree of contact between the heat exchanger 220 and the individual battery cells 216.

As illustrated in FIG. 22, the system includes two individual battery cells 216 for every one of the fin members 222, and one set of the fire retardant material and/or compression pad 230 for every two of the individual battery cells 216. In alternative embodiments, however, different arrangements can be provided. For example, the system may include one individual battery cell 216 for every one of the fin members 222, and one fire retardant material and/or one compression pad 230 for every one of the individual battery cells 216, or three individual battery cells 216 for every one of the fin members 222, and one fire retardant material and/or compression pad 230 for every three of the individual battery cells 216, or four individual battery cells 216 for every one of the fin members 222, and one fire retardant material and/or compression pad 230 for every four of the individual battery cells 216, etc.

As illustrated in FIGS. 21 and 22, the heat exchanger 220 includes a plurality of fin members 222 that extend outward from the first major surface 226 of the main body 224 of the heat exchanger 220. In some embodiments, a multi-layer battery stack may be provided similar to, for example, the multi-layer battery stacks 14, 114 described above with respect to FIGS. 2 through 6 and 9 through 11. Accordingly, the multi-layer battery stack can include a plurality of heat exchangers 220 stacked together with a plurality of battery module layers 212 in an alternating manner. In such embodiments, every one of the heat exchangers 220 and every one of the battery module layers 212 can be configured as illustrated in FIGS. 21 and 22. In some alternative embodiments, however, some of the heat exchangers 220 (e.g., every other one of the heat exchangers 220) can have a first plurality of fin members 222 that extend outward from the first major surface 226 of the main body 224 of the heat exchanger 220 and a second plurality of fin members 222 that extend outward from a second major surface of the main body 224 of the heat exchanger 220, where the second major surface is opposite to the first major surface. In such embodiments, some of the heat exchangers 220 (e.g., every other one of the heat exchangers 220) can be provided without the fin members 222. These two different types of heat exchangers 220 can alternate with one another in the multi-layer battery stack such that each of the battery module layers 212 is coupled to fins extending either from an upper major surface or a lower major surface of a heat exchanger 220.

In either of these embodiments, each of the battery module layers 212 can be in physical and thermal contact with two distinct heat exchangers 220, one on each of opposite sides thereof, to increase or otherwise improve the heat exchange capacity of the system. Furthermore, the battery module layers 212 and heat exchangers 220 may be held in compression when they are stacked in a multi-layer battery stack, such as in a stacking direction thereof, to, among other things, increase or otherwise improve the heat exchange capacity of the system.

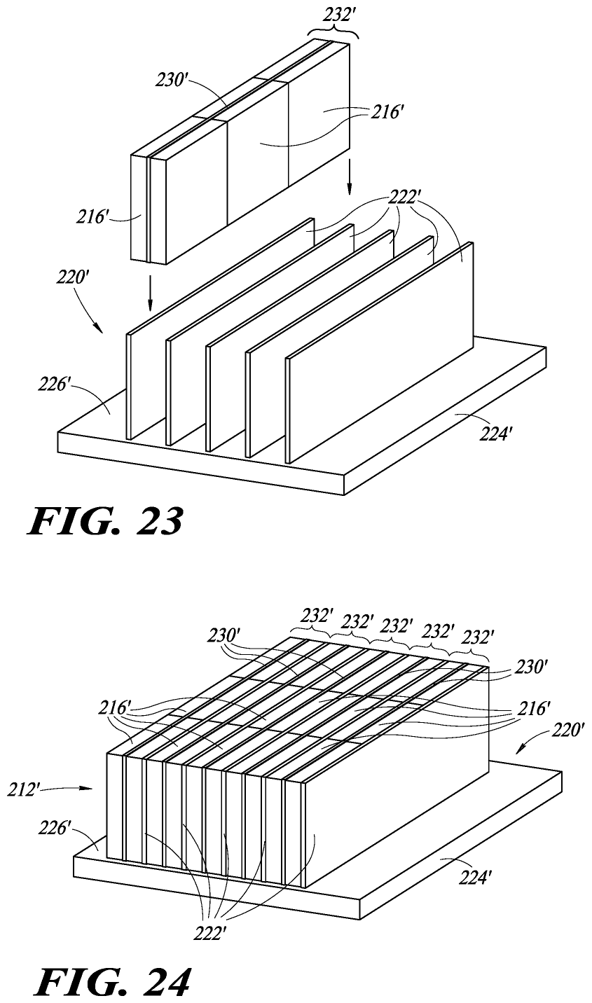

With reference now to FIG. 23, a battery pack according to yet a further embodiment is provided, which is similar in many aspects to the embodiment of FIGS. 21 and 22 but wherein a plurality of battery cells 216′ having a different form factor (such as, for example, the form factor of the battery cell 16′ disclosed above with reference to FIG. 8) are aligned end-to-end transversely across a width of the heat exchanger 220′. As illustrated in FIG. 23, and similar to the above described embodiment, a heat exchanger 220′ is shown to include fin members 222′, each of which comprises a relatively thin sheet or plate of material that extends directly outward from (e.g., perpendicular to) a first major surface 226′ of the heat exchanger 220′, as well as directly across the first major surface 226′ of the heat exchanger 220′. A thickness of each of the fin members 222′ is substantially smaller than a thickness of a main body 224′ of the heat exchanger 220′. Each of the fin members 222′ extends parallel to or substantially parallel to each of the other fin members 222′. Each of the fin members 222′ is integrally or monolithically formed with the main body 224′ of the heat exchanger 220′ at the first major surface 226′ thereof.

FIG. 24 illustrates a plurality of battery cells 216′ being installed on the heat exchanger 220′. As illustrated in FIG. 24, the battery cells 216′ can be installed on the heat exchanger 220′ in a pair of rows, where each pair of rows of battery cells 216′ includes a fire retardant material and/or a compression pad 230′ positioned between the pair of rows of battery cells 216′. Thus, the first retardant material and/or the compression pad 230′ can be sandwiched between the pair of rows of battery cells 216′ to form a battery cell unit 232′, where the entire battery cell unit 232′, but only a single battery cell unit 232′, can be installed between an adjacent pair of the fin members 222′ of the heat exchanger 220′, such as by moving the battery cell unit 232′ vertically downward as illustrated in FIG. 23, and toward the first major surface 226′ of the main body 224′ of the heat exchanger in a direction perpendicular to the first major surface 226′. In some embodiments, outer surfaces of the battery cell unit 232′, that is, a first collective surface of a first row of the battery cells 216′ and a first collective surface of a second row of the battery cells 216′ adjacent to the first row of the battery cells 216′, can be bonded to the adjacent fin members 222′, such as by chemical bonding, such as by an adhesive, glue, epoxy, etc., which may include a thermal paste and/or thermal adhesive. In other instances, each battery cell unit 232′ may be installed between opposing fins 222′ without chemical bonding, and, in some instances, may be held by compression fit or the like.

FIG. 24 illustrates a plurality of battery cell units 232′ installed on the heat exchanger 220′ as described for the battery cell unit 232′ including the battery cells 216′. As illustrated in FIG. 24, each of the battery cells 216′ and each of the fin members 222′ have the same height, or substantially the same height, in a direction extending away from the first major surface 226′ of the main body 224′ of the heat exchanger 220′. Furthermore, each row of battery cells 216′ and the fin members 222′ each have a respective first major surface and a respective second major surface opposite to the first major surface, where each of these major surfaces of each of the rows of battery cells 216′ and the fin members 222′ have the same, or substantially the same, surface area. As illustrated in FIG. 24, the plurality of battery cell units 232′ installed on the heat exchanger 220′ form a battery module layer 212′ composed of rows and columns of a plurality of individual battery cells 216′. In such a system, the fin members 222′ provide structural support for the individual battery cells 216′ and the battery module layer 212′, that is, they can act as anchors for the cells 216′. The fin members 222′ also increase the heat exchange capacity of the heat exchanger 220′ (enhancing its heating and/or cooling performance) and improve heat transfer between the cells 216′ and the heat exchanger 220′, by increasing a degree of contact between the heat exchanger 220′ and the individual battery cells 216′.

As illustrated in FIG. 24, the system includes two rows of three individual battery cells 216′ each for every one of the fin members 222′, and one fire retardant material and/or compression pad 230′ for every two rows of the three individual battery cells 216′. In alternative embodiments, however, different arrangements can be provided. For example, the system may include a single row of individual battery cells 216′ for every one of the fin members 222′, and one fire retardant material and/or one compression pad 230′ for each single row of the individual battery cells 216′, or three rows of individual battery cells 216′ for every one of the fin members 222′, and one fire retardant material and/or compression pad 230′ for every three rows of the individual battery cells 216′, or four rows of individual battery cells 216′ for every one of the fin members 222′, and one fire retardant material and/or compression pad 230′ for every four rows of the individual battery cells 216′, etc.

In some embodiments, a multi-layer battery stack may be provided similar to, for example, the multi-layer battery stacks 14 described above with respect to FIGS. 2 through 6 of the multi-layer battery stacks 114 described above with respect to FIGS. 9 through 11. Accordingly, the multi-layer battery stack can include a plurality of heat exchangers 220′ stacked together with a plurality of battery module layers 212′ in an alternating manner. In such embodiments, every one of the heat exchangers 220′ and every one of the battery module layers 212′ can be configured as illustrated in FIGS. 23 and 24 to form a battery stack that is particularly robust and particularly efficient in heating and cooling of the resulting battery stack.

### Bi-Directional Coolant Flow

Battery packs for electric vehicles can contain hundreds of battery cells. The cells can be cooled by the flow of thermal or heat exchange media (such as a liquid or gaseous heat exchange media, e.g., coolant, air, or a refrigerant). During cooling, charging, and other processes, such as when a battery system is operating, battery cells located on an upstream side of the flow of the heat exchange media can have a lower temperature than other battery cells in the battery pack, while batteries on the downstream side of the flow can have a higher temperature than other battery cells in the battery pack. Such a temperature difference between upstream and downstream cells can be higher than 10° C., especially during a fast charge of the battery cells or extended operation of the battery. This type of temperature difference has a significant impact on battery cell capacity fade and impedance growth over time. The battery cells located on the downstream side are exposed to higher temperature and therefore the capacity fades more quickly. This creates a challenge for battery balancing and shortens battery life.

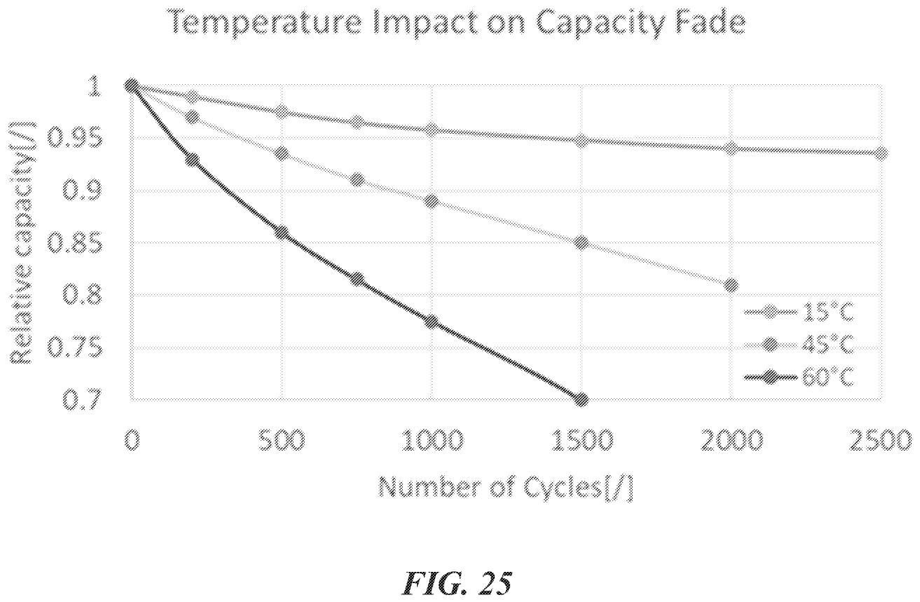

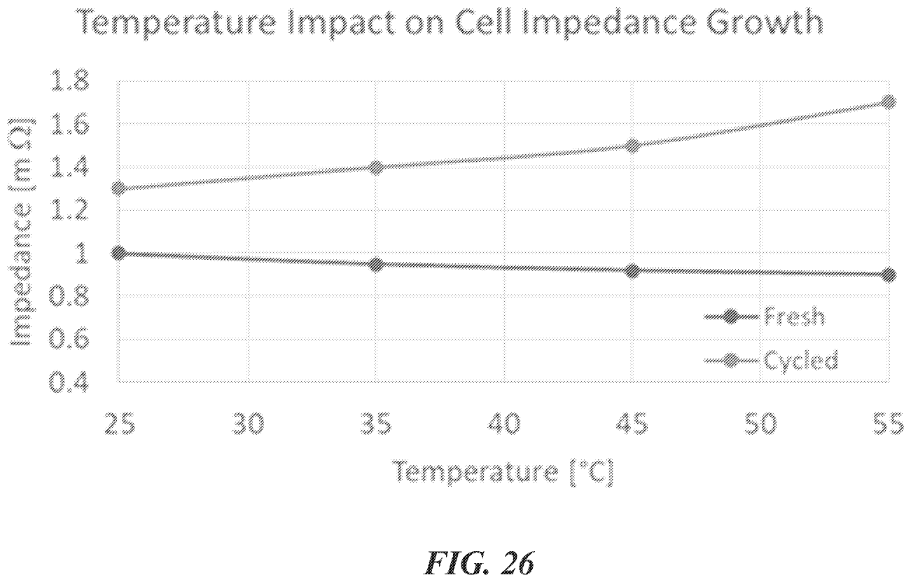

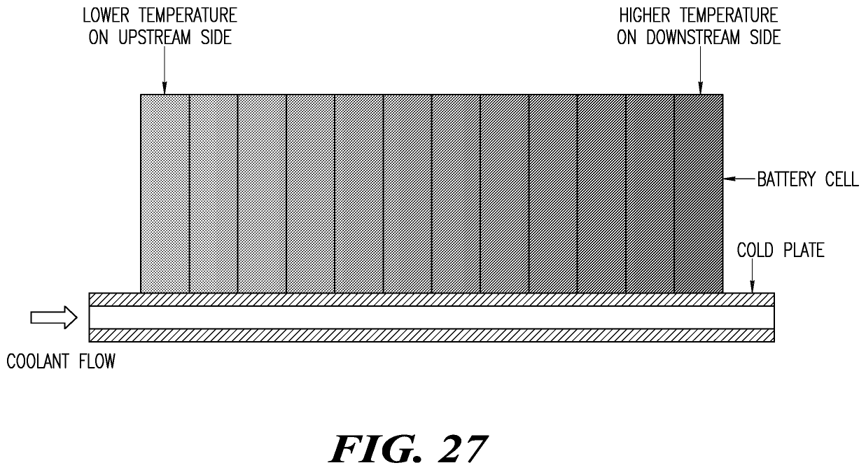

When battery cells are exposed to relatively high temperatures, the capacity of the battery cells fades more quickly, and the impedance of the battery cells increases more quickly, than if they were not exposed to such temperatures. Elevated cell impedances further increase cell temperatures, increasing these imbalances. FIG. 25 shows an effect of temperature cycles on battery cell capacity fade, and FIG. 26 shows an effect of temperature on battery cell impedance growth. FIGS. 25 and 26 illustrate one example of these effects based on a specific battery system, and exact numbers in different battery systems may differ. FIG. 27 illustrates a plurality of battery cells arranged adjacent one another across the width of the page (as shown in FIG. 27), and a coolant flowing from left to right (as shown in FIG. 27) through a thermal management device in the form of an active heat exchanger and, more specifically, a battery cold plate, adjacent the plurality of battery cells. As illustrated in FIG. 27, battery cells at the left (as shown in FIG. 27), and adjacent an upstream portion of the flow of the coolant, are cooled to a relatively low temperature, and battery cells at the right (as shown in FIG. 27), and adjacent a downstream portion of the flow of the coolant, are cooled to a relatively high temperature, as a result of their locations with respect to the flow of the coolant. Concepts of the disclosure alleviate these concerns and provide additional advantages that overcome these and other deficiencies, as described further below.

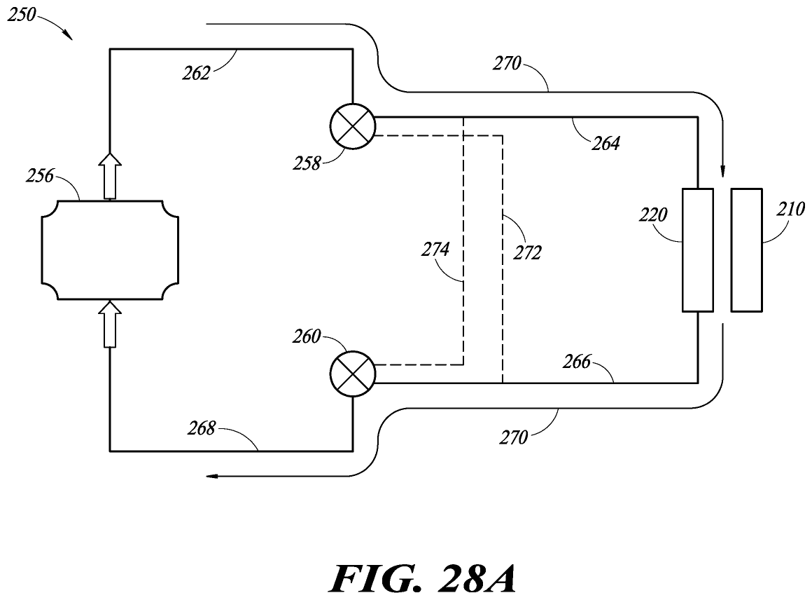

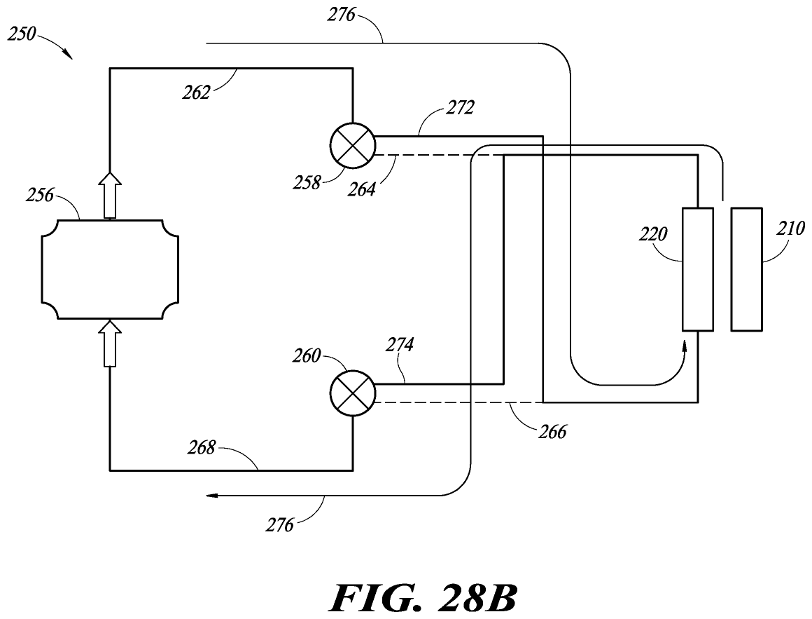

With reference to FIGS. 28A and 28B, a thermal management system 250 for cooling (or alternatively heating) a battery pack 210 according to a further embodiment is provided. The thermal management system 250 includes a thermal management device in the form of an active heat exchanger 220 (or more specifically a cold plate) that is coupled to, or located adjacent to or in close proximity to, battery cells of the battery pack 210. In some instances, the active heat exchanger 220 may be constructed or configured in accordance with the thermal management devices 20, 120, 120′ described and shown with reference to at least FIGS. 2 through 6 and 9 through 13. In other instances, the heat exchanger 220 may also be a different type of heat exchanger than the thermal management device 20, 120, 120′ of the earlier described embodiments. As shown in FIGS. 28A and 28B, the thermal management system 250 includes, in addition to the active heat exchanger 220, a pump 256, a first valve 258, and a second valve 260. The following description provides non-limiting examples where the first and second valves 258, 260 are multi-way valves (e.g., a first three-way valve 258 and a second three-way valve 260), but it is to be appreciated that the disclosure contemplates use of other types of valves. As shown in FIGS. 28A and 28B, the first multi-way valve 258 carries a fluid flowing out of the pump 256, in the sense that fluid flowing through the thermal management system 250 encounters the first multi-way valve first after leaving the pump 256 along its flow path through the thermal management system 250. As shown in FIGS. 28A and 28B, the second multi-way valve 260 carries a fluid flowing into the pump 256, in the sense that fluid flowing through the thermal management system 250 encounters the second multi-way valve last before entering the pump 256 along its flow path through the thermal management system 250.

As illustrated in FIGS. 28A and 28B, the thermal management system 250 includes a first conduit 262 that couples an outlet of the pump 256 to an inlet of the first multi-way valve 258, a second conduit 264 that couples a first outlet of the first multi-way valve 258 to a first end of a heat exchange medium passageway extending through the heat exchanger 220, a third conduit 266 that couples a second end of the heat exchange medium passageway extending through the heat exchanger 220 to a first inlet of the second multi-way valve 260, and a fourth conduit 268 that couples an outlet of the second multi-way valve 260 to an inlet of the pump 256. When the thermal management system 250 is in operation, the first multi-way valve 258 can be switched to allow a heat exchange medium to flow through the first multi-way valve 258 from the first conduit 262 to the second conduit 264, and the second multi-way valve 260 can be switched to allow a heat exchange medium to flow through the second multi-way valve 260 from the third conduit 266 to the fourth conduit 268. In such a configuration, the pump 256 can be operated to pump the heat exchange medium through the system 250 from the outlet of the pump 256, through the first conduit 262, through the first multi-way valve 258, through the second conduit 264, through the heat exchange medium passageway extending through the heat exchanger 220, and thus through the heat exchanger 220 itself, from the first end thereof to the second end thereof, through the third conduit 266, through the second multi-way valve 260, and then through the fourth conduit 268 to the inlet of the pump 256. This flow path can be referred to as a first flow path and is indicated by arrows 270 in FIG. 28A.

As also illustrated in FIGS. 28A and 28B, the thermal management system 250 further includes a fifth conduit 272 that couples a second outlet of the first multi-way valve 258 to the third conduit 266, and a sixth conduit 274 that couples the second conduit 264 to a second inlet of the second multi-way valve 260. When the thermal management system 250 is in operation, the first multi-way valve 258 can be switched to allow a heat exchange medium to flow through the first multi-way valve 258 from the first conduit 262 to the fifth conduit 272, and the second multi-way valve 260 can be switched to allow a heat exchange medium to flow through the second multi-way valve 260 from the sixth conduit 274 to the fourth conduit 268. In such a configuration, the pump 256 can be operated to pump the heat exchange medium through the system 250 from the outlet of the pump 256, through the first conduit 262, through the first multi-way valve 258, through the fifth conduit 272, through a portion of the third conduit 266, through the heat exchange medium passageway extending through the heat exchanger 220, and thus through the heat exchanger 220 itself, from the second end thereof to the first end thereof, through a portion of the second conduit 264, through the sixth conduit 274, through the second multi-way valve 260, and then through the fourth conduit 268 to the inlet of the pump 256. This flow path can be referred to as a second flow path and is indicated by arrows 276 in FIG. 28B.

Thus, as noted in the foregoing, in some cases, depending on the arrangements of the valves 258 and 260, the heat exchange medium can be pumped and flow from the first end of the heat exchange medium passageway extending through the heat exchanger 220 to the second end thereof, or from the second end of the heat exchange medium passageway extending through the heat exchanger 220 to the first end thereof. Thus, by switching the valves 258 and 260 at regular intervals, the thermal management system 250 can alternate the direction of the flow of the heat exchange medium through the heat exchanger 220. The valves 258 and 260 can be actuated and switched to alternate the flow path of the heat exchange medium through the system 250 from time to time. As examples, the valves 258 can be switched to change the flow path of the heat exchange medium from the first flow path to the second flow path once per week, once every two days, once every day, or twice a day. As further examples, the valves 258 and 260 can be switched to change the flow path of the heat exchange medium from the first flow path to the second flow path once every time a vehicle carrying the system 250 is turned off, or once every time the vehicle carrying the system 250 comes to a stop. In some cases, the frequency of the alternation can be greater to increase uniformity of temperature effects on the battery cells in the battery pack 210, and the frequency of the alternation can be decreased if greater uniformity of temperature effects on the battery cells in the battery pack 210 is not needed. In some embodiments, the switching of the valves 258 and 260 can be controlled by a driver of the vehicle carrying the system 250, while in other embodiments, the switching of the valves 258 and 260 cannot be controlled by a driver of the vehicle carrying the system 250. In some embodiments, the switching of the valves 258 and 260 can be controlled by a computer system of the vehicle carrying the system 250, such as at least controller (e.g., controller 455) and/or BMS system described herein, while in other embodiments, the switching of the valves 258 and 260 cannot be controlled by a computer system of the vehicle carrying the system 250.

In some embodiments, the system 250 includes a plurality of temperature sensors, such as a first temperature sensor coupled to one or more battery cells proximate a downstream side of a flow of the heat exchange medium, and configured to measure a temperature of such battery cells, and a second temperature sensor coupled to one or more battery cells proximate an upstream side of the flow of the heat exchange medium, and configured to measure a temperature of such battery cells. In some embodiments, a computer system or controller associated with the system 250, such as at least controller 455 described herein, can be configured to receive signals from such temperature sensors and to operate the system 250, including switching of the first and second valves 258, 260, based on temperatures measured by the sensors. For example, the computer system and/or controller can be configured to switch the valves 258 and 260 if a difference between the temperatures measured by the temperature sensors exceeds a threshold value, such as 5° C., 10° C., 15° C., or 20° C.

As described herein, the system 250 of the illustrated embodiment includes two multi-way valves 258 and 260. In some embodiments, the valves 258 and 260 can be referred to as synchronized dual valves. In alternative embodiments, the system 250 can include a single valve. In other embodiments, the system 250 may not have any valves and may use other devices or techniques to achieve the switching of the flow paths of the heat exchange medium through the heat exchanger 220 as described herein. The heat exchanger 220 can be considered an active heat exchanger in the sense that a heat transfer medium is actively utilized by the heat exchanger for heating or cooling purposes. The heat exchanger 220 may be used to cool the battery pack 210, or the heat exchanger 220 may be used to heat the battery pack 210, in which case the heat exchanger 220 may be referred to as a hot plate. In some embodiments, the heat exchanger 220 can include a heat sink.

As described herein, the system 250 may include a single pump 256. In alternative embodiments, however, two or more pumps may supply the heat exchange medium in opposite directions and the pumps may be operated alternately to supply the heat exchange medium to the at least one heat exchanger 220. In further embodiments, the single pump 256 may be a bi-directional pump configured to supply the heat exchange medium in two different directions (i.e., forward operation to conduit 262 or reverse operation to conduit 268 with a single pump 256) to perform at least some of the techniques described above. In such embodiments, the valves 258 and 260 may be omitted from the system 250. In some embodiments, the battery pack 210 includes a plurality of battery module layers that are stacked, such as in a vertical direction, where each battery module layer includes a respective plurality of battery cells arranged in a planar array and a respective active heat exchanger, and the heat exchange passageway extends through each of the heat exchangers of the battery module layers (similar to the embodiments described above with respect to at least FIGS. 2 through 6 and 9 through 13). In still further embodiments, the system 250 may be associated with a single battery pack 210 in a distributed heating and cooling system, or the system 250 may be associated with a plurality of common battery packs, similar to the systems and arrangements of such systems described at least with reference to FIGS. 1 through 16.

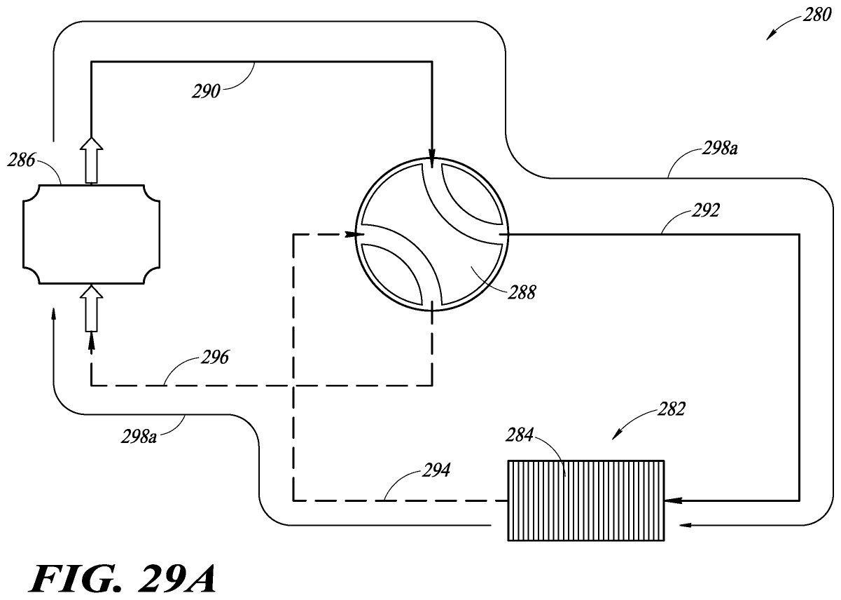

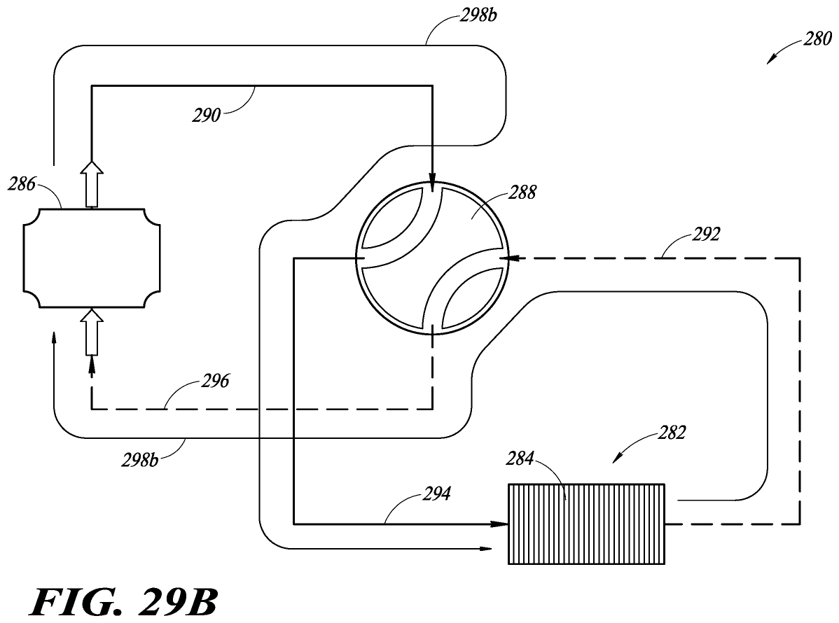

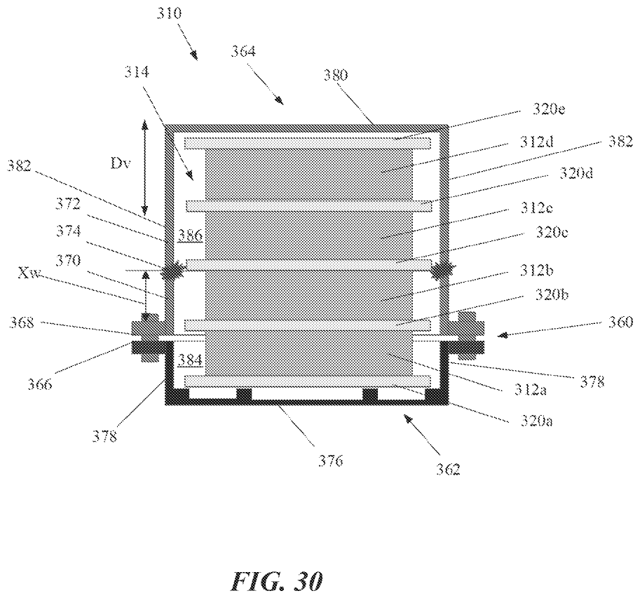

With reference to FIGS. 29A and 29B, a thermal management system 280 for cooling (or alternatively heating) a battery pack 282 according to a further embodiment is provided. The thermal management system 280 includes a thermal management device in the form of an active heat exchanger (or more specifically a cold plate) 284 that is coupled to, or located adjacent to or in close proximity to, battery cells of the battery pack 282. In some instances, the active heat exchanger 284 may be constructed or configured in accordance with the thermal management devices 20 described and shown with reference to at least FIGS. 2 through 6 and 9 through 13. In other instances, the heat exchanger 284 may also be a different type of heat exchanger 284 than the thermal management device 20 of the earlier described embodiments. As shown in FIGS. 29A and 29B, the thermal management system 280 includes, in addition to the active heat exchanger 284, a pump 286 and a valve 288. As illustrated in FIGS. 29A and 29B, the thermal management system 280 includes exactly one path-switching valve 288, or a single path-switching valve 288, and does not include any valves that switch flow paths other than the valve 288.

The following description provides non-limiting examples where the valve 288 is a multi-way valve (e.g., a four-way valve), but it is to be appreciated that the disclosure contemplates use of other types of valves. As shown in FIGS. 29A and 29B, the valve 288 carries a relatively cool or cold fluid flowing out of the pump 286 (cool or cold fluid indicated by solid lines), in the sense that fluid flowing through the thermal management system 280 encounters the valve 288 first after leaving the pump 286 along its flow path through the thermal management system 280. As shown in FIGS. 29A and 29B, the valve 288 also carries a relatively warm or hot fluid flowing into the pump 286 (warm or hot fluid indicated by broken lines), in the sense that fluid flowing through the thermal management system 280 encounters the valve 288 last before entering the pump 286 along its flow path through the thermal management system 280. Such an arrangement may be used, in particular, to cool the battery pack 282. In some alternative embodiments, to heat the battery pack 282, the valve 288 carries a relatively warm or hot fluid flowing out of the pump 286 and a relatively cool or cold fluid flowing into the pump 286.

As illustrated in FIGS. 29A and 29B, the thermal management system 280 includes a first conduit 290 that couples an outlet of the pump 286 to a first inlet/outlet or port of the multi-way valve 288, a second conduit 292 that couples a second inlet/outlet or port of the multi-way valve 288 to a first end of a heat exchange medium passageway extending through the heat exchanger 284, a third conduit 294 that couples a second end of the heat exchange medium passageway extending through the heat exchanger 284 to a third inlet/outlet or port of the multi-way valve 288, and a fourth conduit 296 that couples a fourth inlet/outlet or port of the multi-way valve 288 to an inlet of the pump 286.

When the thermal management system 280 is in operation, the multi-way valve 288 can be switched to allow a heat exchange medium to flow through the first multi-way valve 288 from the first conduit 290 to the second conduit 292, and to allow a heat exchange medium to flow through the multi-way valve 288 from the third conduit 294 to the fourth conduit 296. In such a configuration, the pump 286 can be operated to pump the heat exchange medium through the system 280 from the outlet of the pump 286, through the first conduit 290, through the multi-way valve 288 a first time, through the second conduit 292, through the heat exchange medium passageway extending through the heat exchanger 284, and thus through the heat exchanger 284 itself, from the first end thereof to the second end thereof, through the third conduit 294, through the multi-way valve 288 a second time, and then through the fourth conduit 296 to the inlet of the pump 286. This flow path can be referred to as a first flow path and is indicated by arrows 298a in FIG. 29A.

When the thermal management system 280 is in operation, the multi-way valve 288 can be switched to allow a heat exchange medium to flow through the first multi-way valve 288 from the first conduit 290 to the third conduit 294, and through the multi-way valve 288 from the second conduit 292 to the fourth conduit 296. In such a configuration, the pump 286 can be operated to pump the heat exchange medium through the system 280 from the outlet of the pump 286, through the first conduit 290, through the multi-way valve 288 a first time, through the third conduit 294, through the heat exchange medium passageway extending through the heat exchanger 284, and thus through the heat exchanger 284 itself, from the second end thereof to the first end thereof, through the second conduit 292, through the multi-way valve 288 a second time, and then through the fourth conduit 296 to the inlet of the pump 286. This flow path can be referred to as a second flow path and is indicated by arrows 298b in FIG. 29B.

Thus, as noted in the foregoing, in some cases, depending on the arrangement of the valve 288, the heat exchange medium can be pumped and flow from the first end of the heat exchange medium passageway extending through the heat exchanger 284 to the second end thereof, or from the second end of the heat exchange medium passageway extending through the heat exchanger 284 to the first end thereof. Thus, by switching the valve 288 at regular intervals, the thermal management system 280 can alternate the direction of the flow of the heat exchange medium through the heat exchanger 284. The valve 288 can be actuated and switched to alternate the flow path of the heat exchange medium through the system 280 from time to time. As examples, the valve 288 can be switched to change the flow path of the heat exchange medium from the first flow path to the second flow path once per week, once every two days, once every day, or twice a day. As further examples, the valve 288 can be switched to change the flow path of the heat exchange medium from the first flow path to the second flow path once every time a vehicle carrying the system 280 is turned off, or once every time the vehicle carrying the system 280 comes to a stop. In some cases, the frequency of the alternation can be greater to increase uniformity of temperature effects on the battery cells in the battery pack 282, and the frequency of the alternation can be decreased if greater uniformity of temperature effects on the battery cells in the battery pack 282 is not needed. In some embodiments, the switching of the valve 288 can be controlled by a driver of the vehicle carrying the system 280, while in other embodiments, the switching of the valve 288 cannot be controlled by a driver of the vehicle carrying the system 280. In some embodiments, the switching of the valve 288 can be controlled by a computer system of the vehicle carrying the system 280, such as at least controller (e.g., controller 455) and/or BMS system described herein, while in other embodiments, the switching of the valve 288 cannot be controlled by a computer system of the vehicle carrying the system 280.

In some embodiments, the system 280 includes a plurality of temperature sensors, such as a first temperature sensor coupled to one or more battery cells proximate a downstream side of a flow of the heat exchange medium, and configured to measure a temperature of such battery cells, and a second temperature sensor coupled to one or more battery cells proximate an upstream side of the flow of the heat exchange medium, and configured to measure a temperature of such battery cells. In some embodiments, a computer system or controller associated with the system 280, such as at least controller 455 described herein, can be configured to receive signals from such temperature sensors and to operate the system 280, including switching of the valve 288, based on temperatures measured by the sensors. For example, the computer system and/or controller can be configured to switch the valve 288 if a difference between the temperatures measured by the temperature sensors exceeds a threshold value, such as 5° C., 10° C., 15° C., or 20° C.

The heat exchanger 284 can be considered an active heat exchanger 284 in the sense that a heat transfer medium is actively utilized by the heat exchanger 284 for heating or cooling purposes. The heat exchanger 284 may be used to cool the battery pack 282, or the heat exchanger 284 may be used to heat the battery pack 282, in which case the heat exchanger 284 may be referred to as a hot plate. In some embodiments, the heat exchanger 284 can include a heat sink.

In some embodiments, the battery pack 282 includes a plurality of battery module layers that are stacked, such as in a vertical direction, where each battery module layer includes a respective plurality of battery cells arranged in a planar array and a respective active heat exchanger 284, and the heat exchange passageway extends through each of the heat exchangers 284 of the battery module layers (similar to the embodiments described above with respect to at least FIGS. 2 through 6 and 9 through 13). In still further embodiments, the system 280 may be associated with a single battery pack 282 in a distributed heating and cooling system, or the system 280 may be associated with a plurality of common battery packs, similar to the systems and arrangements of such systems described at least with reference to FIGS. 1 through 16.

In view of the above, the present disclosure advantageously provides for controlling the flow of a heat exchange medium to achieve increased uniformity of temperatures or effects of temperature differences within a battery pack. Such features can alleviate issues discussed herein related to temperatures of battery cells on a downstream side of a flow of the heat exchange medium being higher than temperatures of battery cells on an upstream side of the flow of the heat exchange medium, for example, while the battery cells are being cooled by the heat exchange medium. Such features can also alleviate issues discussed herein related to temperatures of battery cells on a downstream side of a flow of the heat exchange medium being lower than temperatures of battery cells on an upstream side of the flow of the heat exchange medium, for example, while the battery cells are being heated by the heat exchange medium. Thus, the features described herein can reduce, minimize, or eliminate effects on battery pack performance resulting from non-uniform temperatures across a battery pack over extended periods of time. For example, the features described herein provide improvements in that battery cell capacity fade and impedance growth are well balanced across the battery pack over time.

### Battery Pack Enclosure

With reference to FIG. 30, a battery pack 310 according to a further embodiment is provided. Similar to the battery packs 10 described above, the battery pack 310 includes a plurality of battery module layers 312a-312d (collectively referred to as a plurality of battery module layers 312), each layer 312 including a plurality of individual battery cells, and the layers 312 being stacked in an alternating fashion with a plurality of thermal management devices 320, which may be, for example, an active heat exchanger provided in the form of a battery cold plate. As a result, each battery module layer 312 is stacked between two thermal management devices 320, such that each of the thermal management devices 320 is stacked adjacent to at least one of the battery module layers 312. The battery module layers 312 and the thermal management devices 320 are stacked in a vertical direction D_{V} (as illustrated in FIG. 30) to form a multi-layer battery stack 314. Each of the battery module layers 312a-312d may be constructed or configured in accordance with the battery module layers 12, 112, 112′ described at least with reference to FIGS. 2 through 6 and 9 through 13.

As illustrated in FIG. 30, the battery pack 310, and its multi-layer battery stack 314, includes four battery module layers 312 and five thermal management devices 320. Specifically, the battery pack 310, and its multi-layer battery stack 314, includes a stack of layers including a first thermal management device 320a at a first end of the stack 314, which is a bottom end of the stack 314 as illustrated in FIG. 30, a first battery module layer 312a adjacent to a surface of the first thermal management device 320a, a second thermal management device 320b adjacent to a surface of the first battery module layer 312a opposite to the first thermal management device 320a, a second battery module layer 312b adjacent to a surface of the second thermal management device 320b opposite to the first battery module layer 312a, a third thermal management device 320c adjacent to a surface of the second battery module layer 312b opposite to the second thermal management device 320b, a third battery module layer 312c adjacent to a surface of the third thermal management device 320c opposite to the second battery module layer 312b, a fourth thermal management device 320d adjacent to a surface of the third battery module layer 312c opposite to the third thermal management device 320c, a fourth battery module layer 312d adjacent to a surface of the fourth thermal management device 320d opposite to the third battery module layer 312c, and a fifth thermal management device 320e adjacent to a surface of the fourth battery module layer 312d opposite to the fourth thermal management device 320d, and at a second end of the stack 314 opposite to the first end of the stack, which is a top end of the stack 314 as illustrated in FIG. 30.

In other embodiments, the battery pack 310, and its multi-layer battery stack 314, may include a different number of battery module layers 312 and a different number of thermal management devices 320 than illustrated in FIG. 30. For example, the battery pack 310, and its multi-layer battery stack 314, may include one battery module layer 312 and two thermal management devices 320, or two battery module layers 312 and three thermal management devices 320, or three battery module layers 312 and four thermal management devices 320, or five battery module layers 312 and six thermal management devices 320, or six battery module layers 312 and seven thermal management devices 320, or eight battery module layers 312 and nine thermal management devices 320, etc.

As further illustrated in FIG. 30, the battery pack 310 also includes a housing or an enclosure 360 (also referred to as a battery enclosure 360 or a battery pack enclosure 360), including a first portion 362 thereof, which is a bottom portion thereof as illustrated in FIG. 30, and which may be referred to herein as a “tray” 362 or an “enclosure tray” 362, and a second portion 364 thereof, which is a top portion thereof as illustrated in FIG. 30, and which may be referred to herein as a “lid,” “cover,” or “enclosure cover” 364. The enclosure tray 362 includes a tray floor 376 and tray sidewalls 378 extending upwardly from the tray floor 376 to define an internal tray cavity 384. The enclosure cover 364 includes a cover ceiling 380 at a top thereof and cover sidewalls 382 extending downwardly from the cover ceiling 380 to define an internal cover cavity 386. In some embodiments, a volume of the internal cover cavity 386 is larger than a volume of the internal tray cavity 384 such that the internal cover cavity 386 can accommodate a majority of the battery pack 310. This is particularly the case when the multi-layer battery stack 314 includes a significant number (e.g., three, four, or five) of battery module layers 312.

In some embodiments, the tray 362 may include some or all of the ports or other connectors or interfaces of the enclosure 360 through which electrical, thermal, and any other connections can be made between the battery pack 310 and other components outside of the enclosure 360, and the cover 364 may include none of the ports or other connectors or interfaces of the enclosure 360 through which electrical, thermal, and any other connections can be made between the battery pack 310 and other components outside of the enclosure 360. When the battery pack 310 is assembled, the components of the multi-layer battery stack 314 may be stacked on top of one another on top of the tray 362, and the multi-layer battery stack 314 may be fixedly mounted to the tray 362. Once these components have been assembled and plumbed to the enclosure interface with appropriate electrical cables and fluid conduits, then the cover 364 can be positioned over the multi-layer battery stack 314 to surround, house, and enclose the multi-layer battery stack 314, and the cover 364 can then be securely coupled to the tray 362. Such secure coupling can be achieved mechanically, such as with a plurality of bolts or other mechanical fasteners, and/or chemically, such as with an adhesive, glue, epoxy, etc. In some instances, the cover 364 is removably coupled to the tray 362 to facilitate servicing of the battery pack 310.

Regardless of the manner in which the cover 364 is securely coupled to the tray 362, it may be advantageous that each of the tray 362 and the cover 364 has a respective flat surface (e.g., a flat tray sealing surface 366 and a flat cover sealing surface 368) so that these flat surfaces 366, 368 can be flush against one another when the enclosure 360 is assembled, to improve a seal and/or other properties of the enclosure 360. In some embodiments, one or both of the sealing surfaces 366, 368 may include a groove extending a full distance around a peripheral portion of the enclosure 360. In cases where a respective groove is provided in each of the sealing surfaces 366, 368, the grooves may follow identical paths such that a first portion of a gasket can be positioned within the groove formed in the sealing surface 366 and, when the cover 364 is positioned over the tray 362, a second portion of the gasket can be positioned within the groove formed in the sealing surface 368, such that the gasket forms a seal between the tray 362 and the cover 364 and such that the grooves limit or restrict the deformation of the seal.

It can be advantageous to make the tray 362 and/or the cover 364 from relatively lightweight materials, such as to reduce material costs and reduce overall weight of the enclosure 360. Nevertheless, it can also be advantageous to make the tray 362 and/or the cover 364 from relatively heavy materials, such as to improve strength, rigidity, and durability of the enclosure 360. Rigidity can be of particular importance in at least some portions of the enclosure 360 at least because it can facilitate the formation of the grooves (when provided) in the sealing surfaces 366 and 368, and because it can facilitate formation of an adequate seal between the tray 362 and the cover 364. In particular, as the tray 362 and cover 364 become more flexible, it becomes more difficult to maintain the sealing surface 366 flush against the sealing surface 368, or an intermediate seal or gasket material.

Thus, in some embodiments, the cover 364 can be formed from at least two different sections or portions having a different degree of rigidity or other properties, such as for example, a first, more rigid lower portion 370 of the cover 362, as illustrated in FIG. 30, which is configured to directly physically engage with the tray 362, and a second, less rigid upper portion 372 of the cover 364, as illustrated in FIG. 30, which is configured to extend over and around at least a portion of the multi-layer battery stack 314, and which does not directly physically engage with the tray 362. In some embodiments, the lower portion 370 can be more rigid than the upper portion 372 as a result of different material properties and/or different thicknesses, or gauges, of the two portions (that is, a material of the lower portion 370 can be thicker than a material of the upper portion 372). In some embodiments, both of the first and second portions 370, 372 can be metallic, and they can be coupled to one another by welding, such as at a welding seam 374 that extends a full distance around a peripheral portion of the enclosure 360. This allows the lower portion 370 to be made from a relatively rigid cover component that is particularly stout and unsusceptible to elastic and/or plastic deformation under expected loading conditions to improve sealing between the tray 362 and the cover 364, without unduly increasing the overall rigidity and/or weight of the enclosure 360.

This also allows the lower portion 370 of the cover 364 to have a common configuration regardless of the height of the multi-layer battery stack 314 which varies with a number of the battery module layers 312 that are provided within a particular enclosure 360. For example, the lower portion 370 can be coupled to a first upper portion 372 having a first height (in the direction D_{V}) or the lower portion 370 can be coupled to a second upper portion 372 having a second height (in the direction D_{V}), where the first height is different than the second height. This can simplify manufacturing by allowing a common lower portion 370 to be used to cover multi-layer battery stacks 314 of different sizes (e.g., different heights in the direction D_{V}). In some embodiments, the height of the upper portion 372 of the cover 364 in the direction D_{V}, and thus the overall height of the cover 364, can be dependent upon the height of the multi-layer battery stack 314 it is intended to cover, and thus dependent at least in part on the number of battery module layers 312 and thermal management devices 320 in the multi-layer battery stack 314. In some embodiments, each battery module layer 312 has a common footprint (i.e., a common width and common length in a horizontal plane) with only a height the multi-layer battery stack 314 being variable to advantageously enable use of the common lower portion 370 in battery packs 310 of different sizes, as described above.

In some embodiments, welding the upper portion 372 of the cover 364 to the lower portion 370 of the cover 364 can cause the material of the lower and/or upper portions 370, 372 to warp or otherwise be deformed from their original shapes, e.g., such that they may have less planar profiles after the welding than before, particularly if the materials being welded are relatively thin or lightweight. Thus, to reduce the degree to which the at least the sealing surface 368 may be warped or otherwise deformed during the welding, the weld seam 374 can be located at least a threshold or minimum distance X_{W} from the portion of the cover 360 that includes the sealing surface 368. In some embodiments, the threshold distance X_{W} may be at least 50 mm. In some embodiments, the weld seam 374 can be located closer to the tray 362 than to the cover ceiling 380 of the cover 364.

In some embodiments, the entirety of the cover 364 can be made of a relatively lighter weight, more flexible material, rather than the cover 364 being formed from at least two different portions having disparate degrees of rigidity as described elsewhere herein, and may, as a result, lack a perfectly planar sealing interface. In such embodiments, the welding described herein need not be performed. In such embodiments, the tray sealing surface 366 can be coupled to the cover sealing surface 368, such as chemically, by a sealant or adhesive, such as a gel and/or a glue, which can accommodate the relatively flexible nature of the entirety of the cover 364 and the larger tolerances associated with the sealing interface therewith. Such a sealant can be referred to as a liquid sealant. The liquid sealant may beneficially set to fill an irregularly shaped or contoured gap a sealing interface between the cover 364 and the tray 362.

### Structural Battery Pack Enclosure

The phrase “thermal runaway” should be construed broadly as a process that is accelerated by increasing temperature that in turn releases energy that further increases temperature, and in the context of electric vehicle batteries, may refer to at least one battery cell venting hot gas or hot gas entrained with debris that leads to breakdown and similar vent of other cells in the battery pack. In addition, vehicle crashes are known to be potentially deadly events that can also cause significant structural damage to the vehicles involved. When an electric vehicle is involved in a crash, the sudden impact to the battery of the electric vehicle can likewise lead to thermal runaway that increases the likelihood of a battery fire or other serious outcomes as a result of the crash. As a result, certain aspects of the present disclosure include battery pack enclosures that provide a structural support as well as a crumple zone. Such aspects of the present disclosure can include features that provide side impact protection and a greater capacity to absorb impact energy within a battery pack enclosure. The redundant sealing protects the battery pack from water intrusion.

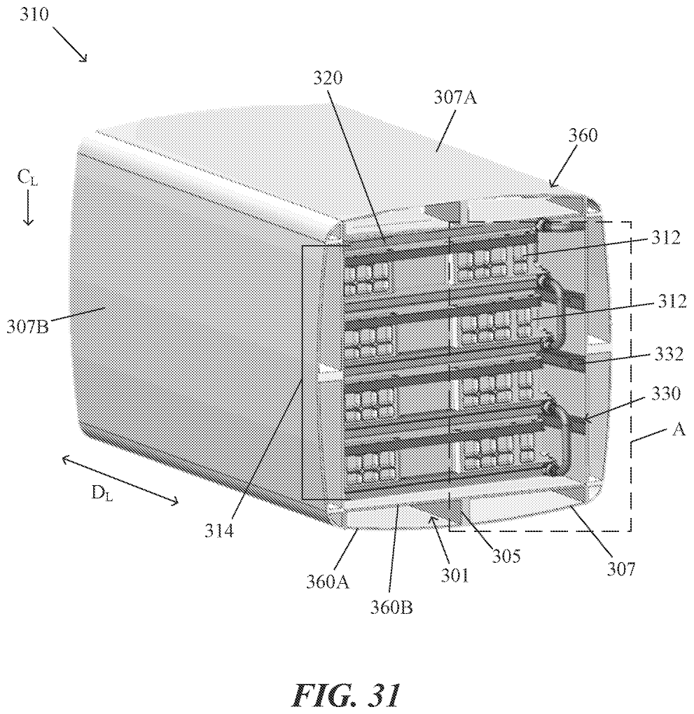

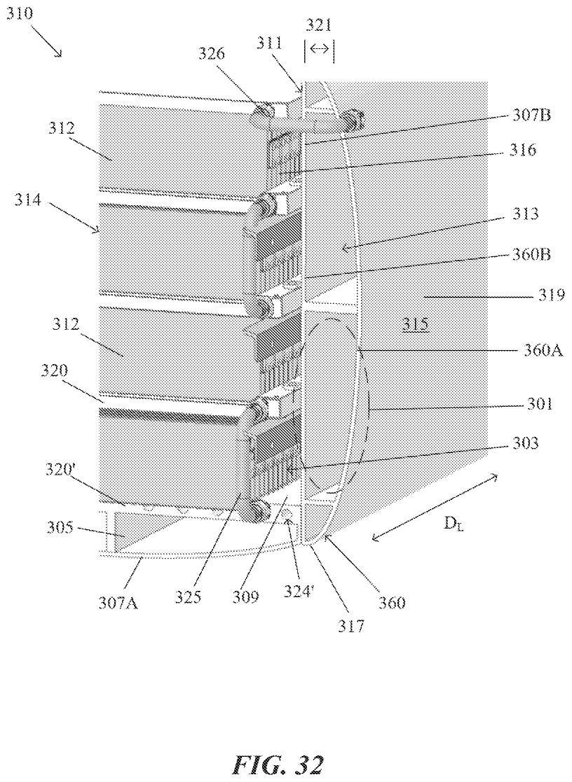

With reference to FIG. 31, an embodiment of a battery pack 310 includes a plurality of battery module layers 312 stacked together in an alternating fashion with a plurality of thermal management devices 320 to form a multi-layer battery stack 314. Each battery module layer 312 includes a plurality of battery cells 316 arranged in an array as best shown in FIG. 32. The thermal management devices 320 will be described in greater detail with reference to FIG. 32. Each of the battery module layers 312 may be constructed or configured in accordance with the battery module layers 12, 112, 112′ described and shown at least with reference to FIGS. 2 through 6 and 9 through 13. A battery pack enclosure 360 (also referred to as a battery enclosure 360 or enclosure 360) surrounds the multi-layer battery stack 314. As will be described in greater detail below, the battery enclosure 360 includes one or more crumple zones 301 (or crush zones) that are configured to deform in response to an impact event, such as from a vehicle crash, to absorb energy from the impact and assist in protecting the multi-layer battery stack 314 from damage, and, as a result, reduce the likelihood of thermal runaway.

The multi-layer battery stack 314 may be arranged with major sides 303 of the stack 314 extending in a longitudinal direction D_{L} such that the major sides 303 may also be referred to as major longitudinal sides 303 or as longitudinal sides 303 of the multi-layer battery stack 314. The major sides 303 are best shown in FIG. 32, as the major sides 303 of the multi-layer battery stack 314 are covered by the enclosure 360 in FIG. 31. Continuing with reference to FIG. 31, the enclosure 360 includes, for example, a respective crumple zone 301 (or crush zone) adjacent to at least two major sides 303 of the multi-layer battery stack 314. In the embodiment shown in FIG. 31, the enclosure 360 includes respective crumple zones 301 adjacent each of the four major sides (i.e., left, right, top, and bottom sides in the orientation of FIG. 31) of the multi-layer battery stack 314. In other words, the battery pack enclosure 360 includes a respective crumple zone adjacent each of longitudinal left and right sides 303, and each of top and bottom longitudinal sides 303 of the multi-layer battery stack 314.

The battery pack 310 may further include a battery pack rack 330 with a plurality of rack members 332. Each battery module layer 312 may be secured to a respective rack member 332 with the rack members 332 coupled directly to the battery pack enclosure 360, as shown in FIG. 31. The rack members 332 may also be formed integrally with the battery enclosure 360 with each battery module layer 312 secured to a respective pair of rack members 332 on opposing sides of each layer 312, such as on left and right longitudinal sides 303 of each layer 312 in a non-limiting example. In some embodiments, the battery pack rack 330 and the plurality of rack members 332 are a separate structure coupled between the battery enclosure 360 and the multi-layer battery stack 314. In some instances, the rack members 332 may be arranged and spaced to apply a compressive load CL on the battery module layers 312 and the thermal management devices 320 to assist in maintaining the battery module layers 312 in thermal contact with each other and with the thermal management devices 320. The battery pack rack 330 and the plurality of rack members 332 may also be constructed or configured, in whole or in part, in accordance with the battery pack frame 30, 130 and plurality of frame members 32, 132 described and shown at least with reference to FIGS. 2 through 6 and 9 through 11.

The battery enclosure 360 may be provided in a number of different form factors. For example, with reference to FIG. 31, the battery enclosure 360 may be provided in the form of a shell with two spaced apart layers 360A, 360B that are joined together at least by a plurality of structural supports 305. In an embodiment, there are more than two layers 360A, 360B, such as at least three, four, five, or more layers. The spaced apart layers 360A, 360B of the shell enclosure 360 and the plurality of structural supports 305 define one or more air gaps 313 between such layers 360A, 360B and supports 305 that generally correspond to, or assist in forming, the one or more crumple zones 301. The shell structure of the enclosure 360 may be formed by a plurality of separate and distinct side components 307 (also referred to as distinct shell portions 307) that are joined together mechanically (i.e., with bolts or other mechanical fasteners) or chemically (i.e., with adhesive, glue, epoxy, etc.) to form the enclosure 360. Each of the side components 307 may include a respective shell arrangement with respective layers 360A, 360B and supports 305 formed as a structural extrusion having a constant cross-sectional profile over a length of each component 307 in the longitudinal direction D_{L}. The enclosure 360 may also include two or more, or all, of the side components 307 integrally formed as a single structural extrusion.

For example, the bottom side component 307 may be a separate and distinct structure in a manner similar to the tray 362 described elsewhere herein, while the left, right, and top side components 307 are integrally formed as a single device akin to the cover 364 that can be coupled to the bottom side component 307 to improve assembly efficiency. In further embodiments, each of the components 307 may be separate, but with standard dimensions that generally correspond to different sizes of common battery packs, such as at least common battery pack 10 described with reference to FIGS. 1 through 16, to enable efficient assembly of battery enclosures 360 of different sizes. To improve manufacturing efficiency, and as described in more detail with reference to FIG. 32, the top and bottom side components 307 may be first side components 307A with an identical size, shape, and/or arrangement, while the left and right side components 307 may be second side components 307B that have an identical size, shape, and/or arrangement that is different from that of the first components 307A to reduce the number of unique parts of the enclosure 360.

FIG. 32 is a detail view of area A in FIG. 31. The battery pack 310 includes the plurality of cells 316 arranged in an array extending in the longitudinal direction D_{L} to form each battery module layer 312 of the multi-layer battery stack 314 (FIG. 31). The array of cells 316 in each layer 312 also collectively define the major sides 303 of the multi-layer battery stack 314 that likewise extend in the longitudinal direction D_{L}. The thermal management devices 320 may each be active heat exchangers (or more particularly battery cold plates), that are in direct thermal engagement with the array of battery cells 16 to provide cooling or heating of the battery cells 16 in operation. More specifically, the thermal management devices 320 may be provided in the form of a generally planar manifold that includes a heat transfer medium passageway to facilitate the circulation of a heat transfer medium through the manifold during operation to assist in drawing heat away from the battery cells 316 to cool the battery cells 316 or, alternatively, supplying heat to the battery cells 316 to heat the battery cells 316.

As shown in FIG. 32, one or more fittings 326 may be provided on each thermal management device 320 to enable conduits 325 for the heat transfer medium to be attached to the thermal management device 320 to enable fluid communication between one or more heat transfer medium passageways (not shown) of each thermal management device 320 with each other and other components of a thermal management system, such as one or more chillers and one or more heaters to enable the battery cooling and heating functionality described herein. Each of the thermal management devices 320 may be constructed or configured in accordance with the thermal management devices 20, 120, 120′ described and shown at least with reference to FIGS. 2 through 6 and 9 through 13. Further, the multi-layer battery stack 314 is disposed in direct contact with a surface 309 of the battery pack enclosure 360 underlying the multi-layer battery stack 314, which may be a heat transfer surface or thermal management device 320′ that is integrated with the pack enclosure 360 and includes internal heat transfer medium passageway 324′.

At least one major side surface 311 of the battery pack enclosure 360 is spaced from the multi-layer battery stack 314. The at least one major side surface 311 of the battery pack enclosure 360 may be an interior surface of the battery enclosure 360, or more specifically, an interior surface of a respective at least one of the side components 307 that extends in the longitudinal direction D_{L} and faces a corresponding at least one major side 303 of the multi-layer battery stack 314. In an embodiment, the space between the at least one major side surface 311 of the battery enclosure 360 and the multi-layer battery pack is an air gap and/or a debris collection space 403 of the type described elsewhere herein. In an embodiment, the at least one major side surface 311 includes major side surfaces 311 of the enclosure 360 on at least each of the left, right, and top sides of the enclosure 360 such that there is a space around at least three (i.e., left, right, and top) major sides of the multi-layer battery stack 314.

As mentioned above, each of the side components 307, as well as the enclosure 360 generally, may include one or more crumple zones 301 that are configured to deform in response to an impact event to assist in absorbing energy of the impact protecting the multi-layer battery stack 314 from damage. One such crumple zone 301 is indicated with a dashed oval in FIG. 32. The crumple zones 301 are generally defined by an air gap 313 between the layers 360A, 360B (FIG. 31) and the supports 305 of each side component 307 and/or the enclosure 360. In an embodiment, the plurality of structural supports 305 (e.g., structural webs, partitions, or gussets) are arranged generally normal to the layers 360A, 360B of the shell structure of the enclosure 360 and/or the side components 307. The first layer 360A of the enclosure 360 and/or each side component 307 may be an outer layer that defines an outer surface 315 of the enclosure 360 and/or each respective side component 307, while the second layer 360B is an inner layer that defines the at least one major side surface 311 of the enclosure 360 that faces the multi-layer battery stack 314. The first layer 360A may be curved or angled to provide the outer surface 315 with a similar curved or angled shape. The second layer 360B may be generally flat and planar to assist in accommodating the multi-layer battery stack 314, which may be generally shaped as a rectangular prism.

In an embodiment, each of the plurality of side components 307 include a respective plurality of structural supports 305 that are spaced equidistant from each other, or with some other select spacing, across the respective side component 307. Further, the curved shape of the first layer 360A and the flat and planar shape of the second layer 360B of each side component 307 interface at peripheral edges 317 of each side component 307. As a result of the selected arrangement (i.e., equidistant spacing in some embodiments) of the structural supports 305, the structural supports 305 proximate the peripheral edges 317 of each side component 307 may be positioned closer to each other than to the structural supports 305 proximate a center region 319 of each side component 307 to increase a structural strength of the shell proximate the peripheral edges 317 of each side component 307 and assist with defining the one or more crumple zones 301 proximate the center region 319 of each side component 307. In an embodiment, the crumple zones 301 are the air gap 313 between a support 305 proximate the center region 319 of each side component and the next successive structural support 305 toward the peripheral edges 317.

In addition, the curved or tapered outer surface 315 of the enclosure 360 and/or the side components 307 provide each of the side components 307 with a width or thickness 321 that changes over a height of the respective side components 307. As a result, each of the side components 307 may have a tapered structure where the thickness 321 is smallest proximate one of the peripheral edges 317 and largest proximate the center region 319 of each side component 307 before returning to the smallest thickness 321 proximate the opposite peripheral edge 317. The changing thickness 321 across each side component 307 provides a larger volume in the air gap 313 proximate the center region 319 and/or a vertex of each side component 307 and the corresponding major side 303 of the multi-layer battery stack 314. In addition, the supports 305 of each side component 307 will have a height that varies with the thickness 321 of the side components 307, meaning that supports 305 proximate the center region 319 will generally be taller than the supports 305 proximate the peripheral edges 317, but may have a thickness that is similar to the supports at the peripheral edges 317 in some embodiments. The central supports 305 (i.e., supports 305 positioned proximate the center region 319 of the side components 307) may provide structural support that serves to deflect impacts proximate the center region 319 of the side components 307 toward the crumple zones 301.

In an embodiment, the crumple zone 301 may correspond to a majority of the side component 307, including the structural support 305 positioned proximate the center region 319 of each side component 307. The increased length or height of the central supports 305 reduces rigidity and increases flexibility in the central supports 305 such that during an impact event, a central portion of each side component 307 that generally corresponds to the major sides 303 of the multi-layer battery stack 314 will crumple before portions of the each side component 307 that are proximate the peripheral edges 317. In addition, forces from the impact event are directed toward the more rigid portions of the side components 307 proximate the peripheral edges 317. The peripheral edges 317 may in some instances be mounted on a chassis of a vehicle, such as the chassis 2 shown and described at least with reference to FIG. 1, such that the forces from the impact event are directed from the crumple zone 301 or crumple zones 301 to the peripheral edges 317 and further to the vehicle chassis.

In some embodiments, the peripheral edges 317 of the side components 307 may be different from each other to assist in forming the enclosure 360. For example, the peripheral edge 317 of the first side components 307A (i.e., top and bottom side components 307) may be provided in the form of a structural support 305, meaning a wall that is normal to at least the second layer 360B. The peripheral edge 317 of the second side components 307B (i.e., the left and right side components 307) may be an interface or meeting point between the curved and flat surfaces of the first and second layers 360A, 360B, respectively, that does not necessarily terminate in a support 305 or wall, but rather, extends to cover the support 305 or wall at the peripheral edge 317 of the corresponding first component 307A and provide space for a connection between the first and second components 307A, 307B to form the enclosure 360. Thus, aspects of at least the supports 305 and/or the overall shell structure of each side component 307 cooperate to define the crumple zones 301 and protect the multi-layer battery stack 314 from damage from an impact event.

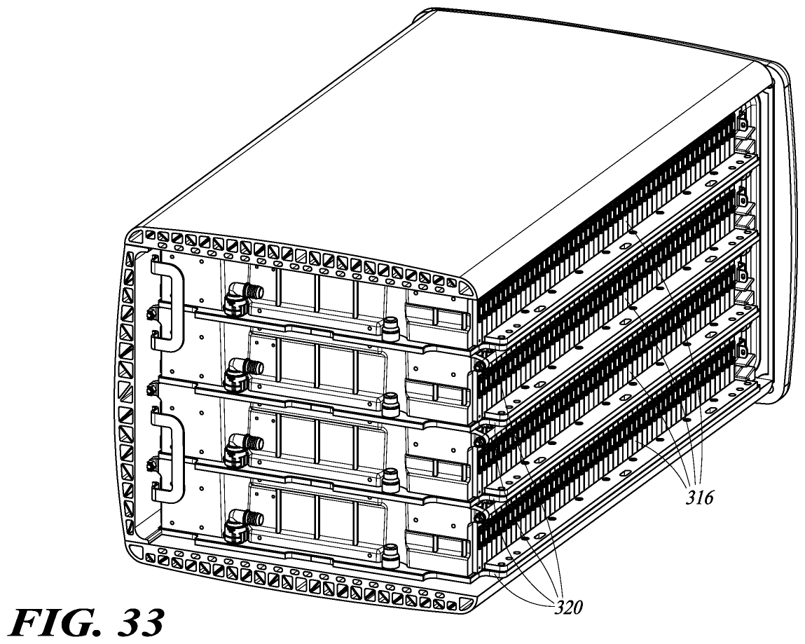

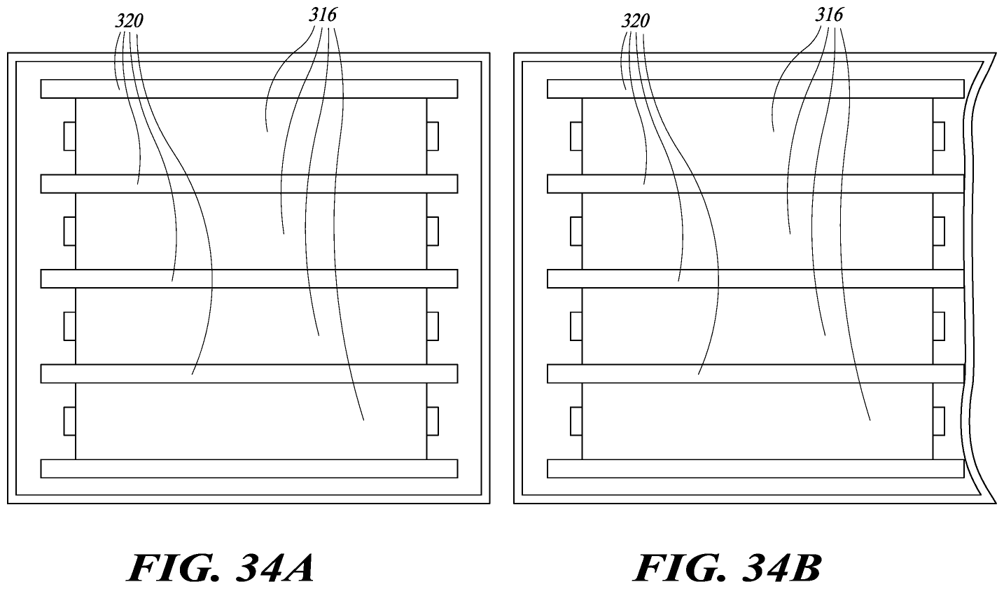

As described elsewhere herein, at least a portion of each of the thermal management devices 320 may extend beyond an end face of the battery cells 316 to enable a mechanical connection between the thermal management devices 320 and the frame members 332 of the frame 330 to support the thermal management devices 320 and apply a compressive load on the multi-layer battery stack 314. Such features are further illustrated in FIG. 33. As illustrated in FIGS. 34A and 34B, such features provide additional benefits. In particular, FIG. 34A illustrates a schematic view of the system in an ordinary working configuration, and FIG. 34B illustrates a schematic view of the system when a collision or side impact has occurred and deformed the battery enclosure surrounding the multi-layer battery stack. As illustrated in FIG. 34B in particular, in the event of a collision or side impact, the thermal management devices 320 extending laterally beyond end face(s) of the battery cells 316 results in the thermal management devices 320 being impacted before the battery cells 316, thus providing an additional buffer or layer of protection for the battery cells 316 in the event of a collision. In other words, the thermal management devices 320 may provide intermittent stops or obstructions along a height of the enclosure to prevent a deformation of the enclosure from directly impacting the battery cells supported therein. Thus, the thermal management devices 320 can provide additional structure to protect the battery cells 316 in the event of a side impact or other impact event that may deform the enclosure.

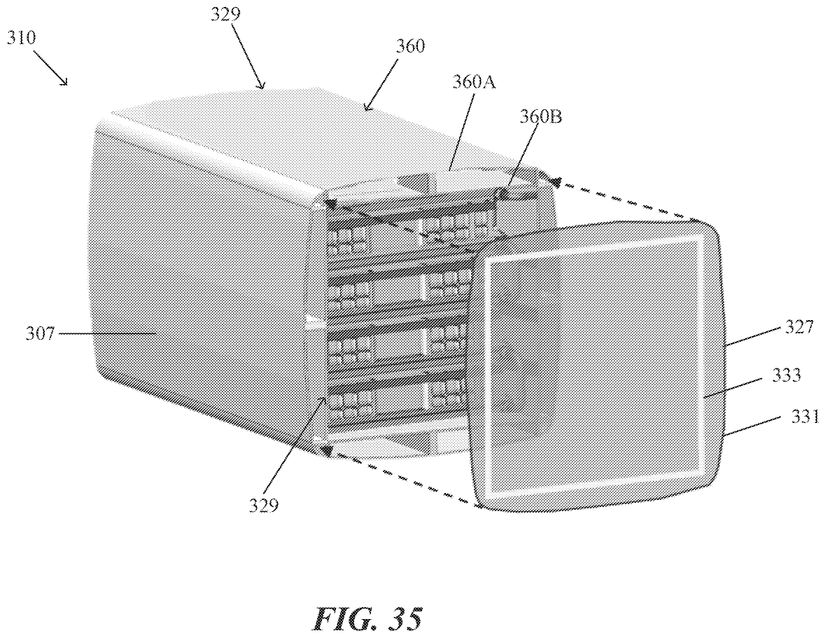

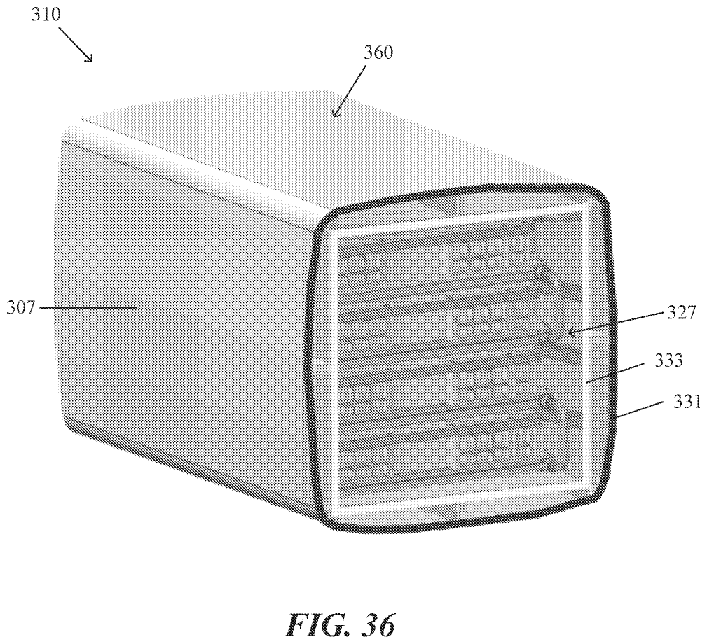

The battery pack 310 of FIG. 31 and FIG. 32 is illustrated without end parts or end covers to facilitate understanding of the disclosure and in particular, of internal aspects of the battery pack 310, and the advantages of certain aspects of the battery pack 310. FIG. 35 is an exploded view of end parts 327 that are coupleable to the side components 307 to form the battery enclosure 360. FIG. 36 shows the assembled battery enclosure 360.

With reference to FIG. 35 and FIG. 36, the battery enclosure 360 includes the plurality of side components 307 coupled together and/or integrally formed to generally surround the left, right, top, and bottom sides of the multi-layer battery stack 314. The battery enclosure 360 further includes end parts 327 that are coupleable to opposing end sides 329 (i.e., front and rear sides in some embodiments) of the side components 307 to complete the battery enclosure 360. Only a single end part 327 is shown in FIG. 35, although an identical end part 327 may be attached to the opposing end side 329 of the side components 327 that is not visible in the orientation of FIG. 35 and FIG. 36 according to the techniques described herein. Each of the side components 307 and the end parts 327 may also be referred to as enclosure parts accordingly. The end parts 327 may be provided in a number of form factors, such as at least in a form similar to the side components 307 (but with a different shape in some embodiments) including at least two spaced apart layers 360A, 360B and supports 305 therebetween, or the end parts 327 may be provided as a generally flat and planar plate that may be a single layer of metal or other suitable material. In some embodiments, the end parts 327 may be removably coupleable to the shell or tubular structure formed by the side components 307 to enclose the multi-layer battery stack 314. Such coupling may be accomplished mechanically (i.e., with bolts or other fasteners or connectors) as well as chemically (i.e., with adhesive, glue, epoxy, etc.).

The end parts 327 may be structured to seal against a respective one of the layers 360A, 360B of each side component 307 at opposing longitudinal ends 329 of the shell or tubular structure formed by the side components 307 to seal the multi-layer battery stack 314 within the enclosure 360. More specifically, the end faces of the layers 360A, 360B of the side components 307 may define a respective sealing interface at opposing ends 329 of the structure formed by the side components 307. The end parts 327 are attached in sealing engagement to the side components 307 at such sealing interfaces at the opposing ends 329 to prevent ingress of water, oil, debris, and other contaminants into the battery enclosure 360. In an embodiment, such sealing arrangement at both opposite ends 329 includes two redundant layers of sealing generally indicated in FIGS. 35 and 36 by a dark line 331 representing an outer seal 331 and a light line 333 representing an inner seal 333.

The outer seal 331 is positioned along, or proximate to, an outer peripheral edge or boundary of the end parts 327 and generally corresponds to a seal between the end plates 327 and the first layer 360A of the side components 307. The inner seal 333 is positioned inside the outer seal 331 (i.e., closer to a center of the end parts 327 than the outer seal 331) and generally corresponds to a seal between the end plates 327 and the second layer 360B of the side components 307. Such redundant seals 331, 333 may also be referred to as dual seals, wherein the end parts 327 interface with dual sealing surfaces (i.e., surfaces of layers 360A, 360B at the opposing ends 329) to provide the redundant sealing. The layers 360A, 360B of each side component 307 as well as potentially of the end parts 327 in some embodiments, may also provide a redundant sealing structure because if the first or outer layer 360A is compromised (i.e., punctured, cracked, damaged, etc.), then the second or inner layer 360B may still prevent ingress of contaminants into the battery enclosure 360. In addition, each of the side components 307 as well as each of the end parts 327 may be associated with fire retardant material (i.e., a fire retardant coating or all or at least a portion of these components or a separate layer of fire retardant material, etc.). Further, one or more fillings or porous materials may be provided in the air gap 313 in the side components 307 to soak up any materials that breaches a seal and/or the layers 360A, 360B and provide yet further redundancy against contaminants entering the enclosure 360.

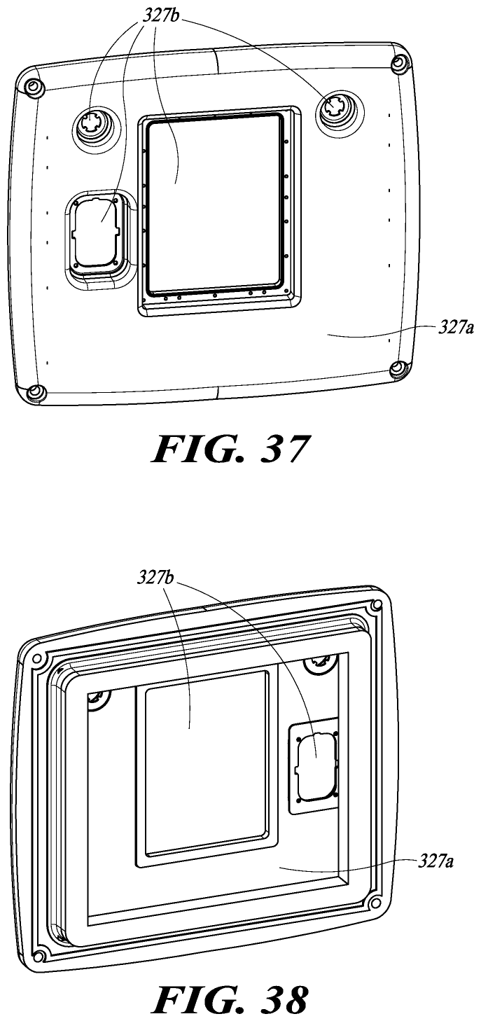

FIGS. 37 and 38 illustrate an additional embodiment of an end part 327a that can be used in place of the end part 327, and which may be referred to as an “end cap.” The end part 327a may be fabricated by casting, such as casting of a metallic material, and may include cast-in (i.e., not machined) features, including holes or apertures 327b. In use, conduits, wires, or other lines or devices (e.g., vents) can extend through such apertures 327b, such as to carry electricity (e.g., high-voltage and/or low-voltage electricity), communications, coolant, vent gases, and/or other materials, from one side of the end part 327a to an opposite side of the end part 327a (i.e., from inside an enclosure to outside the enclosure or from outside the enclosure to inside the enclosure). For this purpose, the end part 327a may be provided with a variety of fittings, connectors and/or interfaces (not illustrated), such as, for example, one or more battery vents, electrical connectors, hydraulic fittings, to provide a generally sealed battery pack which can be connected and plumbed to other system components to provide various aspects of the battery pack functionality described herein.

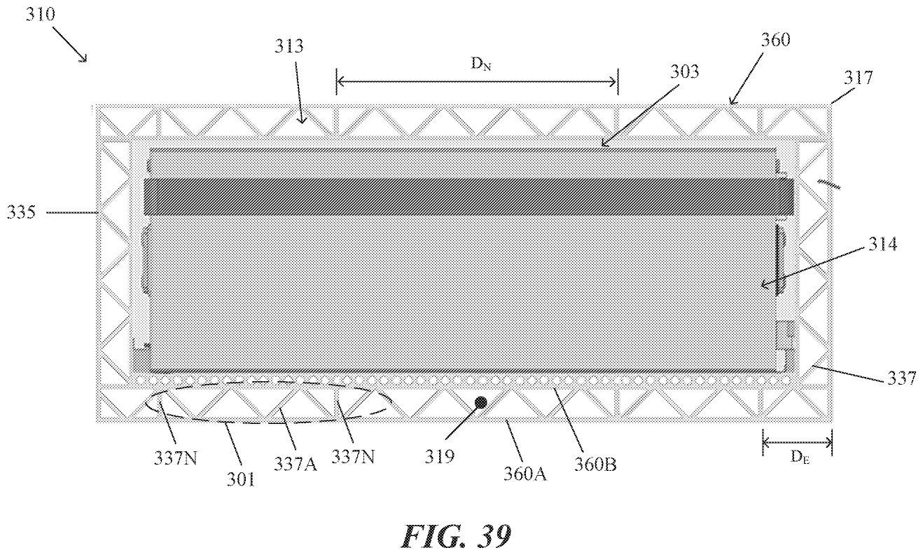

FIG. 39 is a schematic cross-sectional view of a further embodiment of a battery pack 310 and battery pack enclosure 360. The battery pack enclosure 360 may include a plurality of enclosure parts 335 that are coupled together to form the enclosure 360 as a tubular structure that circumferentially surrounds the multi-layer battery stack 314. In other words, the enclosure parts 335 may have a hollow construction bounded by at least two layers 360A, 360B similar to side components 307 to provide the enclosure 360 with an overall tubular structure. Each enclosure part 335 may include a respective plurality of internal structural partitions 337 that, along with layers 360A, 360B, define a plurality of internal cavities 313 (also referred to as air gaps 313) in the enclosure parts 335.

The internal structural partitions 337 may be similar to the structural supports 305 described above, except that at least some of the partitions 337 are arranged in a lattice or wireframe structure and/or are otherwise positioned in the enclosure parts 335 with an arrangement that is different than the partitions 337 being normal to the layers 360A, 360B of the enclosure parts 335 as in FIGS. 31 through 34. More specifically, at least some, most, or all of the partitions 337 may be positioned at an angle (i.e., a selected angle relative to horizontal between and including 15 degrees and 75 degrees) to the enclosure parts 335, as shown in FIG. 35. Certain ones of the partitions 337 may be positioned normal to the layers 360A, 360B (also referred to as normal partitions 337N) at selected intervals along each enclosure part 335 with one or more angled partitions 337A therebetween to define respective crumple zones 301 between the normal partitions 337N. As shown in FIG. 35, a distance DN between normal partitions 337N proximate a center region 319 of each enclosure part 335 may be greater than, and in some cases, at least two times, three times, or four times or more, greater than a distance DE between normal partitions 337N proximate peripheral edges 317 of the enclosure parts 335.

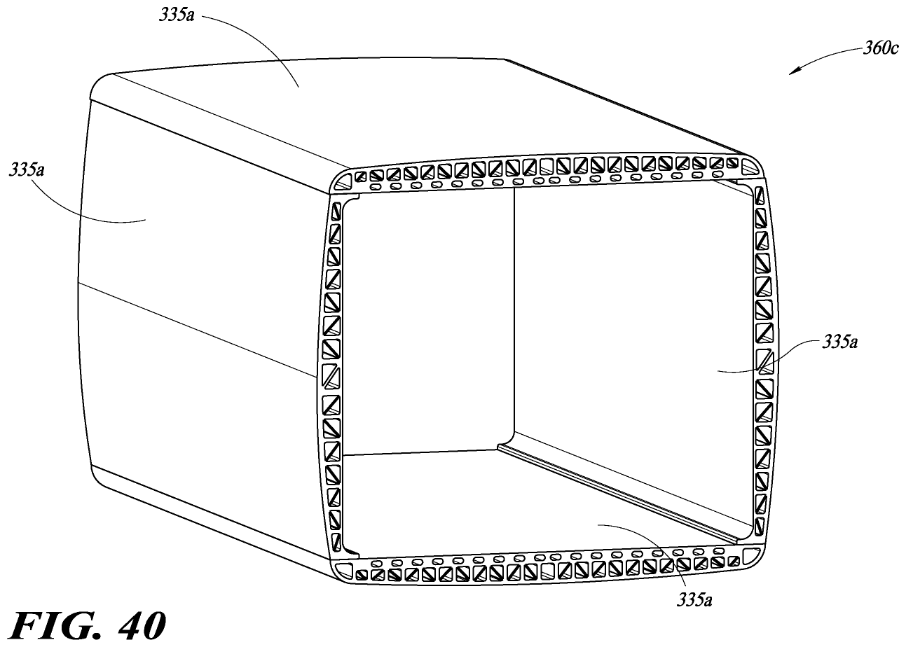

FIG. 40 illustrates an additional embodiment of a battery pack enclosure 360c having features that can be combined with other battery pack enclosures described herein. The battery pack enclosure 360c may include a plurality of enclosure parts 335a that are coupled together to form the enclosure 360c as a tubular structure that circumferentially surrounds a multi-layer battery stack. The enclosures parts 335a may be in some instances extruded parts having a constant cross-sectional profile over a length thereof. The enclosures parts 335a may have a lattice-like structure with a plurality of internal cavities, which collectively provide structural rigidity and protection of the battery cells supported therein. In some instances, one or more heat exchange medium passages may be integrally formed in the battery enclosure parts 335a to assist in cooling or heating functionality described elsewhere herein. In such instances, heat exchange medium may be delivered to the battery pack and move through at least a portion of the battery pack enclosure 360c itself.

In view of the above, the battery packs of the present disclosure include battery pack enclosures with redundant sealing to prevent contaminant ingress. In addition, the present disclosure includes battery pack enclosures that can mitigate the effects of a crash or other impact event reducing the likelihood or otherwise mitigating the effects of, a thermal runaway condition as a result of such impact event by providing enhanced structural protection. The battery pack enclosures also can provide a robust package suitable for use in a variety of applications, including in connection with various electric vehicles including long-haul tractors.

### Venting Gas Protection

When battery cells are overcharged, exposed to extreme temperature, or mechanically damaged, a thermal runaway may happen. During a thermal runaway event, high temperature gasses, and sometimes debris with a high temperature are discharged from the vent of the battery cells. Thermal runaway conditions can result in failure of the enclosure, as well as potentially more serious and dangerous outcomes such as a battery fire.

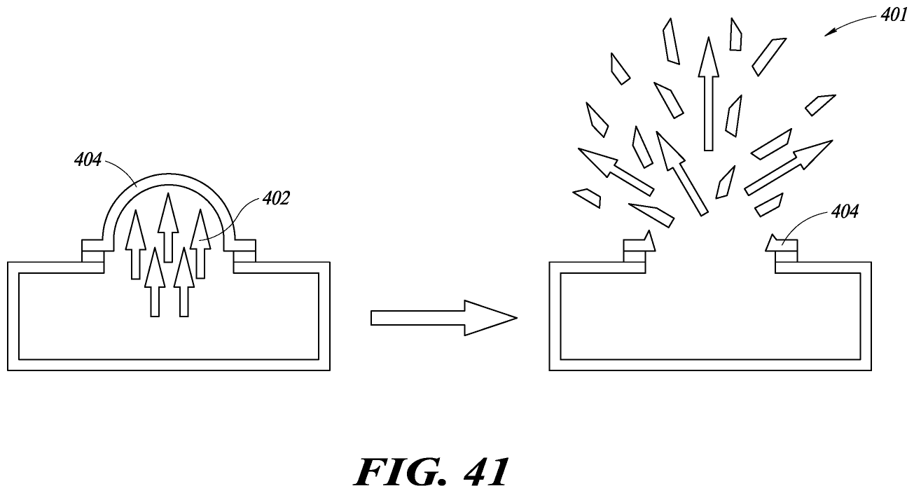

Turning to FIG. 41, illustrated therein is a schematic representation of a thermal runaway condition. When pressure in the cells and/or enclosure represented by arrows 402 exceeds a threshold level of a membrane 404 or some other aspect of the vent(s) described herein, the membrane 404 will burst to allow discharged matter 401 to exit the battery cells and/or enclosure. The discharged matter 401 may be a hot gas, debris, or any combination thereof, such as a hot gas with entrained debris. The discharged matter 401 from one cell may flow to other battery cells and lead to decomposition of the surrounding battery cells to create a thermal runaway condition of the type described above. Thermal runaway can lead to destruction of the battery, damage to the enclosure, and/or substantial risk to occupants of the vehicle including the battery, such as with a battery fire.

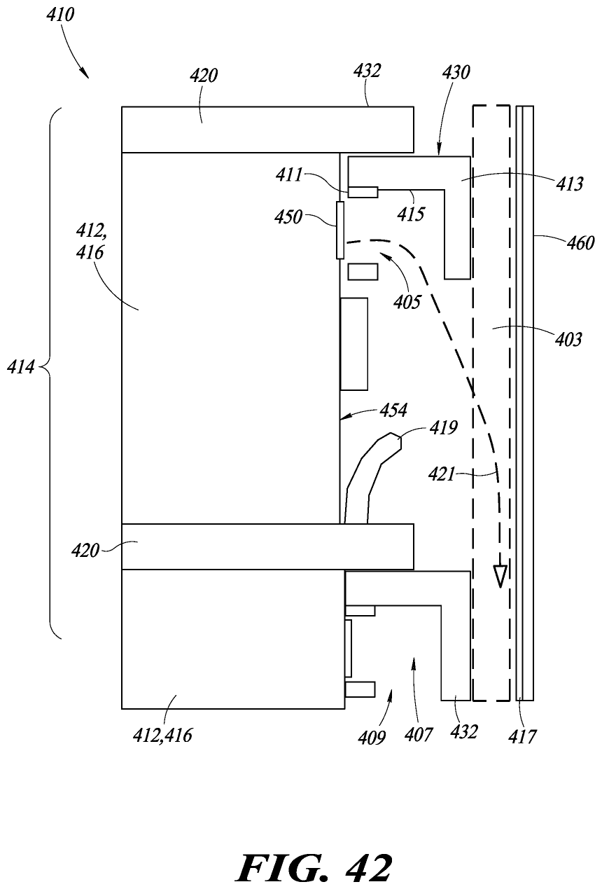

With reference to FIG. 42, a battery pack 410 (which may also be referred to herein as a battery pack system 410 or a system 410) includes a multi-layer battery stack 414 as well as thermal management devices 420 above and/or below each of a plurality of battery module layers 412 that form the stack 414, which may be, for example, provided in the form of active heat exchangers or more specifically battery cold plates, as described further elsewhere herein. More specifically, the battery pack 410 includes the plurality of battery module layers 412 stacked in a vertical direction to form the multi-layer battery stack 414 with each battery module layer 412 including a respective plurality of battery cells 416 arranged in a linear array. In the schematic cross-sectional view of FIG. 42, only a single battery cell 416 of each layer 412 is shown. The battery pack 410 may also include a battery pack frame 430 including a plurality of frame members 432, wherein each battery module layer 412 is secured to a respective frame member 432 to compress the thermal management devices 420 against the battery cells of each battery module layer 412 and hold the battery module layers 412 in compression in the stacked arrangement in the multi-layer stack 414. As will be readily appreciated, the battery pack 410 described here may be built-up or configured according to the any of the aspects and features of the battery packs 10, 110, 110′ described above at least with respect to FIGS. 1 through 16.

Each of the plurality of battery cells 416 include an end face 454 arranged normal to a direction in which the battery cells 416 are aligned in the linear array (namely, normal to a direction extending into and out of the page of FIG. 42). At least a portion of each of the thermal management devices 420 may extend beyond the end face 454 of the battery cells 416 to enable a mechanical connection between the thermal management devices 420 and the frame members 432 of the frame 430 to support the thermal management devices 420 and apply a compressive load on the multi-layer battery stack 414, as described herein. Each of the plurality of battery cells 416 further includes a vent 450 (also referred to as a vent valve 450) located on the end face 454. The vents 450 of the battery cells are in communication with an environment inside a battery enclosure 460 surrounding the multi-layer battery stack 414, the thermal management devices 420, and the battery pack frame 430. In some embodiments, the multi-layer battery stack 414, the thermal management devices 420, and the battery pack frame 430 are spaced from the battery enclosure 460 by at least a debris collection space 403 that may be provided in the form of an air gap between the enclosure 460 and the battery pack frame 430, or between the enclosure 460 and other internal aspects of the battery pack 410. The vents 450 may be provided in a number of different form factors that are capable of allowing gases to enter and escape the battery cells.

The battery pack 410 may further include vent protection functionality to decrease the likelihood of thermal runaway conditions and improve safety and operational lifespan of the battery pack 410, among other benefits. More specifically, the plurality of frame members 432 of the battery pack frame 430 may have vent protection functionality by being integrally formed with, or as, vent isolators. In such an embodiment, the frame members 432 serve as vent isolators and have the structural features and functionality of the frame members 432 described herein, but are also configured to assist in isolating discharged matter from the vent 450 of any one of the battery cells of each battery module layer 412 from the vents 450 of adjacent battery cells of the battery module layer 412 and to assist in directing the discharged matter away from the end face 454 of the battery cell during a thermal runaway event. The following description is directed to embodiments where the frame members 432 include such integrated vent isolation features and functionality, although it is to be appreciated that the vent isolators may also be a separate structure with similar features that is coupled to a respective frame member 432, bracket, or other fastening device of any of the battery pack frames 430 and/or battery packs 410 described herein in further embodiments. To assist in understanding the benefits and advantages of the disclosure, the frame members 432 will be referred to as vent isolators 432 in the following description of FIGS. 42 through 45 only.

The battery pack frame 430 may include a single vent isolator 432 for each battery module layer 412 in the multi-layer battery stack 414 with the vent isolator 432 provided in a form factor of an angle iron with a respective vent aperture 405 facing and aligned with the vent 450 of each battery cell 416 in each battery module layer 412, as further described below. In an embodiment, the vent isolators 432 may be a “U”-shaped frame member that defines an interior hollow channel 407 that is open on one side via a vent slot 409 extending along a longitudinal length of the respective vent isolator 432. In FIG. 42, the channel 407 is generally positioned with the vent slot 409 facing downward and opening into the space 403 according to the ordinary meaning of “down” as gravity pulls objects down. As a result, the vent slot 409 may be at a bottom of each vent isolator 432, while the vent apertures 405 are positioned normal to the vent slot 409 and on a face of the respective vent isolator that interfaces with the end face 454 of the battery cells of each layer 412.

According to the illustrated embodiment of FIG. 42, each vent isolator 432 includes a first vertical sidewall 411 and a second vertical sidewall 413 opposite the first vertical sidewall 411 connected by a transverse sidewall 415 with the transverse sidewall 415 defining a width or thickness of the vent isolator 432. The first vertical sidewall 411 includes the series of vent apertures 405 and interfaces with the end face 454 of each battery cell 416 in each battery module layer 412. Further, the sidewalls 411, 413, 415 cooperate to define the hollow channel 407. Each of the second vertical sidewall 413 and the transverse sidewall 415 may be a solid piece of metal or some other suitable material, with “solid” meaning that these sidewalls 413, 415 do not include openings, apertures, or other like structures and that gas and liquid are not capable of flowing through these sidewalls 413, 415. Further, each of the vent isolators 432 may be bare metal, or may include a fire retardant coating on at least a portion of, or all of, the vent isolators 432. In an embodiment, each of the plurality of battery cells 416 may likewise be coated with a fire retardant material.

In yet further embodiments, only certain aspects of the battery pack 410 are associated with fire retardant material, which may be a fire retardant coating, a layer of fire retardant material, or others. For example, only a surface area of, or at least a portion of a surface area of, the end face 454 of each battery cell and/or only select vent isolators 432 may be associated with fire retardant material based on design factors, such as likely locations of occurrence of thermal runaway conditions and the risks associated therewith in different locations in the battery pack 410. Thus, in some embodiments, a fire retardant material may be associated with at least some of the plurality of vent isolators 432 or at least some of the plurality of battery cells 416, or both. As shown in FIG. 42, the battery pack 410 may also include a layer of fire retardant material 417 in direct contact with, or in close contact with, the battery enclosure 460 in a vicinity of the vents 450 of the battery cells 416 of the multi-layer battery stack 414. In an embodiment, the layer of fire retardant material 417 is on an entire internal surface of the battery enclosure 460. The battery pack 410 may further include a plurality of debris dams 419 that assist with holding each cell 416 in the battery module layers 412 in place while also protecting at least a portion of the end face 454 of each cell 416, as further described below.

During a thermal runaway event, each vent aperture 405 defines at least a portion of a guide, conduit or passageway that assists in routing discharged matter from an associated one of the battery cells away from the vent 450 associated with the respective vent aperture 405 and away from the end face 454 of the battery cells. More specifically, the structure of the first vertical sidewall 411 surrounding each vent aperture 405 may be described as defining at least a portion of a guide, conduit, or passageway that assists in collecting and routing discharged matter from one of the battery cells away from the end faces 454 of the cells and toward the debris collection space 403, as generally indicated by dashed arrow 421. Likewise, the second vertical sidewall 413, the transverse sidewall 415 and/or the slot 409 may further define at least a portion of a guide, conduit, or passageway that assists in collecting and routing discharged matter from one of the battery cells away from the end faces 454 of the cells and toward the debris collection space 403, as generally indicated by dashed arrow 421. The debris collection space 403 may be positioned along a periphery of the battery pack 410, and more specifically, along a periphery of the multi-layer battery stack 414 that is spaced from the end faces 454 of the battery cells 416. At the same time, the debris dams 419 protect at least a portion of the end faces 454 of the cells at the bottom of each battery module layer 412 where discharged matter may otherwise be prone to collect as it travels to the debris collection space 403 during a thermal runaway event. In an embodiment, the debris dams 419 are shaped to direct debris away from each end face 454 and toward the debris collection space 403, for example, by having a shape that curves away from, or is positioned at angle away from, the end faces 454 of the battery cells 416. Such an arrangement may assist in preventing high temperature venting gas from directly impinging on the end faces 454 of the battery cells or some other portion of the battery cell surface, while also redirecting any discharged matter that impinges on the debris dams 419 toward the debris collection space 403. In some embodiments, the debris collection space 403 is elongated and spans an entirety or substantially an entirety of a longitudinal length of the linear array of the battery cells 416 of each battery module layer 412 and thus is capable of collecting and holding a substantial amount of discharged matter without such matter contacting the other cells 416.

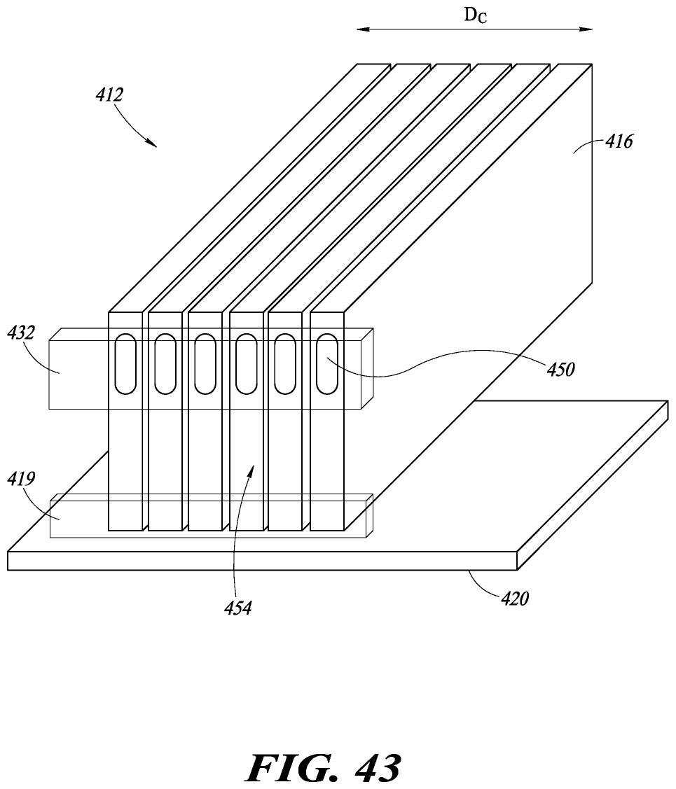

FIG. 43 is an isometric view of one battery module layer 412 of the battery pack 410. Each battery module layer 412 includes a plurality of battery cells 416 of the type described herein that are arranged in a series or array, and in direct contact with the thermal management device 420 underlying the cells 416. The debris dam 419 may be in direct contact with the thermal management device 420 and positioned adjacent a bottom portion of each end face 454 of the cells 416 to protect the bottom portion of each end face 454. The vent isolator 432 is spaced from the debris dam 419 across at least a select portion of a height of the battery cells 416 in the layer 412 and may be positioned proximate a top surface of the cells 416 in some embodiments. In an embodiment, the vent isolator 432 may also have a different location corresponding to the location of the vents 450. Further, the vent isolator 432 spans a series of the battery cells 416 of the battery module layer 412, meaning that the vent isolator 432 extends across multiple end faces 454 of multiple respective battery cells 416 in a direction that is parallel to a direction D_{C} in which the battery cells 416 are generally arranged in the series or array.

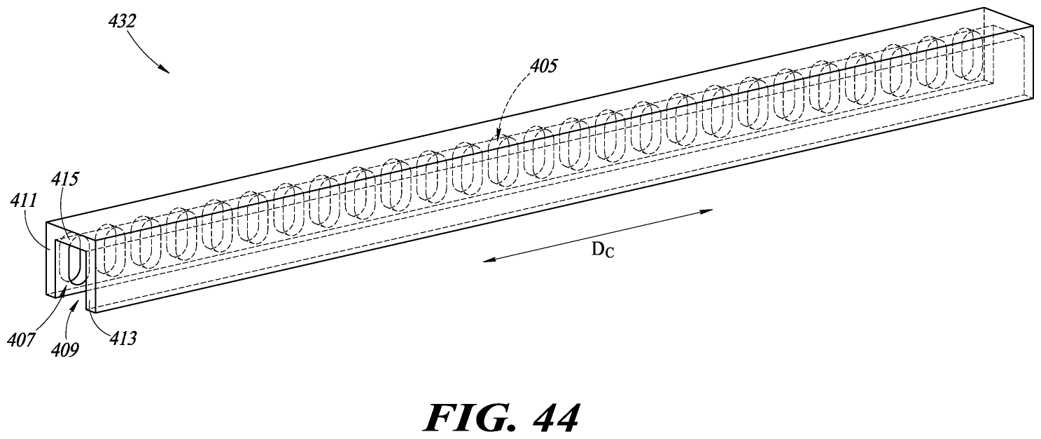

FIG. 44 shows the vent isolator 432 in more detail. The vent isolator 432 includes a linear array of vent apertures 405 in the direction D_{C}. Each vent aperture 405 is aligned with a respective one of the vents 450 of the series or array of the battery cells 416 of the battery module layer shown in FIG. 43. FIG. 44 also provides more detail regarding the features or aspects of at least some embodiments of the vent isolator 432 described with reference to FIG. 42, such as for, example, the channel 407, the vent slot 409, and the sidewalls 411, 413, 415, as well as the overall shape and structure of the vent isolator 432. As shown in FIG. 44, the channel 407 and vent slot 409 may extend along an entirety of the vent isolator 432 in the direction D_{C}, or a direction that is parallel to the direction D_{C} to facilitate alignment of the vent apertures 405 with the vents 450 of the cells 416.

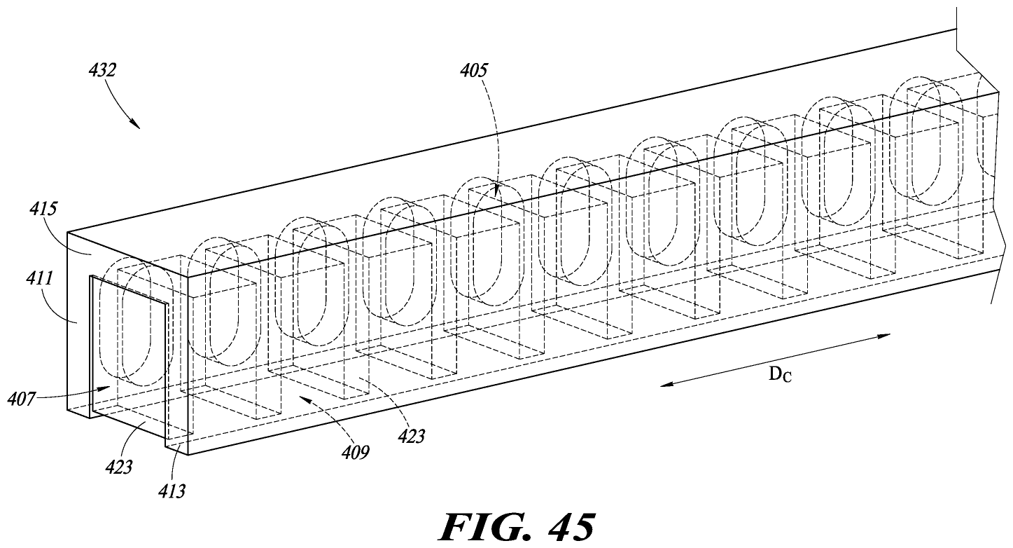

Turning to FIG. 45, each vent isolator 432 may include a plurality of separators 423 (which may also be referred to herein as walls 423 or partitions 423) that may be internal to the isolator 432 and positioned between adjacent vent apertures 405 in the linear array of apertures 405. The separators 423 may be a solid material according to the above definition of “solid” that assists in preventing discharged matter from one vent 450 or cell 416 from impacting, directly or indirectly, the other vents 450 and cells 416. Further, the separators 423 may nearly completely seal and/or isolate an internal space of the vent isolators 423 between respective adjacent vent apertures 405 such that discharged matter from one vent 450 of one cell 416 cannot reasonably contact the vents 450 of other adjacent cells 416. More specifically, “nearly completely seal and/or isolate” means that each separator 423 may be extend between, and be coupled to and in sealing contact with the sidewalls 411, 413, 415 to create a generally isolated or sealed space around each vent aperture 405 that is only open at the bottom through the vent slot 409. As a result, the only path out of the vent isolator 432 for discharged matter from one vent 450 of one cell 416 is through the vent slot 409 (FIG. 42) at the bottom of each respective isolated or sealed space around each vent aperture 405. In this way, the separators, as well as the vent isolator 432 generally, assist with preventing discharged matter from one cell 416 during a thermal runaway event from contacting other cells 416, and in particular the vents 450 of other cells 416, to significantly reduce the likelihood of a thermal runaway condition and the risks and potential damage associated with the same. The separators 423 may be the same material as the vent isolators 432, or may be a different suitable material, and may be formed integrally with the vent isolator 432 or separately fastened thereto. In an embodiment, at least a portion of, or all of, each of the separators 423 are associated with fire retardant material.

The above features may also be recited as one or more steps in a method, such as during a thermal runaway event, isolating discharged matter from the vent 450 of one battery cell 416 from vents 450 of adjacent battery cells 416 of the battery pack 410 with the vent isolator 423 the above-described structure. The method further includes collecting the discharged matter in the debris collection space 403 provided around the periphery of the battery pack 410. Additional steps in the method are contemplated herein based on the above description of FIGS. 41 to 45.

In view of the above, the vent isolators 432 and debris collection space 403 assist with preventing direct impingement of high temperature discharged matter from one cell 416 during a thermal runaway event from contacting other cells 416 to significantly reduce the likelihood of a thermal runaway condition with other cells 316 and the risks and potential damage associated with the same.

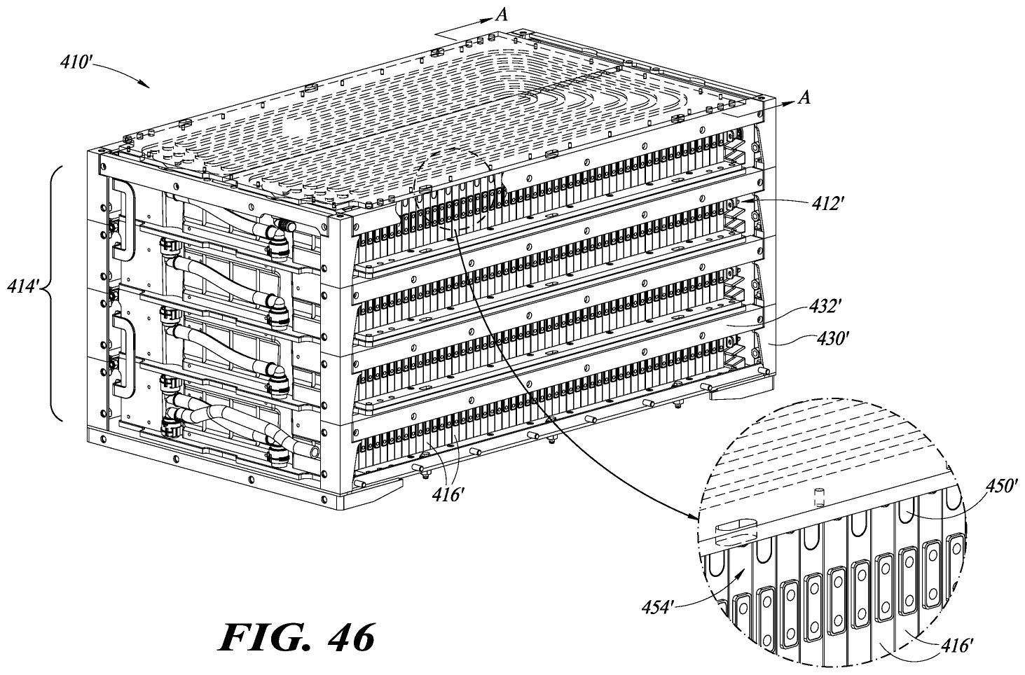

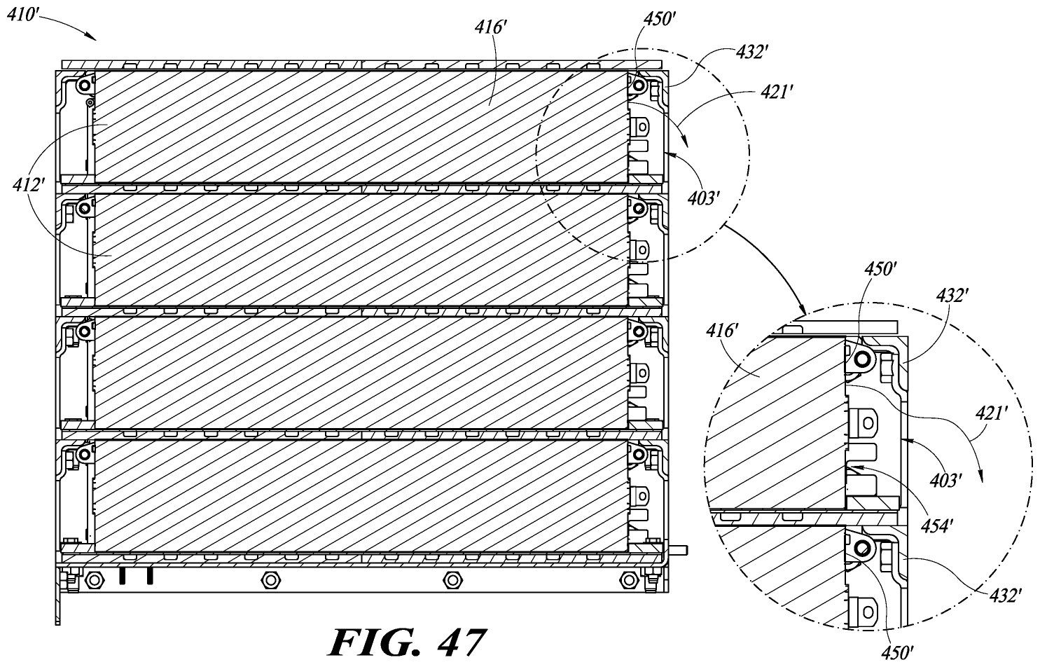

FIG. 46 illustrates a battery pack 410′ that may be an embodiment or implementation of the battery pack 410 represented schematically in FIG. 42. The battery pack 410′ includes a plurality of battery module layers 412′ stacked in a vertical direction to form a multi-layer battery stack 414′ with each battery module layer 412′ including a respective plurality of battery cells 416′ arranged in a linear array. The battery pack 410′ may also include a battery pack frame 430′ including a plurality of frame members 432′, wherein each battery module layer 412′ is secured to a respective frame member 432′ to compress thermal management devices described elsewhere against the battery cells 416′ of each battery module layer 412′ and hold the battery module layers 412′ in compression in the stacked arrangement in the multi-layer stack 414′. The battery pack frame 430′ may be similar, or identical, to battery pack frame 130′ described with reference to FIGS. 9 and 10. Each battery cell 416′ includes an end face 454′ with a vent 450′ (or vent valve 450′) located on the end face 454′, as best shown in the detail view of FIG. 46. Except as otherwise noted, the remaining features of the battery pack 410′ may be similar or identical to battery pack 10 and/or battery pack 110, 110′ described elsewhere.

The frame members 432′ provide the vent protection functionality described above in FIG. 42, which is explained herein with reference to FIG. 47 based on the embodiment or implementation of the battery pack 410′. Specifically, FIG. 47 is a cross-sectional view of the battery pack 410′ along line A-A in FIG. 46. FIG. 47 illustrates a cross section of specific battery cells 416′ in each battery module layer 412′. In an embodiment, the frame members 432′ may be right angle or 90-degree angle frame members 432′. As shown in FIG. 46, the frame members 432′ are spaced from each other over a height of the battery pack 410′, with each frame member 432′ generally having a height that is less than a majority of a height of a respective end face 454′ of the battery cells 416′. Thus, there is a space or gap 403′ between the frame members 432′ that may be similar to debris vent space 403 described above. Although not shown, the battery pack 410′ may also include an enclosure of the types described herein coupled to the battery pack frame 430′ and generally enclosing the multi-layer battery stack 414′ (FIG. 46). Thus, the space 403′ may be between the end faces 454′ of the battery cells 416′ and the battery enclosure that is limited in part by the frame members 432′.

If a venting event occurs during operation, debris is vented from the vents 450′ on the end face 454′ of one or more battery cells 416′ in a layer of the multi-layer stack 414′. The vented matter is guided by the frame members 432′ through the space 403′. The frame members 432′ of other layers act as a shield that protects the vents 450′ and the end faces 454′ generally of the cells 416′ in the other layers by preventing the vented debris from contacting the vents 450′ and/or end faces 454′ of the other layers. Thus, the vented debris is prevented from contacting additional cells 416′ to reduce the likelihood of a thermal runaway event, battery fire, or other adverse impacts. The path of the vented debris is illustrated in FIG. 47 by arrow 421′. In sum, the vented debris is directed outward and downward in the orientation of FIG. 46 by at least the frame members 432′, through the space 403′, and toward a bottom of the battery pack 410′ for collection without contacting the cells 416′ in other layers 412′ of the battery pack 410′. In this way, the battery pack frame 430′ may be implemented with frame members 432′ that assist with preventing discharged matter from one cell 416′ during a thermal runaway event from contacting other cells 416′, and in particular the vents 450′ and/or end faces 454′ of other cells 416′, to significantly reduce the likelihood of a thermal runaway condition and the risks and potential damage associated with the same.

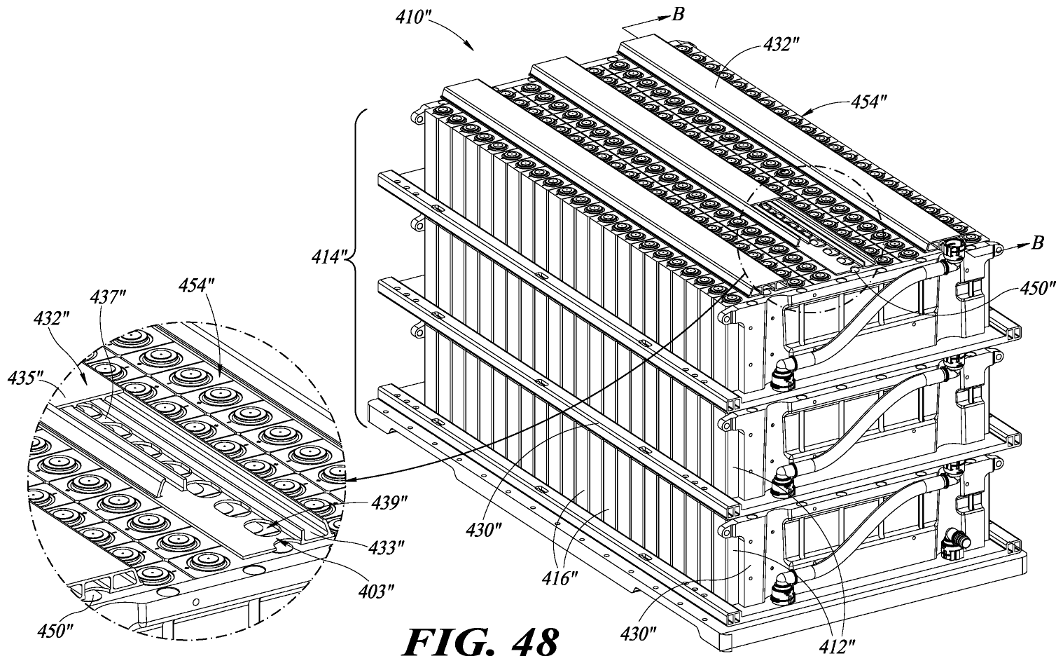

FIG. 48 is an isometric view of a further battery pack 410″ with vent protection functionality. As noted herein, the battery packs described in the disclosure may include a variety of different types of battery cells, including but not limited to prismatic battery cells. The further battery pack 410″ is an example embodiment of a battery pack 410″ that includes such prismatic cells 416″ arranged in layers 412″ in a multi-layer battery stack 414″. Each layer 412″ may include a plurality of cells 416″ in several rows and columns with the rows and columns adjacent to each other or spaced from each other according to the size of the layer 412″ and/or battery pack 410″, which may be selected. For example, the battery pack 410″ of FIG. 48 may include layers 412″ with three rows of battery cells 416″ in a length or longest dimension of the battery pack 410″ and a selected number of columns in a width dimension, such as at least 10, 20, or more columns. Although not shown, the battery pack 410″ may be associated with a battery pack enclosure of the types described herein. The battery pack 410″ may also include a battery pack frame 430″, albeit the frame members 432″ are omitted in favor of the vent isolators described below.

The prismatic cells 416″ have an end face 454″ that may be at the top of the cells 416″ such that the end face 454″ is a top outermost surface of the cells 416″ according to the orientation of FIG. 48. The cells 416″ may also be arranged with the end face 454″ being a bottom outermost surface, or a side outermost surface depending on the selected orientation of the cells 416″. A vent 450″ of the cells 416″ is located on the end face 454″, or at the top of the cells 416″ in the illustrated embodiment. As shown in FIG. 48, the vents 450″ of the cells 416″ in each row of cells 416″ in the lengthwise direction of each layer 412″ may generally be aligned with each other. A vent isolator 432″ is associated with each row of vents 450″, such as the three vent isolators 432″ for the three rows of vents 450″ in the battery pack 410″. The vent isolator 432″ may be a structural frame member that enables stacking of the layers 412″. Further, the vent isolators 432″ may be provided in only one layer 412″ and for each of the rows of vents 450″, or may be provided in each layer 412″ or selected layers 412″. While the vent isolators 432″ are preferably associated with each row of vents 450″, the disclosure contemplates vent isolators 432″ being associated with less than each row of vents 450″, such as only selected rows of vents 450″.

The vent isolators 432″ have a frame construction with rails 433″ engaging and coupled to a top plate 435″. The rails 433″ are spaced from each other across the vents 450″ and the top plate 435″ is a continuous sheet such that the combination of the rails 433″ and top plate 435″ defines a channel or space 403″ for distribution of vented debris that may generally be similar to the debris vent spaces 403, 403′ described above. The vent isolators 432″ further include a bottom plate 437″ with a plurality of apertures 439″ that are generally provided in a number and arrangement that corresponds with the vents 450″ in each row of cells 416″. The bottom plate 437″ bounds the debris vent space 403″ at the bottom, except for apertures 439″. The plurality of apertures 439″ may be separated from each other by portions of the bottom plate 437″. Thus, during a venting event, ejected debris and other matters from the vents 450″ is provided to the channel or debris vent space 403″ between the rails 433″ and the top plate 435″ with the rails 433″ and top plate 435″ functioning to guide the ejected debris and other matters away from other cells 416″ in other rows and from other layers 412″ in the battery pack 410″, as further described below.

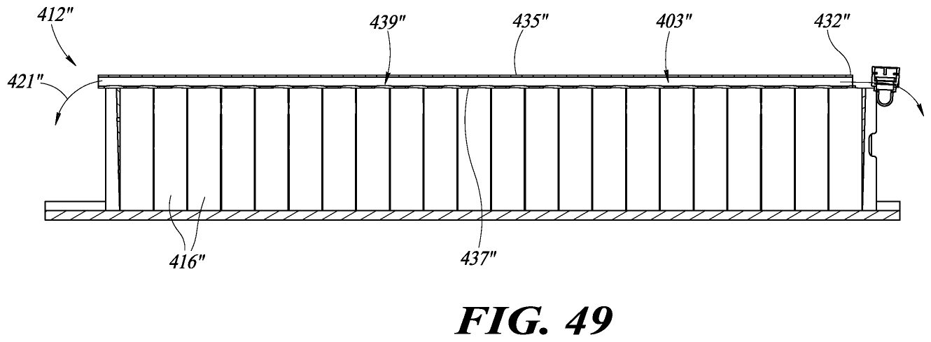

FIG. 49 is a cross-sectional view of an array or row of battery cells 416″ of the further battery pack 410″ along line B-B in FIG. 48 illustrating operation of the vent isolators 432″. During a venting event, debris is ejected from vents 450″ on the end face 454″ and passes through apertures 439″ in the bottom plate 437″ of the vent isolators 432″ to be collected in the channel or debris vent space 403″. The rails 433″, top plate 435″, and bottom plate 437″ guide the vented debris along the debris vent space 403″ under pressure from the venting event until it is ejected at outer end faces or sides 441″ of the respective array or row of battery cells 416″, as indicated by arrows 421″. Because the prismatic cells 416″ are generally smaller in size, and in some embodiments, much smaller than the other battery cells, such as battery cells 416 and 416′ (and other like battery cells described herein), the vents 450″ of successive cells 416″ in each row can be in communication with each other via apertures 439″ without causing a significant thermal runaway event. In other words, venting of the cells 416″ associated with each vent isolator 432″ may not be significant enough to cause the serious impacts and risks described herein with larger scale thermal runaway events, such as for an entire layer of cells 416″ or entire battery pack 410″. In this way, the battery pack 410″ may be implemented with vent isolators 432″ that assist with preventing discharged matter from one row of cells 416″ during a thermal runaway event from contacting other rows of cells 416″ and other layers 412″ of cells 416″. The vent isolators 432″ may also be arranged at the top end face of prismatic cells 416″, among other variations discussed herein.

### Venting Gas Detection

The battery packs of the present disclosure may further include venting detection and warning functionality, meaning, the battery packs include aspects and/or techniques for detecting whether a thermal runaway event (or venting event) has occurred with at least one battery cell and providing a suitable warning indication to a driver and/or occupant of a vehicle including the battery pack. Such a warning indication may provide time for the driver and/or occupant(s) to safely exit the vehicle to mitigate the risk of harm to the driver and/or occupant(s) in the event of battery thermal runaway of the type described herein.

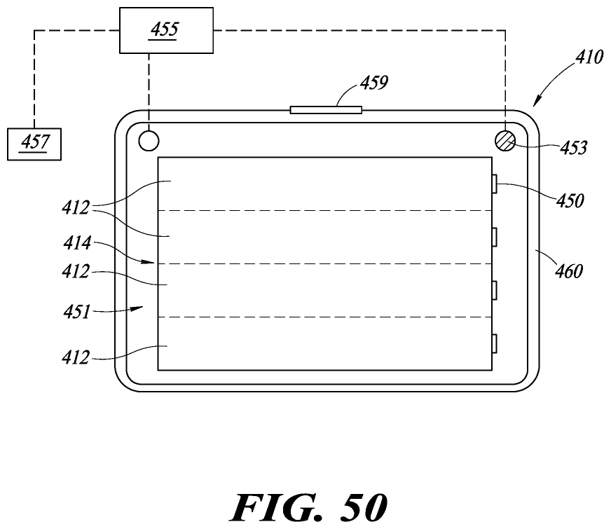

With reference to FIG. 50, one or more embodiments of the battery pack 410 include the multi-layer battery stack 414 surrounded by the battery enclosure 460 (which may also be referred to herein as a battery pack enclosure 460). The multi-layer battery stack 414 includes a plurality of battery module layers 412 stacked to form the multi-layer battery 414 with each battery module layer 412 including a respective plurality of battery cells arranged in an array. FIG. 50 is a schematic cross-sectional view such that only one battery cell in the array forming each layer 412 is shown. Each battery cell includes the vent 450 that is configured to discharge matter upon a fault condition of the battery cell, as described herein. The multi-layer battery stack 414 may be separated from the battery enclosure 460 by an air gap 451. In some embodiments, the air gap 451 surrounds the multi-layer battery stack 414. It is appreciated that the battery pack 410 and multi-layer battery stack 414 may be built-up or constructed in accordance with any other the battery packs disclosed herein, including, for example, the battery packs 10, 110, 110′ and battery pack stacks 14, 114, 114′ described with reference to FIGS. 2 through 6 and 9 through 13.

The battery pack 410 further includes at least one sensor 453. The at least one sensor 453 may be disposed on the battery enclosure 460, on the multi-layer battery stack 414, or in some other location. Further, the at least one sensor 453 may be positioned in a selected location relative to the battery enclosure 460 and/or the multi-layer battery stack 414, such as in upper corners or any upper portion of the battery enclosure 460 and/or multi-layer battery stack 414 in some non-limiting examples. The at least one sensor 453 is in communication with the air gap 451 around the multi-layer battery stack 414. As will be described in more detail below, the at least one sensor 453 is configured to detect a change in at least one characteristic of the battery enclosure 460 over time, or more particularly, at least one characteristic of the air gap 451 internal to the battery enclosure 460 over time. The at least one characteristic may be associated with vented matter from the vent 450 of at least one of the battery cells during a thermal runaway event of the type described herein. The battery pack 410 may include only a single sensor 453, or may include more than one sensor 453. In some non-limiting examples, the at least one sensor 453 may be only a pressure sensor operable to detect pressure over time (e.g., 1000 Pa above ambient) and/or a rate of pressure change in the air gap 451, only a gas sensor operable to detect a change in gas concentration over time, or a combination of such a pressure sensor and a gas sensor.

In an embodiment where the at least one sensors 453 is a pressure sensor 453, the pressure sensor 453 may be a transducer operable to detect pressure of the air gap 451, and the controller 455 described further below may detect or determine pressure over time or the rate of pressure change over a detection period based on the raw pressure measurements from the pressure sensor 453. In further embodiments, the pressure sensor 453 may be associated with a clock or timer that is part of the pressure sensor 453 or is onboard the controller 455 to facilitate such pressure rate calculations at the pressure sensor 453. Where the at least one sensor 453 is a gas sensor 453, the gas sensor 453 may likewise be a sensor operable to detect or determine gas concentration of the air gap 451 over time, with the controller 455 further configured to interpret the raw gas concentration measurements. The present disclosure also contemplates use of additional and/or different types of sensors, which may include, but are not limited to, vibration sensors, temperature sensors, and others.

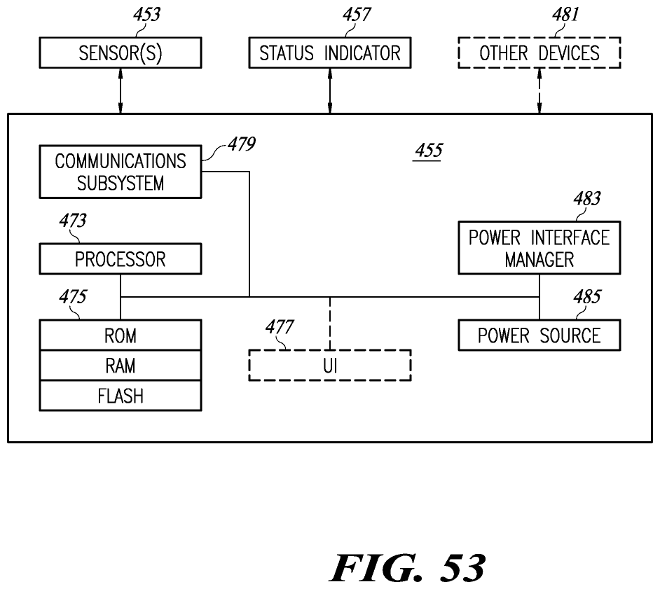

The following description includes certain non-limiting examples of techniques for detecting or determining pressure over time, but it is to be appreciated that such detection or determination of pressure over time may also be used to calculate a rate of pressure change over an observed period of time, such as at least with assistance from the controller 455. The at least one sensor 453 is in communication, either wired or wirelessly, with a controller 455 (which may also be referred to herein as a computing system 455) that may be carried by the battery pack 410 or may be located external to the battery pack 410. The controller 455 will be described in more detail with reference to FIG. 53, but briefly, the controller 455 receives instructions, signals, and/or data from the at least one sensor 453 regarding the detected conditions in the battery enclosure 460 (i.e., the detected conditions of the air gap 451) and may transmit instructions, signals, and/or data to a status indicator 457. The status indicator 457 is therefore in communication, either wired or wirelessly, with the at least one sensor 453. The status indicator 457 is operable to provide at least one warning indication to a driver and/or occupant of a vehicle including the battery pack 410 in response to the detected change in the at least one characteristic over time in the battery pack enclosure associated with discharged matter from the vent valve 450 of at least one of the battery cells 412 via the at least one sensor 453.

The status indicator 457 may be positioned in the vehicle, such as on a dashboard, in or proximate to an instrument cluster, or some other location that is preferably proximate to, or in a line of sight of, the driver of the vehicle. Further, the status indicator 457 may be one or more light-emitting diodes (LEDs), a speaker, a buzzer, or any combination thereof. As a result, the at least one warning indication provided by the status indicator 457 may be a haptic signal, a visual alert, an auditory alert, or any combination thereof in some embodiments. The controller 455 may also be in communication with a mobile device of the driver and may provide instructions, signals, and/or data to the mobile device to provide additional warning indications of the type described herein via onboard hardware of the mobile device.

The battery enclosure 460 may include a relief valve 459 located anywhere along the battery enclosure 460, such as at a top or a side of the battery enclosure 460 in some non-limiting examples. The relief valve 459 may be provided in a form factor that is similar to the vents 450 of the battery cells described herein and illustrated in FIG. 41, or some other type. The relief valve 459 is configured to allow air and other gases to enter and escape the battery enclosure 460 while preventing ingress of water, oil, other liquids, and dust and debris into the battery enclosure 460. In particular, the relief valve 459 is operable to expel pressure and/or gas accumulated in the battery enclosure 460 that exceeds a threshold pressure and/or that is actuated in response to the change in at least one characteristic of the battery enclosure 460 over time, such as, for example, a gas concentration exceeding a threshold limit as described herein to prevent failure of the battery enclosure 460 or a thermal runaway condition. The relief valve 459 may operate automatically, meaning that the relief valve 459 includes aspects for venting the pressure and/or gas at the threshold pressure and/or threshold gas concentration. Alternatively, the relief valve 459 may be in wired or wireless communication with the controller 455 and the controller 455 sends instructions, signals, and/or data to the relief valve 459 to expel pressure and/or gas upon detection of a thermal runaway event via the at least one sensor 453.

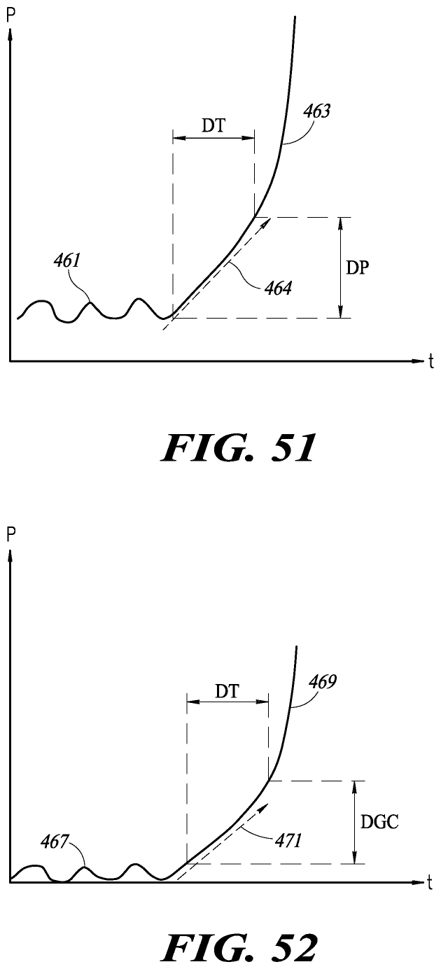

FIG. 51 is a graphical representation of pressure in the battery enclosure 460 over time. In particular, FIG. 51 is provided to illustrate one or more embodiments where the at least one sensor 453 is a pressure sensor 453, and the associated detection of a thermal runaway event of at least one battery cell in the battery enclosure 460 by measuring pressure in the air gap 451 in the battery enclosure 460 with the pressure sensor 453. In FIG. 51, pressure is on the vertical or y-axis and time is on the horizontal or x-axis. The units for the pressure may be Pascals (Pa), and the units for time may be seconds(s).

Under normal operating conditions, the battery pack 410 may experience comparatively small variations in pressure over time in the air gap 451 inside the battery enclosure 460 that may be attributable to vibrations from driving the vehicle, and/or temperature fluctuations in the battery enclosure 460 as a result of environmental conditions around the battery pack 410, operation of the cooling systems described herein, operation of the battery cells, or any combination thereof. These comparatively small variations are represented in FIG. 51 by a first portion 461 of the graph line that includes small peaks and valleys. When a thermal runaway event occurs in one or more of the battery cells, the one or more battery cells vent matter in the nature of hot gas or hot gas entrained with debris. The vented matter results in a relatively sudden increase in pressure that continues to increase as the matter is discharged to provide a pressure profile similar to that illustrated by a second portion 463 of the graph line. As shown with the dashed arrow in FIG. 51 labeled 464, an initial portion of the second portion 463 of the graph line associated with the thermal runaway event has a sustained positive slope that is noticeably discernable from the pressure fluctuations of the first portion 461. The dashed arrow 464 in FIG. 51 is a visual representation of the rate of pressure change in the air gap 451 that is associated with a thermal runaway event and lasts for a duration that is considerably longer in duration than variations in pressure over time in the air gap 451 associated with vibration and/or temperature variations during normal operating conditions shown in the first portion 461 of the depicted pressure profile, which notably include increasing and varying rates of pressure change, and decreasing and varying rates of pressure change that fluctuate over relatively shorter durations. Notably, the sustained period of time in which the rate of pressure change exceeds a particular threshold value reflected in the second portion 463 of the illustrated pressure profile may be used to identify a thermal runaway event.

Again, in some embodiments, a sustained rate of pressure change (DP/DT) that exceeds a threshold value for an extended threshold duration may be used to identify a thermal runaway event. In some instances, the threshold value of the sustained rate of pressure change (DP/DT) may be a rate of pressure change of at least 50 Pa/s, and the threshold duration may be at least three seconds. In some instances, the threshold value of the sustained rate of pressure change (DP/DT) may be between and including 50 Pa/s and 150 Pa/s, and the threshold duration may between and including 3 seconds and 5 seconds. In an advantageous embodiment, the graphical representation generally corresponds to the at least one sensor 453 being a pressure sensor 453 operable to detect or determine pressure over time, and in turn a rate of pressure change (DP/DT). The pressure sensor 453 may send information, signals, and/or data to the controller 455 and/or status indicator 457 to provide the at least one warning indication once the detected or determined pressure and/or rate of pressure change by the pressure sensor 453 in the air gap 451 is greater than established thresholds for a particular threshold duration or time, such as the thresholds described immediately above. In this way, small variations in pressure, such as those that correspond to the first portion 461 of FIG. 51 do not result in the status indicator 457 providing the at least one warning indication.

In a non-limiting example, if the air gap 451 has a volume of approximately 130 liters (L) and the thermal runaway event releases 0.1 L/s of hot gas or hot gas entrained with debris, then the pressure inside the battery enclosure 460 will increase by approximately 75 Pa/s, which is a considerably larger rate of pressure change than is expected to occur during normal operating conditions. Other variations are possible based on a number of factors such as the size, type, and/or number of battery cells as well as characteristics of the battery enclosure 460 such that the above ranges may be higher or lower than the stated amounts in some embodiments.

Upon occurrence of a thermal runaway event that results in a pressure profile that exceeds pre-established thresholds, the pressure in the battery enclosure 460 may be vented by the relief valve 459 of the battery enclosure 460 (FIG. 50). In this way, the relief valve 459 of the battery enclosure 460 may assist with regulating pressure inside the battery enclosure 460 and preventing damage to the battery enclosure 460 and mitigating the likelihood of other more serious outcomes, following a thermal runaway event.

FIG. 52 is a graphical representation of detected gas concentration in the battery enclosure 460 over time. In particular, FIG. 52 is provided to illustrate one or more embodiments where the at least one sensor 453 is a gas sensor 453, and the associated detection of a thermal runaway event of at least one battery cell in the battery enclosure 460 by measuring changes in gas concentration in the air gap 451 in the battery enclosure 460 with the gas sensor 453. In FIG. 52, gas concentration (GC) is on the vertical or y-axis and time is on the horizontal or x-axis. The units for the gas concentration may be parts per million (ppm) and the units for time may be seconds(s).

Under normal operating conditions, the battery pack 410 may experience comparatively small variations in gas concentration over time in the air gap 451 inside the battery enclosure 460 that may be attributable to operation of the battery cells, or other factors. These comparatively small variations are represented in FIG. 51 by a first portion 467 of the graph line that includes small peaks and valleys. In practice, such peak and valleys in the first portion 467 may instead be a steadily increasing gas concentration, but with a sustained rate of increase that is significantly lower than that associated with a thermal runaway (or venting) event, as described further below. When a thermal runaway event occurs in one or more of the battery cells, the one or more battery cells vent matter in the nature of hot gas or hot gas entrained with debris. The gas may include carbon monoxide (CO), carbon dioxide (CO2), a lithium complex (LiX) including lithium in combination with other elements, or any combination thereof. The vented matter corresponds to a relatively sudden significant increase in gas concentration over a short time that is generally illustrated by a second portion 469 of the graph line. As shown with the dashed arrow in FIG. 52 labeled 471, at least a portion of the second portion 469 of the graph line has a sustained positive slope that may be steeper and readily discernable from the first portion 467 of the graph line. The dashed arrow in FIG. 52 labeled 471 is a visual representation of the rate of change in gas concentration in the air gap 451 that is associated with a thermal runaway event being considerably higher for a considerably longer in duration than changes in gas concentration, if any, in the air gap 451 associated with normal operating conditions shown by the first portion 467 of the graph line.

In some embodiments, a sudden increase in gas concentration DGC which results in a gas concentration level that exceeds a threshold gas concentration may be used to identify a thermal runaway event. In some instances, the threshold gas concentration may be at least 50 ppm, or between and including 20 ppm and 80 ppm. Further, the change in gas concentration may be for a change in concentration of a single gas detected by the gas sensor 453, such as CO, or may be a change in total gas concentration for several selected gases detected by the gas sensor 453 in the air space 451 in the battery enclosure 460. Other variations are possible based on a number of factors such as the size, type, and/or number of battery cells as well as characteristics of the battery enclosure 460 such that the above ranges may be higher or lower than the stated amounts in some embodiments.

Upon occurrence of a thermal runaway event that results in a gas concentration profile that exceeds one or more pre-determined thresholds, the gas in the battery enclosure 460 may be vented by the relief valve 459 of the battery enclosure 460 (FIG. 50). In this way, the relief valve 459 of the battery enclosure 460 may assist with regulating gas concentration inside the battery enclosure 460 to prevent damage to the battery enclosure 460 while also mitigating the likelihood of other more serious outcomes following a thermal runaway event. Further, the measurement of gas concentration inside the battery enclosure 460 may be particularly advantageous because it is not susceptible to variations that are a result of vibrations in the vehicle and/or small gradients of signal noise that may be associated with the aforementioned pressure detection.

FIG. 53 is a block diagram of the controller 455. As further described below, the controller 455 is suitable for executing or otherwise performing at least some embodiments or techniques of the battery packs described herein, including but not limited to battery pack 410. The physical or hardware aspects of the controller 455 may be provided in the battery enclosure 460, in a separate housing carried by the battery enclosure 460, and/or at an external location to the battery enclosure and communicatively coupled to at least the one or more sensors 453 in the battery enclosure 460, among other devices. In an embodiment, the controller 455 is a centralized battery management system (BMS), or is one aspect of a BMS for providing centralized monitoring and control functionality for the common battery packs. The controller 455 may also be, or may be part of, a master-slave battery management system (BMS) for providing distributed monitoring and control functionality.

The controller 455 includes a processor 473, for example a microprocessor, digital signal processor, programmable gate array (PGA) or application specific integrated circuit (ASIC). The controller 455 includes one or more non-transitory storage mediums 475, for example read only memory (ROM), random access memory (RAM), Flash memory, or other physical computer- or processor-readable storage media in communication with the processor 473. The non-transitory storage mediums 475 may store instructions and/or data used by the processor 473 and the controller 455 generally, for example an operating system (OS) and/or applications. The instructions as executed by the processor 473 may execute logic to perform the functionality of the various implementations or techniques of the devices and systems described herein, including, but not limited to, receiving signals from the one or more sensors 453, and determining, based on the signals, whether to instruct the status indicator 457 to provide the at least one warning indication, among others.

The controller 455 may include, or be in communication with, the one or more sensors 453, such as the pressure sensor and/or gas sensor. As described herein, the sensors 453 send signals, instructions, and/or data to the processor 473 based on detected conditions, such as pressure, a rate of pressure change, and/or gas concentration in the air gap 451 of the battery enclosure 460. The controller 455 may include, or be in communication with, the status indicator 457. As noted above, the status indicator 457 may be one or more LEDs or some other lighting element, a speaker, and/or a buzzer, among others. In at least some embodiments, each individual lighting element may be position- and hue-addressable, such as to control the color and state of each element independently of or in conjunction with the other lighting elements. The speaker may be a buzzer configured to emit sound as well as haptic signals or vibrations. In some embodiments, the controller 455 may include a separate speaker for emitting sound and a haptic device for emitting vibration, such as to change the strength, volume, or other characteristics of either of these signals relative to a buzzer.

The control unit 455 may include a user interface (UI) 477 to allow a user to operate or otherwise provide input to the controller 455, the battery packs, and/or systems described herein, such as with respect to the operational state or condition of the battery pack 410. In some embodiments, the user interface 477 is configured to display information to the user, such as a driver and/or occupant of a vehicle regarding the operational state or other characteristics of the battery pack 410. Additionally, the user interface 477 may include a number of user actuatable controls, such as, for example, a number of switches or keys operable to turn certain aspects ON and OFF and/or to set various operating parameters of the battery pack 410, the one or more sensors 453, and the status indicator 457, such as sensor sensitivity and operation and control of test and/or maintenance modes, among others. The switches and keys or the user interface 477 may include, for example, toggle switches, a keypad or keyboard, rocker switches or other physical actuators.

In some embodiments, the user interface 477 may include a display, for instance a touch panel display. The touch panel display (e.g., LCD or LED with touch sensitive overlay) may provide both an input and an output interface for the user. The touch panel display may present a graphical user interface, with various user selectable icons, menus, check boxes, dialog boxes, and other components and elements selectable by the end user to set operational states or conditions of the battery pack 410. The user interface 477 may also include one or more auditory transducers, for example one or more speakers and/or microphones. Such may allow audible alert notifications or signals to be provided to the user as a result of manual interaction with the user interface 477. Such may additionally, or alternatively, allow the user to provide audible commands or instructions. The user interface 477 may include additional components and/or different components than those illustrated or described, and/or may omit some components.

The controller 455 includes a communications sub-system 479 that may include one or more communications modules or components which facilitate communications with the one or more sensors 453, the status indicator 457, and/or other external devices 481, such as a personal computing device, mobile device, server, or a remote computing system associated with the controller 455 that monitors the operational characteristics of the battery pack 410. The communications sub-system 479 may provide wireless or wired communications to one or more such devices and may include wireless receivers, wireless transmitters and/or wireless transceivers to provide wireless signal paths to the various aspects, remote components, and/or systems of the one or more paired devices. The communications sub-system 479 may, for example, include components enabling short range (e.g., via Bluetooth®, BLE (“Bluetooth® low energy”), near field communication (NFC), or radio frequency identification (RFID) components and protocols) or longer range wireless communications (e.g., over a wireless LAN, Low-Power-Wide-Area Network (LPWAN), satellite, or cellular network) and may include one or more modems or one or more Ethernet or other types of communications cards or components for doing so. The communications sub-system 479 may also include one or more bridges or routers suitable to handle network traffic including switched packet type communications protocols (TCP/IP), Ethernet or other networking protocols.

The controller 455 further includes a power interface manager 483 that manages supply of power from a power source 485 to the various components of the controller 455, such as at least the one or more sensors 453 and the status indicator 457. The power interface manager 483 is coupled to the processor 473 and the power source 485. Alternatively, in some implementations, the power interface manager 483 can be integrated in the processor 473. The power source 485 may include an external power supply, or a rechargeable or replaceable battery power supply, as well as the battery pack 410 itself, among others. The power interface manager 483 may include power converters, rectifiers, buses, gates, circuitry, etc. in some embodiments. In particular, the power interface manager 483 can control, limit, and/or restrict the supply of power from the power source 485 based on the various operational states of the battery pack 410, as described in more detail below.

In some embodiments or implementations, the instructions and/or data stored on the non-transitory storage mediums 475 that may be used by the processor 473 and the controller 455 generally, such as, for example, ROM, RAM and/or Flash memory, includes or provides an application program interface (“API”) that provides programmatic access to one or more functions of the controller 322. For example, such an API may provide a programmatic interface to control one or more operational characteristics of the battery pack 410. Such control may be invoked by one of the other programs, other remote device or system, or some other module. In this manner, the API may facilitate the development of third-party software, such as various different user interfaces and control systems for other devices, plug-ins, and adapters, and the like to facilitate interactivity and customization of the operation and devices within the battery pack 410.

In an embodiment, components or modules of the controller 455 and other devices within the battery packs described herein are implemented using standard programming techniques. For example, the logic to perform the functionality of the various embodiments or techniques described herein may be implemented as a “native” executable running on the controller 455, e.g., microprocessor 473, along with one or more static or dynamic libraries. In other embodiments, various functions of the controller 455 may be implemented as instructions processed by a virtual machine that executes as one or more programs whose instructions are stored on non-transitory storage mediums 475. In general, a range of programming languages known in the art may be employed for implementing such example embodiments, including representative implementations of various programming language paradigms, including but not limited to, object-oriented (e.g., Java, C±±, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the controller 455, such as microprocessor 473, to perform the functions of the controller 455. The instructions cause the microprocessor 473 or some other processor, such as an I/O controller/processor, to process and act on information received from the one or more sensors 453, the status indicator 457, and/or or other external devices 481 to provide the functionality and techniques described herein.

The embodiments or implementations described above may also use well-known or other synchronous or asynchronous client-server computing techniques. However, the various components may be implemented using more monolithic programming techniques as well, for example, as an executable running on a single microprocessor, or alternatively decomposed using a variety of structuring techniques known in the art, including but not limited to, multiprogramming, multithreading, client-server, or peer-to-peer (e.g., Bluetooth®, NFC or RFID wireless technology, mesh networks, etc.), running on one or more computer systems each having one or more central processing units (CPUs) or other processors. Some embodiments may execute concurrently and asynchronously, and communicate using message passing techniques.

In addition, programming interfaces to the data stored on and functionality provided by the controller 455, can be available by standard mechanisms such as through C, C±±, C#, and Java APIs; libraries for accessing files, databases, or other data repositories; scripting languages; or Web servers, FTP servers, or other types of servers providing access to stored data. The data stored and utilized by the controller 455 and overall battery packs may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules within the battery pack 410 in different ways, yet still achieve the functions of the controller 455.

Furthermore, in some embodiments or implementations, some or all of the components of the controller 455 may be implemented or provided in other manners, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

In some embodiments, the non-transitory storage mediums 475 store instructions that are executed by the at least one processor 473 during operation of the battery pack 410 to provide the at least one warning indication with the status indicator 457 in response to the rate of change in pressure (DP/DT) in the battery pack enclosure exceeding a threshold rate for at least a threshold duration. The threshold rate may be at least 50 Pascals per second, or between and including 50 Pascals per second and 150 Pascals per second. The threshold duration may be at least 3 seconds, or between and including 3 seconds and 5 seconds.

In embodiments where the one or more sensors 453 are a pressure sensor 453, the non-transitory storage mediums 475 may also store instructions associated with smoothing, filtering, or otherwise interpreting the data from the pressure sensor 453 to filter out fluctuations in pressure associated with vibration and/or temperature during normal operating conditions. In some embodiments, the non-transitory storage mediums 475 store instructions that are executed by the at least one processor 473 during operation of the battery pack 410 to not provide the at least one warning indication with the status indicator 457 in response to the rate of change in pressure in the battery enclosure 460 less than the threshold rate, or greater than the threshold rate, but for less than the threshold duration. The non-transitory storage mediums 475 may also store instructions that are executed by the at least one processor 473 during operation of the battery pack 410 to not provide the at least one warning indication with the status indicator 457 in response to variations in pressure over time associated with vibration or operational temperature of the multi-layer battery stack, or both, such as by using filtering or smoothing techniques. As a result, the pressure sensor may be operable to distinguish between changes in pressure in the battery cell enclosure 460 associated with vibration, temperature of the multi-layer battery stack 414, or both, and changes in pressure associated with the vented matter from the vent valve of the at least one of the battery cells as shown at least in FIG. 51.

In some embodiments where the one or more sensors 453 are a gas sensor 453, the non-transitory storage mediums 475 store instructions that are executed by the at least one processor 473 during operation of the battery pack 410 to detect, with the gas sensor 453, the gas concentration of the air gap 451 and provide the at least one warning indication with the status indicator 457 in response to changes in gas concentration in the battery pack enclosure exceeding a threshold concentration. As above, the threshold concentration may be at least 50 ppm of a single gas, or a total concentration from multiple selected gases. The non-transitory storage mediums 475 may also store further instructions that are executed by the at least one processor 473 during operation of the battery pack 410 to not provide the at least one warning indication with the status indicator 457 in response to the change in gas concentration in the battery enclosure 460 being less than the threshold concentration above.

The present disclosure also contemplates methods associated with the above aspects and techniques described with reference to FIGS. 50 through 53. For example, one or more embodiments of a method may include detecting a change in at least one characteristic over time in the space 451 between the battery pack enclosure 460 and the multi-layer battery stack 414 in the battery pack enclosure 460 with at least one sensor 453. The at least one characteristic over time may be indicative of vented matter from the vent valve 450 of at least one battery cell in the multi-layer battery stack 414 during a thermal runaway event. The method further includes providing at least one warning indication with the status indicator 457 in response to the detected change in the at least one characteristic of the space 451 over time via the at least one sensor 453. The method may include additional features of the type described herein, including but not limited to those in the appended claims.

In view of the above, the battery packs of the present disclosure may include venting detection and/or warning functionality for detecting whether a thermal runaway event has occurred and providing a suitable warning indication to a driver and/or occupant of a vehicle including the battery pack. Such a warning indication may provide time for the driver and/or occupant to safely exit the vehicle to mitigate the risk of harm to the driver and/or occupant in the event of battery damage following the thermal runaway event.

### Additional Aspects

In a first aspect, a battery pack is provided comprising a plurality of battery module layers stacked in a vertical direction to form a multi-layer battery stack, each battery module layer including a plurality of battery cells arranged in a linear array and a thermal management device; and a battery pack frame including a plurality of frame members, wherein each battery module layer is secured to a respective frame member, and wherein the frame members are arranged to apply a compressive load on the battery module layers to assist in maintaining the battery module layers of the multi-layer battery stack in thermal contact with each other.

In a second aspect, the battery pack of aspect 1, wherein each frame member is provided in the form of a structural support frame at a periphery of the battery pack.

In a third aspect, the battery pack of aspect 2, wherein, for each battery module layer, the thermal management device is secured directly to a respective one of the structural support frames and supports the linear array of battery cells thereon.

In a fourth aspect, the battery pack of aspect 3, wherein each battery module layer further includes one or more anchors to assist in securing the linear array of battery cells to the thermal management device of the battery module layer.

In a fifth aspect, the battery pack of aspect 4, wherein each anchor is provided in the form of an elongated bar or plate positioned at a lower end of the battery cells and extending along a longitudinal direction of the battery pack.

In a sixth aspect, the battery pack of aspect 1, wherein, for each battery module layer, the battery cells are compressed together in sub-modules to maintain contact between the battery cells or intervening structures of each sub-module.

In a seventh aspect, the battery pack of aspect 1, wherein, for each battery module layer, all of the battery cells of the battery module layer are compressed together.

In an eighth aspect, the battery pack of aspect 7, wherein for each battery module layer, all of the battery cells of the battery module layer are compressed together with the aid of a compression band encircling the linear array of battery cells or compression brackets or plates secured to the battery cells.

In a ninth aspect, the battery pack of aspect 7, wherein for each battery module layer, all of the battery cells of the battery module layer are compressed together with the aid of opposing compression plates that are coupled together with adjustable tie rods to selectively adjust a compression force on the battery cells.

In a tenth aspect, the battery pack of aspect 1, wherein, for each battery module layer, discrete subsets of the battery cells of the battery module layer are compressed together in sub-modules.

In an 11th aspect, the battery pack of aspect 10, wherein, for each battery module layer, the discrete subsets of the battery cells of the battery module layer are compressed together in sub-modules with the aid of a compression band encircling the discrete subsets of the battery cells or compression brackets secured to the discrete subsets of the battery cells.

In a 12th aspect, the battery pack of aspect 10, wherein the sub-modules are fixedly secured to each other to form the linear array.

In a 13th aspect, the battery pack of aspect 1, wherein the battery cells of one of the battery module layers are in direct thermal engagement with the thermal management device of an adjacent battery module layer such that all of the battery cells of the battery module layer are positioned between two thermal management devices to facilitate heat transfer on plural sides of the battery cells.

In a 14th aspect, the battery pack of aspect 1, wherein all battery cells of the battery pack are positioned between two thermal management devices to facilitate heat transfer on plural sides of the battery cells.

In a 15th aspect, the battery pack of aspect 1, wherein the linear array of battery cells of each battery module layer are held in compression between two thermal management devices of the multi-layer battery stack.

In a 16th aspect, the battery pack of aspect 1, wherein the thermal management device is an active heat exchanger having at least one liquid heat exchange medium passageway for circulating a liquid heat exchange medium for cooling or heating purposes.

In a 17th aspect, the battery pack of aspect 16, wherein the active heat exchanger is a battery cold plate that is configured to provide cooling or heating of the battery cells in operation.

In a 18th aspect, the battery pack of aspect 1, wherein the thermal management device of each battery module layer is a battery cold plate that comprises a generally planar manifold and includes at least one heat transfer medium passageway to facilitate the circulation of a heat transfer medium through the manifold during operation to assist in drawing heat away from the battery cells to cool the battery cells or, alternatively, supplying heat to the battery cells to heat the battery cells.

In a 19th aspect, the battery pack of aspect 18, wherein, for each battery module layer, each battery cell includes a vent and one or more electrode terminals provided on an end face of the battery cell that is oriented normal to a major surface of the battery cold plate.

In a 20th aspect, the battery pack of aspect 18, wherein, for each battery module layer, each battery cell includes a vent and one or more electrode terminals provided on an upper face of the battery cell that is oriented parallel to a major surface of the battery cold plate.

In a 21st aspect, the battery pack of aspect 18, wherein a major surface of each battery cold plate is perpendicular to a plane of the electrodes in the battery cells.

In a 22nd aspect, the battery pack of aspect 18, wherein a major surface of each battery cold plate is parallel to a plane of the electrodes in the battery cells.

In a 23rd aspect, the battery pack of aspect 18, further comprising a battery enclosure that accommodates the multi-layer battery stack, and wherein each battery cold plate extends laterally beyond the battery cells on each of opposing sides of the battery pack to present a stack of battery cold plates that terminate adjacent a side wall of the enclosure and assist in protecting the battery cells from potential damage arising from a side impact event to the battery enclosure.

In a 24th aspect, the battery pack of aspect 16, wherein each active heat exchanger includes a set of liquid heat exchange medium openings on a same end of the battery pack, which serve as an inlet and an outlet for the liquid heat exchange medium.

In a 25th aspect, the battery pack of aspect 24, wherein the outlet of one of the active heat exchangers is connected to the inlet of an adjacent one of the active heat exchangers to enable the liquid heat exchange medium to pass through each of the battery module layers in a continuous path.

In a 26th aspect, the battery pack of aspect 25, wherein the battery pack is configured such that the liquid heat exchange medium may flow in alternate directions along the continuous path to provide heating or cooling functionality to the multi-layer battery stack in reversible directions.

In a 27th aspect, the battery pack of aspect 24, wherein electronics of the battery pack are provided on an opposing end of the battery pack opposite of the end of the battery pack having the liquid heat exchange medium openings to separate the electronics from connections for the liquid heat exchange medium made at the liquid heat exchange medium openings.

In a 28th aspect, the battery pack of aspect 1, further comprising: a battery enclosure that accommodates the multi-layer battery stack and battery pack frame, and wherein each of the frame members of the battery pack frame is secured to the battery enclosure.

In a 29th aspect, the battery pack of aspect 28, wherein the battery enclosure includes a tray and a cover, each of the tray and the cover including a flat sealing surface to facilitate a watertight seal between the tray and the cover.

In a 30th aspect, the battery pack of aspect 1, wherein the plurality of frame members are arranged and spaced relative to each other in order to apply the compressive load in response to the battery module layers being secured to the respective frame member.

In a 31st aspect, the battery pack of aspect 1, wherein, for each battery module layer, the battery cells are arranged in a plurality of rows, with each row having a plurality of battery cells arranged in a linear array.

In a 32nd aspect, the battery pack of aspect 1, wherein each battery cell is provided in a form factor having a generally rectangular prismatic shape.

In a 33rd aspect, the battery pack of aspect 1, wherein each battery cell has an aspect ratio of cell length to cell height of between 3:1 to 6:1.

In a 34th aspect, the battery pack of aspect 1, wherein each battery cell has an aspect ratio of cell length to cell width of between 1:1 to 2:1.

In a 35th aspect, the battery pack of aspect 1, wherein each battery cell is provided in a form factor having a generally rectangular prismatic shape with a cell length of 520±50 mm, a cell height of 125±10 mm, a cell thickness of 20±5 mm.

In a 36th aspect, the battery pack of aspect 1, wherein each battery cell is provided in a form factor having a generally rectangular prismatic shape with a cell length of 175±50 mm, a cell height of 150±20 mm, a cell thickness of 45±5 mm.

In a 37th aspect, the battery pack of aspect 1, further comprising, for each battery module layer, one or more vented material collectors positioned to collect and route vented material discharged from one or more of the battery cells during a venting event away from the multi-layer battery stack.

In a 38^{th} aspect, a battery pack system for commercial vehicles having different vehicle attributes is provided, the battery pack system comprising: a plurality of common battery packs arrangeable in commercial vehicles in a plurality of different configurations to optimize vehicle power and vehicle range, wherein each of the common battery packs includes a plurality of battery module layers stacked to form a multi-layer battery stack, with each battery module layer including a plurality of battery cells arranged in an array and connected in series with each other and the battery cells of each other battery module layer to provide a battery pack voltage in a range of between 600V and 1200V that is common to each of the common battery packs, and wherein each of the common battery packs is connectable in parallel with each other to increase vehicle power and vehicle range of a host commercial vehicle.

In a 39th aspect, the battery pack system of aspect 38, wherein a number of the common battery packs in the plurality of different configurations ranges from between 2 and 10.

In a 40th aspect, the battery pack system of aspect 38, wherein the plurality of different configurations includes at least one configuration in which a number of the common battery packs is different than a number of the common battery packs in another one of the configurations.

In a 41st aspect, the battery pack system of aspect 38, wherein each common battery pack includes a same number of battery module layers that is two, three, four or five battery module layers.

In a 42nd aspect, the battery pack system of aspect 38, wherein, for each common battery pack, each battery module layer further includes a thermal management device associated with and in thermal engagement with the array of battery cells of the battery module layer.

In a 43rd aspect, the battery pack system of aspect 42, wherein the thermal management device is an active heat exchanger having a liquid heat exchange medium passageway for circulating a liquid heat exchange medium for cooling or heating purposes.

In a 44th aspect, the battery pack system of aspect 43, wherein the active heat exchanger is a battery cold plate that is configured to provide cooling or heating of the battery cells in operation.

In a 45th aspect, the battery pack system of aspect 38, further comprising: a thermal management system that is centralized or distributed, or a hybrid thereof.

In a 46th aspect, the battery pack system of aspect 45, wherein the thermal management system includes a centralized chiller for all of the common battery packs for distributing a heat transfer medium to the common battery packs for cooling purposes.

In a 47th aspect, the battery pack system of aspect 45, wherein the thermal management system includes a plurality of chillers associated with the common battery packs for distributing a heat transfer medium to the common battery packs for cooling purposes.

In a 48th aspect, the battery pack system of aspect 45, wherein the thermal management system includes a respective chiller associated with each of the common battery packs for routing a heat transfer medium to the common battery pack for cooling purposes.

In a 49th aspect, the battery pack system of aspect 45, wherein the thermal management system includes a centralized heater for all of the common battery packs for distributing a heat transfer medium to the common battery packs for heating purposes.

In a 50th aspect, the battery pack system of aspect 45, wherein the thermal management system includes a plurality of heaters associated with the common battery packs for distributing a heat transfer medium to the common battery packs for heating purposes.

In a 51st aspect, the battery pack system of aspect 45, wherein the thermal management system includes a respective heater associated with each of the common battery packs for routing a heat transfer medium to the common battery pack for heating purposes.

In a 52nd aspect, the battery pack system of aspect 45, wherein the thermal management system includes a centralized chiller for all of the common battery packs for distributing a heat transfer medium to the common battery packs for cooling purposes, and further includes a respective heater associated with each of the common battery packs for routing a heat transfer medium to the common battery pack for heating purposes.

In a 53rd aspect, the battery pack system of aspect 38, further comprising: a centralized battery management system (BMS) for providing centralized monitoring and control functionality for the common battery packs; or a master-slave battery management system (BMS) for providing distributed monitoring and control functionality for the common battery packs.

In a 54th aspect, the battery pack system of aspect 38, further comprising: a centralized charging system comprising a single charger for charging the common battery packs; or a distributed charging system comprising a plurality of chargers for charging the common battery packs.

In a 55th aspect, the battery pack system of aspect 38, wherein the common battery packs have an identical form factor to enable each of the common battery packs to be exchanged with the others to facilitate periodic rearranging of the common battery packs on the host vehicle.

In a 56th aspect, the battery pack system of aspect 38, wherein the common battery packs have an identical form factor to enable any one of the common battery packs to be replaced with a new battery pack of the same form factor.

In a 57th aspect, the battery pack system of aspect 42, wherein each common battery pack further includes a battery pack frame including a plurality of frame members, wherein each battery module layer is secured to a respective frame member, and wherein the frame members are arranged to apply a compressive load on the battery module layers to assist in maintaining the battery module layers of the multi-layer battery stack in thermal contact with each other.

In a 58th aspect, the battery pack system of aspect 57, wherein each frame member is provided in the form of a structural support frame at a periphery of the common battery pack.

In a 59th aspect, the battery pack system of aspect 58, wherein, for each battery module layer, the thermal management device is secured directly to a respective one of the structural support frames and supports the array of battery cells thereon.

In a 60th aspect, the battery pack system of aspect 42, wherein each battery module layer further includes one or more anchors to assist in securing the array of battery cells to the thermal management device of the battery module layer.

In a 61st aspect, the battery pack system of aspect 42, wherein the battery cells of one of the battery module layers are in direct thermal engagement with the thermal management device of an adjacent battery module layer such that all of the battery cells of the battery module layer are positioned between two thermal management devices to facilitate heat transfer on plural sides of the battery cells.

In a 62nd aspect, the battery pack system of aspect 42, wherein all battery cells of each common battery pack are positioned between two thermal management devices to facilitate heat transfer on plural sides of the battery cells.

In a 63rd aspect, the battery pack system of aspect 42, wherein the array of battery cells of each battery module layer are held in compression between two thermal management devices of the multi-layer battery stack.

In a 64th aspect, the battery pack system of aspect 42, wherein the thermal management device of each battery module layer is a cold plate that comprises a generally planar manifold and includes at least one heat transfer medium passageway to facilitate the circulation of a heat transfer medium through the manifold during operation to assist in drawing heat away from the battery cells to cool the battery cells or, alternatively, supplying heat to the battery cells to heat the battery cells.

In a 65th aspect, the battery pack system of aspect 64, wherein, for each battery module layer, each battery cell includes a vent and one or more electrode terminals provided on an end face of the battery cell that is oriented normal to a major surface of the cold plate.

In a 66th aspect, the battery pack system of aspect 64, wherein a major surface of each cold plate is perpendicular to a plane of the electrodes in the battery cells.

In a 67th aspect, the battery pack system of aspect 64, wherein, for each battery module layer, each battery cell includes a vent and one or more electrode terminals provided on an upper face of the battery cell that is oriented parallel to a major surface of the cold plate.

In a 68th aspect, the battery pack system of aspect 64, wherein a major surface of each cold plate is parallel to a plane of the electrodes in the battery cells.

In a 69th aspect, the battery pack system of aspect 57, further comprising: for each common battery pack, a battery enclosure that accommodates the multi-layer battery stack and battery pack frame, and wherein each of the frame members of the battery pack frame is secured to the battery enclosure.

In a 70th aspect, the battery pack system of aspect 38, wherein, for each battery module layer, the battery cells are compressed together in sub-modules to maintain contact between the battery cells or intervening structures of each sub-module.

In a 71st aspect, the battery pack system of aspect 38, wherein, for each battery module layer, all of the battery cells of the battery module layer are compressed together.

In a 72nd aspect, the battery pack system of aspect 38, wherein, for each battery module layer, discrete subsets of the battery cells of the battery module layer are compressed together in sub-modules.

In a 73rd aspect, the battery pack system of aspect 38, wherein each common battery pack is provided in a form factor having a generally rectangular shape with a pack length of 1100±150 mm, a pack height of 600±100 mm, and a pack width of 600=100 mm.

In a 74th aspect, the battery pack system of aspect 38, wherein at least one of the battery packs is provided in a T-shape, L-shape, boot-shape or stairstep-shape configuration.

In a 75th aspect, the battery pack system of aspect 74, wherein the at least one battery pack provided in the T-shape, L-shape, boot-shape or stairstep-shape configuration comprises an enclosure with one or more rail channels for assisting in nesting the battery pack with a rail or rails of a host vehicle.

In a 76th aspect, the battery pack system of aspect 38, wherein at least one of the battery packs is provided in a L-shape, boot-shape or stairstep-shape configuration with an overall pack length of 1100±150 mm, an overall pack height of 600±100 mm, an overall pack width of 600±100 mm, a lower step height of 425±75 mm, and an upper landing length of 600±100 mm.

In a 77th aspect, the battery pack system of aspect 38, wherein at least one of the battery packs is provided in a T-shape configuration with an overall pack length of 1250±150 mm, an overall pack height of 600±100 mm, an overall pack width of 2200±100 mm, a stem width of 600±100 mm, and a stem height of 200±75 mm.

In a 78th aspect, the battery pack system of aspect 38, wherein each battery cell is provided in a form factor having a generally rectangular prismatic shape with an aspect ratio of cell length to cell height of between 3:1 to 6:1.

In a 79th aspect, the battery pack system of aspect 38, wherein each battery cell is provided in a form factor having a generally rectangular prismatic shape with an aspect ratio of cell length to cell height of between 1:1 to 2:1.

In an 80th aspect, the battery pack system of aspect 38, wherein each battery cell is provided in a form factor having a generally rectangular prismatic shape with a cell length of 520±50 mm, a cell height of 125±10 mm, a cell thickness of 20±5 mm.

In an 81st aspect, the battery pack system of aspect 38, wherein each battery cell is provided in a form factor having a generally rectangular prismatic shape with a cell length of 175±50 mm, a cell height of 150±20 mm, a cell thickness of 45±5 mm.

In an 82nd aspect, a commercial vehicle is provided including a battery pack system according to any one of aspects 38-81.

In an 83rd aspect, a commercial vehicle comprising a chassis and a battery pack system according to any one of aspects 38-81 is provided, wherein the common battery packs are positionable along the chassis to optimize a weight distribution of the commercial vehicle.

In an 84th aspect, a commercial vehicle is provided comprising a chassis with chassis rails and a battery pack system according to any one of aspects 38-81, wherein the common battery packs are under the chassis rails or along the side of the chassis rails.

In an 85th aspect, a collection of commercial vehicles is provided, each commercial vehicle including a battery pack system according to any one of aspects 38-81, and including a common drivetrain system regardless of a number of the common battery packs that are connected in parallel for each commercial vehicle.

In an 86th aspect, a battery pack is provided, comprising: a plurality of battery cells arranged in an array to form a battery module layer; a lower thermal management device underlying and in thermal contact with the plurality of battery cells of the battery module layer; an upper thermal management device overlying and in thermal contact with the plurality of battery cells of the battery module layer; and a connecting manifold that extends between the lower thermal management device and the upper thermal management device and has at least one heat transfer medium passage arranged to provide fluid communication between the lower thermal management device and the upper thermal management device in order to facilitate distribution of a heat transfer medium through each of the lower thermal management device and the upper thermal management device during operation to provide heating or cooling functionality for the plurality of battery cells of the battery module layer.

In an 87th aspect, the battery pack of aspect 86, wherein each of the lower and upper thermal management device comprises an active heat exchanger having a generally planar manifold that includes at least one heat transfer medium passageway to facilitate the circulation of the heat transfer medium through the planar manifold during operation to assist in drawing heat away from the battery cells to cool the battery cells or, alternatively, supplying heat to the battery cells to heat the battery cells.

In an 88th aspect, the battery pack of aspect 87, wherein each active heat exchanger is a battery cold plate that is configured to provide cooling or heating of the battery cells in operation.

In an 89th aspect, the battery pack of aspect 88, wherein the connecting manifold is positioned at an end of the battery pack and extends vertically between the battery cold plates of the lower and upper thermal management devices.

In a 90th aspect, the battery pack of aspect 86, wherein the connecting manifold is configured to assist in securing the plurality of battery cells in place within the battery pack between the lower and upper thermal management devices.

In a 91st aspect, the battery pack of aspect 86, wherein the connecting manifold has a plurality of heat transfer medium passages for providing fluid communication between the lower thermal management device and the upper thermal management device, and wherein an end of at least one of the heat transfer medium passages is blocked to assist in routing the heat transfer medium through the battery pack in a desired path.

In a 92nd aspect, the battery pack of aspect 86, wherein the connecting manifold is configured to route the heat transfer medium through the lower and upper thermal management devices in series.

In a 93rd aspect, the battery pack of aspect 86, wherein the connecting manifold is configured to route the heat transfer medium through the lower and upper thermal management devices in parallel.

In a 94th aspect, the battery pack of aspect 86, wherein the battery pack includes a plurality of battery module layers stacked together, and wherein a respective connecting manifold is provided for each battery module layer.

In a 95th aspect, the battery pack of aspect 86, wherein the connecting manifold serves as one of opposing hold down members that assist in fixedly securing the battery cells within the battery pack between said hold down members.

In a 96th aspect, the battery pack of aspect 86, wherein the connecting manifold serves as a structural support between the lower and upper thermal management devices.

In a 97th aspect, the battery pack of aspect 86, wherein the connecting manifold includes at least two distinct heat transfer medium passages that are spaced apart from each other to be in fluid communication with different regions of the lower and upper thermal management devices.

In a 98th aspect, a battery pack is provided, comprising: a plurality of battery cells arranged in an array to form a battery module layer; and a thermal management device underlying and in direct thermal contact with the plurality of battery cells of the battery module layer, wherein discrete subsets of the plurality of battery cells of the battery module layer are held together in sub-modules with each sub-module being fixedly secured to the thermal management device and/or an adjacent sub-module.

In a 99th aspect, the battery pack of aspect 98, wherein the discrete subsets of the plurality of battery cells of the battery module layer are held together in the sub-modules via one or more straps, brackets or clamp arrangements.

In a 100th aspect, the battery pack of aspect 99, wherein the battery cells of each sub-module are held together by a pair of the straps, brackets or clamp arrangements provided on opposing ends of each sub-module.

In a 101st aspect, the battery pack of aspect 100, wherein the straps, brackets or clamp arrangements are connectable together in at least a longitudinal direction that is aligned with a direction in which the battery cells of the module layer extend in the array.

In a 102nd aspect, the battery pack of aspect 101, wherein the straps, brackets or clamp arrangements are further connectable together in a vertical direction that is normal to the direction in which the battery cells of the module layer extend in the array.

In a 103rd aspect, the battery pack of aspect 102, wherein the battery module layer is a first battery module layer, and wherein the battery pack further comprises: a further plurality of battery cells arranged in an array to form a second battery module layer that is positioned above the first battery module layer; and a further thermal management device overlying and in direct thermal contact with the battery cells of the first battery module layer and underlying and in direct thermal contact with the battery cells of the second battery module layer.

In a 104th aspect, the battery pack of aspect 103, further comprising: a plurality of structural supports extending between the thermal management device and the further thermal management device to support the further thermal management device in position above the thermal management device and assist in eliminating or reducing appreciable deflection of the further thermal management device.

In a 105th aspect, the battery pack of aspect 103, wherein the straps, brackets or clamp arrangements are connectable together in the vertical direction via the intermediary of the further thermal management device.

In a 106th aspect, the battery pack of aspect 99, wherein the straps, brackets or clamp arrangements are connectable together via fasteners or integrated interlock features.

In a 107th aspect, the battery pack of aspect 99, wherein the straps, brackets or clamp arrangements hold the battery cells of each sub-module together in a rigid manner to enable each sub-module to be independently manipulated in space during assembly of the sub-modules.

In a 108th aspect, the battery pack of aspect 99, wherein the straps, brackets or clamp arrangements hold the battery cells of each sub-module together in compression.

In a 109th aspect, the battery pack of aspect 99, wherein the straps, brackets or clamp arrangements fix each sub-module to the thermal management device in a manner that urges the battery cells into contact with the thermal management device or an intervening thermally conductive material.

In a 110th aspect, the battery pack of aspect 99, wherein the straps, brackets or clamp arrangements extend beyond end faces of the battery cells and include clearance on at least one side of the battery module layer for an elongated bus bar to span across the end faces of the battery cells on the at least one side of the battery module layer.

In a 111th aspect, the battery pack of aspect 98, wherein each sub-module comprises one or more end plates that provide thermal insulation between the sub-module and one or more adjacent sub-modules.

In a 112th aspect, the battery pack of aspect 98, wherein fire retardant material is provided between adjacent sub-modules.

In a 113th aspect, the battery pack of aspect 98, wherein each sub-module comprises thermal resistant material between each of at least some of the battery cells of the sub-module to prevent or delay the propagation of thermal runaway.

In a 114th aspect, the battery pack of aspect 98, wherein each sub-module comprises fire retardant material between each of at least some of the battery cells of the sub-module.

In a 115th aspect, the battery pack of aspect 98, further comprising: a battery pack frame to which the battery module layer is fixed; and a battery back enclosure that surrounds the battery pack frame.

In a 116th aspect, the battery pack of aspect 98, further comprising a further thermal management device overlying the battery module layer, and wherein the battery cells of the battery module layer are also in direct thermal engagement with the further thermal management device to facilitate heat transfer on both of opposing sides of the battery cells.

In a 117th aspect, the battery pack of aspect 98, wherein the thermal management device of the battery module layer comprises an active heat exchanger having a generally planar manifold that includes a heat transfer medium passageway to facilitate the circulation of a heat transfer medium through the manifold during operation to assist in drawing heat away from the battery cells to cool the battery cells or, alternatively, supplying heat to the battery cells to heat the battery cells.

In a 118th aspect, the battery pack of aspect 98, wherein the active heat exchanger of the battery module layer is a battery cold plate that is configured to provide cooling or heating of the battery cells in operation.

In a 119th aspect, the battery pack of aspect 98, wherein each of the discrete subsets of the plurality of battery cells of each sub module includes a same number of battery cells between two and ten battery cells.

In a 120th aspect, the battery pack of aspect 98, wherein the discrete subsets of the plurality of battery cells of the battery module layer are held together in the sub-modules with one or more fasteners that are aligned with, or recessed with respect to, an outer peripheral edge of the thermal management device.

In a 121st aspect, the battery pack of aspect 98, wherein the battery module layer is a first battery module layer, and wherein the battery pack further comprises: a second battery module layer including a further plurality of battery cells arranged in an array, the second battery module layer removably connectable to the first battery module layer in a vertically stacking arrangement.

In a 122nd aspect, the battery pack of aspect 121, wherein the second battery module layer is removably connectable to the first battery module layer in the vertical stacking arrangement with the thermal management device between, and in direct contact with, the first battery module layer and the second battery module layer.

In a 123rd aspect, the battery pack of aspect 121, wherein the second battery module layer is removably connectable to the first module layer in the vertical stacking arrangement with a further thermal management device between, and in direct contact with, the first battery module layer and the second battery module layer, and such that the first battery module layer is provided between opposing thermal management devices.

In a 124th aspect, the battery pack of aspect 121, wherein the second battery module layer is connectable to the first battery module layer on either of opposing sides of the first module layer.

In a 125th aspect, the battery pack of aspect 98, wherein each battery cell of each sub module extends substantially an entire length of the sub module.

In a 126th aspect, the battery pack of aspect 98, wherein at least two battery cells among the battery cells of each sub module are aligned end-to-end to extend substantially an entire length of the sub module.

In a 127th aspect, the battery pack of aspect 98, wherein at least one supplemental strap, bracket or clamp arrangement is proved between opposing ends of the sub module at an interface between adjacent battery cells that are aligned end-to-end.

In a 128th aspect, the battery pack of aspect 98, wherein each battery cell is provided in a form factor having a generally rectangular prismatic shape with an aspect ratio of cell length to cell height of between 3:1 to 6:1.

In a 129th aspect, the battery pack of aspect 98, wherein each battery cell is provided in a form factor having a generally rectangular prismatic shape with an aspect ratio of cell length to cell height of between 1:1 to 2:1.

In a 130th aspect, the battery pack of aspect 98, wherein each battery cell is provided in a form factor having a generally rectangular prismatic shape with a cell length of 520±50 mm, a cell height of 125±10 mm, a cell thickness of 20±5 mm.

In a 131st aspect, the battery pack of aspect 98, wherein each battery cell is provided in a form factor having a generally rectangular prismatic shape with a cell length of 175±50 mm, a cell height of 150±20 mm, a cell thickness of 45±5 mm.

In a 132nd aspect, a battery pack is provided, comprising: a first battery module including a plurality of battery cells coupled together in an array; a second battery module including a plurality of battery cells coupled together in an array; and a thermal management device underlying and in direct thermal contact with the plurality of battery cells of the first battery module, the second battery module connectable to the first battery module via one or more fasteners associated with each of the first battery module and the second battery module.

In a 133rd aspect, the battery pack of aspect 132, wherein the second battery module is connectable to the first battery module in a side-by-side arrangement with both the first and second battery modules fixed to the thermal management device to form a battery module layer.

In a 134th aspect, the battery pack of aspect 132, wherein the second battery module is connectable to the first battery module in a vertical stacking arrangement with the thermal management device between, and in direct contact with, the plurality of battery cells of the first battery module and the plurality of further battery cells of the second battery module.

In a 135th aspect, the battery pack of aspect 132, wherein the second battery module is connectable to the first battery module in a vertical stacking arrangement with a further thermal management device between, and in direct contact with, the plurality of battery cells of the first battery module and the plurality of further battery cells of the second battery module.

In a 136th aspect, a battery pack is provided, comprising: a plurality of battery cells arranged in an array to form a battery module layer; a lower thermal management device underlying and in direct thermal contact with the plurality of battery cells of the battery module layer; an upper thermal management device overlying and in direct thermal contact with the plurality of battery cells of the battery module layer; and a plurality of structural supports extending between the lower thermal management device and the upper thermal management device to support the upper thermal management device in position above the lower thermal management device.

In a 137th aspect, the battery back of aspect 136, wherein the plurality of structural supports are configured to support the upper thermal management device in position above the lower thermal management device to assist in eliminating or reducing appreciable deflection of the upper thermal management device.

In a 138th aspect, the battery back of aspect 136, wherein the plurality of structural supports are removably attached to the lower and upper thermal management device.

In a 139th aspect, the battery back of aspect 136, wherein each of the plurality of structural supports comprises an elongate form factor that extends an entirety or substantially an entirety of a longitudinal length of the battery cells, or a longitudinal length of a plurality of the battery cells aligned end-to-end across the battery pack.

In a 140th aspect, the battery back of aspect 136, wherein the plurality of structural supports comprise at least two structural supports that are spaced apart along a longitudinal length of the battery module layer with at least some of the battery cells positioned therebetween.

In a 141st aspect, the battery back of aspect 136, wherein the plurality of structural supports comprise at least three structural supports that are spaced apart along a longitudinal length of the battery module layer in equidistant intervals with at least some of the battery cells positioned between adjacent structural supports.

In a 142nd aspect, the battery back of aspect 136, wherein discrete subsets of the plurality of battery cells of the battery module layer are held together in sub-modules with each sub-module being fixedly secured to at least one of the lower and upper thermal management devices and/or an adjacent sub-module.

In a 143rd aspect, the battery back of aspect 142, wherein each of the plurality of structural supports is positioned next to one of the sub-modules.

In a 144th aspect, the battery back of aspect 142, wherein the discrete subsets of the plurality of battery cells of the battery module layer are held together in the sub-modules via one or more straps, brackets or clamp arrangements, and wherein each of the plurality of structural supports interfaces with the one or more straps, brackets or clamp arrangements.

In a 145th aspect, the battery back of aspect 136, wherein the battery module layer is a first battery module layer, and wherein the battery pack further comprises: a further plurality of battery cells arranged in an array to form a second battery module layer that is positioned above the first battery module layer, the second battery module layer being supported by and in direct thermal contact with the upper thermal management device; a further thermal management device overlying the second battery module layer; and a further plurality of structural supports extending between the upper thermal management device and the further thermal management device to support the further thermal management device in position above the upper thermal management device.

In a 146th aspect, the battery back of aspect 136, wherein at least one of the structural supports provides thermal insulation between some of the plurality of battery cells in the battery module layer and others of the plurality of battery cells in the battery module layer.

In a 147th aspect, the battery back of aspect 136, wherein at least one of the structural supports is covered at least in part with a thermal insulation material.

In a 148th aspect, the battery back of aspect 136, wherein at least one of the structural supports is covered at least in part with a fire retardant material.

In a 149th aspect, the battery back of aspect 136, wherein each of the lower and upper thermal management devices comprises an active heat exchanger having a generally planar manifold that includes a heat transfer medium passageway to facilitate the circulation of a heat transfer medium through the manifold during operation to assist in drawing heat away from the battery cells to cool the battery cells or, alternatively, supplying heat to the battery cells to heat the battery cells.

In a 150th aspect, the battery back of aspect 136, wherein each active heat exchanger is a battery cold plate that is configured to provide cooling or heating of the battery cells in operation.

In a 151st aspect, the battery back of aspect 136, further comprising: a battery pack frame to which the battery module layer is fixed; and a battery back enclosure that surrounds the battery pack frame.

In a 152nd aspect, the battery back of aspect 136, wherein each of the lower thermal management device and the upper thermal management device comprises a generally planar manifold and includes a heat transfer medium passageway to facilitate the circulation of a heat transfer medium through the manifold during operation to assist in drawing heat away from the battery cells to cool the battery cells or, alternatively, supplying heat to the battery cells to heat the battery cells.

In a 153rd aspect, the battery back of aspect 136, wherein each of the plurality of structural supports comprises an elongate form factor that covers an entirety or substantially an entirety of a side surface of the battery cells, or a side surface of a plurality of the battery cells aligned end-to-end across the battery pack.

In a 154th aspect, the battery back of aspect 136, wherein the plurality of structural supports comprise at least two structural supports that are positioned on opposite sides of the battery module layer.

In a 155th aspect, the battery back of aspect 136, wherein discrete subsets of the plurality of battery cells of the battery module layer are held together in sub-modules via one or more straps, brackets or clamp arrangements, and wherein the plurality of structural supports cover at least a portion of the one or more straps, brackets, or clamp arrangements.

In a 157th aspect, the battery back of aspect 136, wherein a longitudinal length of the plurality of structural supports is greater than a longitudinal length of the plurality of battery cells, or a longitudinal length of a plurality of the battery cells aligned end-to-end across the battery pack.

In a 158th aspect, the battery back of aspect 136, wherein the plurality of structural supports are in direct contact with the lower thermal management device and the upper thermal management device.

In a 159th aspect, the battery back of aspect 136, wherein the plurality of structural supports are provided at ends of the battery module layer to protect the battery cells therebetween.

In a 160th aspect, the battery back of aspect 136, wherein the upper and lower thermal management devices define respective thermal paths above and below the plurality of battery cells, respectively, and the plurality of structural supports define respective additional thermal paths on longitudinal sides of the plurality of battery cells.

In a 161st aspect, the battery back of aspect 136, wherein the battery module layer includes thermal paths corresponding to each of a plurality of major surfaces of the battery module layer.

In a 162nd aspect, the battery back of aspect 161, wherein minor surfaces on at least one transverse end of the battery module layer are exposed to an external environment to facilitate connections to the plurality of battery cells.

In a 163rd aspect, the battery back of aspect 136, wherein each battery cell is provided in a form factor having a generally rectangular prismatic shape with an aspect ratio of cell length to cell height of between 3:1 to 6:1.

In a 164th aspect, the battery back of aspect 136, wherein each battery cell is provided in a form factor having a generally rectangular prismatic shape with an aspect ratio of cell length to cell height of between 1:1 to 2:1.

In a 165th aspect, the battery back of aspect 136, wherein each battery cell is provided in a form factor having a generally rectangular prismatic shape with a cell length of 520±50 mm, a cell height of 125±10 mm, and a cell thickness of 20±5 mm.

In a 166th aspect, the battery back of aspect 136, wherein each battery cell is provided in a form factor having a generally rectangular prismatic shape with a cell length of 175 mm±50 mm, a cell height of 150±20 mm, and a cell thickness of 45±5 mm.

In a 167th aspect, a method of regulating temperature of a battery pack that includes a plurality of battery cells arranged in an array and at least one heat exchanger associated with the array of battery cells is provided, the method comprising: supplying a heat exchange medium to the at least one heat exchanger in a first flow direction through a heat exchange passageway of the at least one heat exchanger such that a first subset of the battery cells located proximate to a first end of the heat exchange passageway is exposed to the heat exchange medium prior to a second subset of the battery cells located proximate to a second end of the heat exchange passageway; and subsequently, supplying the heat exchange medium to the at least one heat exchanger in a second flow direction through the heat exchange passageway in an opposite direction of the first flow direction such that the second subset of the battery cells located proximate to the second end of the heat exchange passageway is exposed to the heat exchange medium prior to the first subset of the battery cells located proximate to the first end of the heat exchange passageway.

In a 168th aspect, the method of aspect 167, wherein the supplying of the heat exchange medium to the at least one heat exchanger in the first flow direction and the subsequent supplying of the heat exchange medium to the at least one heat exchanger in the second flow direction are periodically repeated to assist in balancing an average temperature to which each of the first subset of the battery cells and the second subset of the battery cells are exposed during operation.

In a 169th aspect, the method of aspect 167, wherein the supplying of the heat exchange medium to the at least one heat exchanger in the first flow direction and the subsequent supplying of the heat exchange medium to the at least one heat exchanger in the second flow direction is performed by a pump operating in a common direction and wherein a direction of flow through the heat exchange passageway is switchable by actuation of one or more control valves of a heat exchange medium supply system.

In a 170th aspect, the method of claim 167, wherein the supplying of the heat exchange medium to the at least one heat exchanger in the first flow direction and the subsequent supplying of the heat exchange medium to the at least one heat exchanger in the second flow direction is performed without changing a pump's operation and wherein a direction of flow through the heat exchange passageway is switchable by actuation of one or more control valves of a heat exchange medium supply system.

In a 171st aspect, the method of aspect 167, wherein the supplying of the heat exchange medium to the at least one heat exchanger in the first flow direction and the subsequent supplying of the heat exchange medium to the at least one heat exchanger in the second flow direction are each carried out alternately over an extended period of time.

In a 172nd aspect, the method of aspect 171, wherein the extended period of time exceeds 30 minutes, 1 hour, 2 hours, 3 hours, 4 hours, 5 hours, 6 hours, 8 hours, 10 hours, 12 hours, 24 hours, 36 hours or 48 hours, and/or is less than 1 hour, 2 hours, 3 hours, 4 hours, 5 hours, 6 hours, 8 hours, 10 hours, 12 hours, 24 hours, 36 hours or 48 hours.

In a 173rd aspect, the method of aspect 167, wherein two or more pumps supply the heat exchange medium in opposite directions and the pumps are operated alternately to supply the heat exchange medium to the at least one heat exchanger.

In a 174th aspect, the method of aspect 167, wherein the battery pack includes a plurality of battery module layers that are stacked in a vertical direction, each battery module layer including a respective plurality of battery cells arranged in a planar array and a respective heat exchanger, and wherein the heat exchange passageway extends through each of the heat exchangers of the battery module layers.

In a 175th aspect, the method of aspect 174, wherein the first subset of the battery cells is located in a lowermost one of the battery module layers, and the second subset of the battery cells is located in an uppermost one of the battery module layers, or wherein the first subset of the battery cells is located in an uppermost one of the battery module layers, and the second subset of the battery cells is located in a lowermost one of the battery module layers.

In a 176th aspect, the method of aspect 167, further comprising: monitoring a temperature profile of the battery pack; and switching from the supplying of the heat exchange medium to the at least one heat exchanger in the first flow direction to the supplying of the heat exchange medium to the at least one heat exchanger in the second flow direction based at least in part on said monitoring.

In a 177th aspect, the method of aspect 167, wherein the monitoring of the temperature profile of the battery pack includes measuring a temperature of the battery pack proximate to the battery cells at the first end of the heat exchange passageway and measuring a temperature of the battery pack proximate to the battery cells at the second end of the heat exchange passageway.

In a 178th aspect, the method of aspect 167, wherein the supplying of the heat exchange medium in a first flow direction and the supplying of the heat exchange medium in the second flow direction are performed alternately by a single bi-directional pump.

In a 179th aspect, a system is provided, comprising: a battery pack including a plurality of battery cells arranged in an array and at least one heat exchanger, and wherein a heat exchange passageway extends through the at least one heat exchanger; and a heat exchange media supply system including one or more heat exchange media supply conduits and one or more multi-way valves for reconfiguring the heat exchange media supply system between a first supply configuration, in which the heat exchange media supply system is configured to supply a heat exchange medium through the heat exchange media passageway of the battery pack in a first flow direction, and a second supply configuration, in which the heat exchange media supply system is configured to supply the heat exchange medium through the heat exchange media passageway of the battery pack in a second flow direction opposite the first flow direction.

In a 180th aspect, the system of aspect 179, wherein, during operation with the heat exchange media supply system in the first supply configuration, a first subset of the battery cells located proximate to a first end of the heat exchange media passageway is exposed to the heat exchange medium prior to a second subset of the battery cells located proximate to a second end of the heat exchange media passageway, and wherein, during operation with the heat exchange media supply system in the second supply configuration, the second subset of the battery cells located proximate to the second end of the heat exchange media passageway is exposed to the heat exchange medium prior to the first subset of the battery cells located proximate to the first end of the heat exchange media passageway.

In a 181st aspect, the system of aspect 179, further comprising: a controller operable to periodically actuate the one or more multi-way valves to reconfigure the heat exchange media supply system from the first supply configuration to the second supply configuration, and vice versa.

In a 182nd aspect, the system of aspect 179, further comprising: one or more temperature sensors associated with one or more battery cells of the battery pack for monitoring a temperature profile of the battery pack.

In a 183rd aspect, the system of aspect 179, further comprising: one or more temperature sensors associated with one or more battery cells of the battery pack for monitoring a temperature profile of the battery pack; and a controller in communication with the one or more temperature sensors and including a memory configured to store instructions and at least one processor configured to execute the instructions to: detect, via the one or more temperature sensors, whether a temperature of a first subset of the battery cells proximate a first end of the heat exchange media passageway exceeds a temperature of a second subset of the battery cells proximate a second end of the heat exchange media passageway by a threshold value over time; and periodically actuate the one or more multi-way valves to reconfigure the heat exchange media supply system from the first supply configuration to the second supply configuration, and vice versa, in response to the detecting.

In a 184th aspect, the system of aspect 179, wherein the one or more multi-way valves are manually actuatable to selectively reconfigure the heat exchange media supply system from the first supply configuration to the second supply configuration, and vice versa.

In a 185th aspect, the system of aspect 179, wherein the battery pack includes a plurality of battery module layers that are stacked in a vertical direction, each battery module layer including a respective plurality of battery cells arranged in a planar array and a respective heat exchanger and wherein the heat exchange media passageway extends through each of the respective heat exchanger of the battery module layers.

In a 186th aspect, the system of aspect 179, wherein the system includes a single four-way valve for reconfiguring the heat exchange media supply system between the first supply configuration and the second supply configuration.

In a 187th aspect, the system of aspect 179, wherein the system includes exactly two multi-way valves for collectively reconfiguring the heat exchange media supply system between the first supply configuration and the second supply configuration.

In an 188th aspect, a battery pack is provided, comprising: a plurality of battery module layers stacked together to form a multi-layer battery stack, each battery module layer including a plurality of battery cells arranged in an array; and a battery pack enclosure surrounding the multi-layer battery stack, the battery enclosure including one or more crumple zones configured to deform in response to an impact event to assist in protecting the multi-layer battery stack from damage.

In a 189th aspect, the battery pack of aspect 188, wherein the battery pack enclosure includes a respective crumple zone adjacent each of at least two major sides of the multi-layer battery stack.

In a 190th aspect, the battery pack of aspect 188, wherein the battery pack enclosure includes a respective crumple zone adjacent each of longitudinal sides of the multi-layer battery stack and each of top and bottom sides of the multi-layer battery stack.

In a 191st aspect, the battery pack of aspect 188, wherein each of the one or more crumple zones is formed by a shell structure with a plurality of internal structural partitions and a plurality of internal cavities defined at least in part by the shell structure and internal structural partitions.

In a 192nd aspect, the battery pack of aspect 188, wherein the battery pack enclosure includes one or more heat transfer medium passageways to facilitate the circulation of a heat transfer medium through at least a portion of the battery pack enclosure to assist in drawing heat away from the battery cells to cool the battery cells or, alternatively, supplying heat to the battery cells to heat the battery cells.

In a 193rd aspect, the battery pack of aspect 188, wherein the multi-layer battery stack further includes one or more thermal management devices in thermal contact with at least some of the battery cells and having one or more heat transfer medium passageways, and wherein the one or more heat transfer medium passageways of the battery pack enclosure are in fluid communication with the one or more heat transfer medium passageways of the one or more thermal management devices of the multi-layer battery stack.

In a 194th aspect, the battery pack of aspect 193, wherein each of the one or more thermal management devices of the multi-layer battery stack is an active heat exchanger having the one or more heat transfer medium passageways for circulating the heat transfer medium for cooling or heating purposes.

In a 195th aspect, the battery pack of aspect 194, wherein each of the one or more active heat exchangers of the multi-layer battery stack is a battery cold plate that is configured to provide cooling or heating of the battery cells in operation.

In a 196th aspect, the battery pack of aspect 195, wherein each battery cold plate extends laterally beyond the battery cells on each of opposing sides of the battery pack to present a stack of battery cold plates that terminate adjacent a side wall of the battery pack enclosure and assist in protecting the battery cells from potential damage arising from a side impact event to the battery pack enclosure.

In a 197th aspect, the battery pack of aspect 188, wherein the battery pack enclosure is formed by a plurality of enclosure parts joined together.

In a 198th aspect, the battery pack of aspect 197, wherein the enclosure parts include a plurality of side components joined together to form a tubular structure that circumferentially surrounds the multi-layer battery stack.

In a 199th aspect, the battery pack of aspect 198, wherein each of the plurality of side components are structural extrusions having a constant cross-sectional profile over a longitudinal length thereof.

In a 200th aspect, the battery pack of aspect 198, wherein the enclosure parts include opposing end parts removably coupleable to the tubular structure formed by the plurality of side components to enclose the multi-layer battery stack.

In a 201st aspect, the battery pack of aspect 200, wherein the opposing end parts sealingly engage with a respective one of opposing mating interfaces at longitudinal ends of the tubular structure formed by the plurality of side components to seal the multi-layer battery stack within the battery pack enclosure.

In a 202nd aspect, the battery pack of aspect 201, wherein each of the opposing mating interfaces are provided with dual sealing surfaces to provide redundant sealing between each of the opposing end parts and the opposing mating interfaces at longitudinal ends of the tubular structure formed by the plurality of side components.

In a 203rd aspect, the battery pack of aspect 188, further comprising:
a battery pack rack including a plurality of rack members, wherein each battery module layer is secured to a respective rack member, and wherein the rack members are coupled directly to the battery pack enclosure.

In a 204th aspect, the battery pack of aspect 188, wherein the battery enclosure includes a plurality of rack members formed integrally therewith, and wherein each battery module layer is secured to a respective pair of rack members.

In a 205th aspect, the battery pack of aspect 188, wherein the rack members are arranged and spaced to apply a compressive load on the battery module layers to assist in maintaining the battery module layers of the multi-layer battery stack in thermal contact with each other.

In a 206th aspect, the battery pack of aspect 188, wherein the one or more crumple zones are formed by a shell structure with a curved or tapered outer surface to increase a volume of the one or more crumple zones proximate a major side of the multi-layer battery stack.

In a 207th aspect, the battery pack of aspect 206, wherein the curved or tapered outer surface has a vertex corresponding to a centerline through the major side of the multi-layer battery stack.

In a 208th aspect, the battery pack of aspect 188, wherein each of the one or more crumple zones has a volume proximate peripheral edges thereof that is different from a volume proximate a center of the crumple zone.

In a 209th aspect, the battery pack of aspect 188, wherein the multi-layer battery stack is disposed in direct contact with a surface of the battery pack enclosure underlying the multi-layer battery stack, and wherein at least one major side surface of battery pack enclosure is spaced from the multi-layer battery stack.

In a 210th aspect, the battery pack of aspect 188, wherein the battery pack enclosure comprises a shell with two spaced apart layers joined together by a plurality of structural supports to define one or more air gaps between the two layers corresponding to the one or more crumple zones.

In a 211th aspect, the battery pack of aspect 210, wherein the battery pack enclosure further includes end parts removably coupleable to the shell, wherein each end part includes dual sealing surfaces to provide redundant sealing between each of the end parts and the two layers of the shell.

In a 212th aspect, the battery pack of aspect 210, wherein the plurality of structural supports are arranged normal to the two layers of the shell.

In a 213th aspect, the battery pack of aspect 210, wherein the shell includes a plurality of distinct shell portions joined together to form the shell.

In a 214th aspect, the battery pack of aspect 213, wherein each of the plurality of distinct shell portions include a respective plurality of structural supports that are spaced equidistant from each other across the respective distinct shell portion.

In a 215th aspect, the battery pack of aspect 214, wherein structural supports proximate peripheral edges of each distinct shell portion are positioned closer to each other than structural supports proximate a center of each distinct shell portion to increase a structural strength of the shell proximate the peripheral edges of each distinct shell portion and define the one or more crumple zones proximate the center of each distinct shell portion.

In a 216th aspect, the battery pack of aspect 188, wherein each battery cell is provided in a form factor having a generally rectangular prismatic shape with an aspect ratio of cell length to cell height of between 3:1 to 6:1.

In a 217th aspect, the battery pack of aspect 188, wherein each battery cell is provided in a form factor having a generally rectangular prismatic shape with an aspect ratio of cell length to cell height of between 1:1 to 2:1.

In a 218th aspect, the battery pack of aspect 188, wherein each battery cell is provided in a form factor having a generally rectangular prismatic shape with a cell length of 520±50 mm, a cell height of 125±10 mm, a cell thickness of 20±5 mm.

In a 219th aspect, the battery pack of aspect 188, wherein each battery cell is provided in a form factor having a generally rectangular prismatic shape with a cell length of 175±50 mm, a cell height of 150±20 mm, a cell thickness of 45±5 mm.

In a 220th aspect, a battery pack is provided, comprising: a plurality of battery cells arranged in an array to form a battery array; at least one thermal management device associated with the battery array; and a battery pack enclosure in which the battery array and the thermal management device are accommodated, the battery pack enclosure including: an enclosure tray to which the battery array is fixedly mounted, the enclosure tray including a tray floor and tray sidewalls extending upwardly from the tray floor to define an internal tray cavity, and the enclosure tray further including a sealing interface around a perimeter of the tray sidewalls at a mouth of the enclosure tray; and an enclosure cover configured to mate with the enclosure tray at the sealing interface to enclose the battery array in a sealed manner, the enclosure cover comprising an upper cover portion integrally joined with a lower cover portion, the lower cover portion including a corresponding sealing interface to mate with the sealing interface of the enclosure tray, and wherein a rigidity of the lower cover portion in a vicinity of the sealing interface exceeds a rigidity of the upper cover portion in a vicinity of an interface between the upper cover portion and the lower cover portion.

In a 221st aspect, the battery pack of aspect 220, wherein the interface between the upper cover portion and the lower cover portion of the enclosure cover is characterized by a weld seam.

In a 222nd aspect, the battery pack of aspect 221, wherein the weld seam between the upper cover portion and the lower cover portion of the enclosure cover is offset from the corresponding sealing interface of the lower cover portion by a distance sufficient to avoid appreciable thermal distortion of a sealing surface of the corresponding sealing interface.

In a 223rd aspect, the battery pack of aspect 222, wherein the weld seam is offset from the corresponding sealing interface of the lower cover portion by at least 100 mm.

In a 224th aspect, the battery pack of aspect 220, wherein a gasket is provided between the sealing interface of the tray enclosure and the corresponding sealing interface of the lower cover portion of the enclosure cover.

In a 225th aspect, the battery pack of aspect 224, wherein at least one of the sealing interface of the enclosure tray and the corresponding sealing interface of the lower cover portion of the enclosure cover includes a trench formed therein for receiving the gasket.

In a 226th aspect, the battery pack of aspect 220, wherein the enclosure cover is devoid of any electrical connectors, fittings or interfaces or fluid connectors, fittings or interfaces.

In a 227th aspect, the battery pack of aspect 220, wherein the battery pack enclosure includes one or more electrical connectors, fittings or interfaces for electrical power or signal transmission, and wherein all of the one or more electrical connectors, fittings or interfaces are coupled directly to the enclosure tray such that all electrical connections for the battery pack may be carried out via the enclosure tray.

In a 228th aspect, the battery pack of aspect 220, wherein the battery pack enclosure includes one or more fluid connectors, fittings or interfaces for heat transfer medium transmission, and wherein all of the one or more fluid connectors, fittings or interfaces are coupled directly to the enclosure tray such that all fluid connections for the battery pack may be carried out via the enclosure tray.

In a 229th aspect, the battery pack of aspect 220, wherein the upper cover portion and the lower cover portion of the enclosure cover define an internal cover cavity with a volume greater than a volume of the internal tray cavity to accommodate a majority of the battery array.

In a 230th aspect, the battery pack of aspect 220, wherein the interface between the upper cover portion and the lower cover portion of the enclosure cover is positioned closer to the sealing interface of the lower cover portion than to an outermost surface of the upper cover portion.

In a 231st aspect, a battery pack is provided, comprising: a plurality of battery module layers stacked in a vertical direction to form a multi-layer battery stack, each battery module layer including a plurality of battery cells arranged in a linear array, and each battery cell including a vent valve located on an end face thereof; and a battery pack frame including a plurality of frame members, wherein each battery module layer is secured to a respective frame member; and a plurality of vent isolators, each vent isolator associated with a respective one of the battery module layers and configured to assist in isolating discharged matter from the vent valve of any one of the battery cells of the battery module layer from the vent valves of battery cells of other battery module layers and to assist in directing the discharged matter away from the end face of the battery cell.

In a 232nd aspect, the battery pack of aspect 231, wherein each vent isolator is coupled to a respective one of the frame members.

In a 233rd aspect, the battery pack of aspect 231, wherein each vent isolator is integrally formed with a respective one of the frame members.

In a 234th aspect, the battery pack of aspect 231, wherein each vent isolator spans a series of the battery cells of the battery module layer, and includes a linear array of vent apertures with each vent aperture being aligned with a respective one of the vent valves of the series of the battery cells of the battery module layer.

In a 235th aspect, the battery pack of aspect 234, wherein each vent isolator includes a separator or wall of material between adjacent vent apertures to assist in preventing discharged matter from one of the vent valves associated with the adjacent vent apertures from directly impacting the other one of the vent valves associated with the adjacent vent apertures.

In a 236th aspect, the battery pack of aspect 234, wherein each vent aperture defines at least a portion of a guide, conduit or passageway that assists in routing discharged matter away from the vent valve associated with the vent aperture and away from the end face of the battery cell.

In a 237th aspect, the battery pack of aspect 236, wherein the at least a portion of the guide, conduit or passageway defined by each vent aperture assists in routing discharged matter toward a debris collection space provided adjacent the battery pack frame at a periphery of the battery pack.

In a 238th aspect, the battery pack of aspect 231, further comprising: for each battery module layer, one or more debris dams that assist in holding at least some of the linear array of battery cells in place and that assist in protecting at least a portion of each end face of those battery cells.

In a 239th aspect, the battery pack of aspect 231, wherein the one or more debris dams are shaped to direct debris away from each end face of the at least some of the linear array of battery cells.

In a 240th aspect, the battery pack of aspect 231, wherein the one or more debris dams are shaped to direct debris toward a debris collection space provided adjacent the battery pack frame at a periphery of the battery pack.

In a 241st aspect, the battery pack of aspect 231, further comprising: a battery pack enclosure surrounding the multi-layer battery stack and the battery pack frame, and wherein the battery pack frame is coupled to the battery pack enclosure with a debris collection space formed at a periphery of the multi-layer battery stack to receive debris upon a discharge of debris from one or more of the vent valves.

In a 242nd aspect, the battery pack of aspect 241, wherein the debris collection space is elongated and spans an entirety or substantially an entirety of a longitudinal length of the linear array of the battery cells of each battery module layer.

In a 243rd aspect, the battery pack of aspect 241, wherein the debris collection space is provided between the battery pack frame and the battery pack enclosure.

In a 244th aspect, the battery pack of aspect 241, wherein the debris collection space is provided at one or both of opposing ends of the battery pack to collect debris after the debris passes between the battery module layers of the multi-layer battery stack.

In a 245th aspect, the battery pack of aspect 241, wherein at least a portion of a surface area of the battery pack enclosure in a vicinity of the vent valves of the battery cells is covered with a fire retardant material.

In a 246th aspect, the battery pack of aspect 231, wherein at least a portion of a surface area of the end face of each battery cell is covered with a fire retardant material.

In a 247th aspect, the battery pack of aspect 231, wherein, for each battery module layer, the battery cells are arranged with vents thereof positioned on one or more of opposing sides of the battery module layer.

In a 248th aspect, the battery pack of aspect 231, wherein, for each battery module layer, the battery cells are arranged with vents thereof aligned in a stacking direction of the battery module layers.

In a 249th aspect, the battery pack of aspect 231, wherein each battery cell is provided in a form factor having a generally rectangular prismatic shape with an aspect ratio of cell length to cell height of between 3:1 to 6:1.

In a 250th aspect, the battery pack of aspect 231, wherein each battery cell is provided in a form factor having a generally rectangular prismatic shape with an aspect ratio of cell length to cell height of between 1:1 to 2:1.

In a 251st aspect, the battery pack of aspect 231, wherein each battery cell is provided in a form factor having a generally rectangular prismatic shape with a cell length of 520±50 mm, a cell height of 125±10 mm, a cell thickness of 20±5 mm.

In a 252nd aspect, the battery pack of aspect 231, wherein each battery cell is provided in a form factor having a generally rectangular prismatic shape with a cell length of 175 mm±50 mm, a cell height of 150±20 mm, and a cell thickness of 45±5 mm.

In a 253rd aspect, the battery pack of aspect 231, wherein the discharged matter is a hot gas with entrained debris.

In a 254th aspect, the battery pack of aspect 231, wherein each of the plurality of vent isolators are bare metal.

In a 255th aspect, the battery pack of aspect 231, wherein each of the plurality of vent isolators include a fire retardant coating.

In a 256th aspect, the battery pack of aspect 231, wherein each of the plurality of battery cells are coated with a fire retardant material.

In a 257th aspect, the battery pack of aspect 231, further comprising: a fire retardant material associated with at least some of the plurality of vent isolators or at least some of the plurality of battery cells, or both.

In a 258th aspect, a battery pack is provided, comprising: a plurality of battery module layers stacked to form a multi-layer battery stack, each battery module layer including a plurality of battery cells, and each battery cell including a vent valve located on an end face thereof; and at least one vent isolator, each vent isolator associated with a respective one of the battery module layers and configured to assist in isolating discharged matter from the vent valve of any one of the battery cells of the battery module layer from the vent valves of other battery cells and to assist in directing the discharged matter away from the end face of the battery cell.

In a 259th aspect, the battery pack of aspect 258, wherein the plurality of battery cells includes a plurality of rows and columns of prismatic battery cells in each battery module layer.

In a 260th aspect, the battery pack of aspect 259, wherein the at least one vent isolator includes one vent isolator associated with each row of battery cells and corresponding vent valves in the row.

In a 261st aspect, the battery pack of aspect 258, wherein each vent isolator includes a pair of spaced apart rails and a top plate disposed on the pair of spaced apart rails to define a debris collection space that assists with directing the discharged matter away from the end face of the battery cells.

In a 262nd aspect, the battery pack of aspect 261, wherein each vent isolator further includes a bottom plate including a plurality of apertures corresponding to the vent valves of the respective battery cells associated with each vent isolator.

In a 263rd aspect, the battery pack of aspect 258, wherein the end face of each battery cell is a top face of each battery cell.

In a 264th aspect, the battery pack of aspect 258, wherein each battery module layer includes the plurality of battery cells arranged in rows, and the at least one vent isolator includes vent isolators associated with each row of battery cells, each vent isolator configured to assist in isolating discharged matter from the vent valve of any one of the battery cells in a row from the vent valves of other battery cells in other rows of the same battery module layer.

In a 265th aspect, the battery pack of aspect 258, wherein a length of each at least one vent isolator is greater than a width of each of the battery cells.

In a 266th aspect, a battery pack is provided, comprising: a plurality of battery module layers stacked to form a multi-layer battery stack, each battery module layer including a plurality of battery cells arranged in an array, and each battery cell including a vent valve configured to discharge matter upon a fault condition of the battery cell; a battery pack enclosure surrounding the multi-layer battery stack; at least one sensor provided within the battery pack enclosure and operable to detect a change in at least one characteristic of the battery pack enclosure over time associated with discharged matter from the vent valve of at least one of the battery cells during a thermal runaway event; and a status indicator in communication with the at least one sensor operable to provide at least one warning indication in response to the detected change in the at least one characteristic over time in the battery pack enclosure associated with discharged matter from the vent valve of at least one of the battery cells via the at least one sensor.

In a 267th aspect, the battery pack of aspect 266, further including an air gap between the multi-layer battery stack and the battery pack enclosure, the at least one sensor being a pressure sensor and the at least one characteristic being pressure, the pressure sensor operable to detect a change in pressure of the air gap over time.

In a 268th aspect, the battery pack of aspect 267, wherein the status indicator is operable to provide the at least one warning indication in response to the change in pressure over time in the battery pack enclosure exceeding a threshold rate.

In a 269th aspect, the battery pack of aspect 268, wherein the threshold rate is between and including 50 Pascals per second and 150 Pascals per second.

In a 270th aspect, the battery pack of aspect 268, wherein the status indicator is operable to provide the at least one warning indication in response to the change in pressure over time in the battery pack enclosure exceeding the threshold rate for at least a threshold duration.

In a 271st aspect, the battery pack of aspect 270, wherein the threshold duration is at least 3 seconds.

In a 272nd aspect, the battery pack of aspect 270, wherein the status indicator is operable to not provide the at least one warning indication in response to the change in pressure over time in the battery enclosure less than the threshold rate, or greater than the threshold rate but for less than the threshold duration.

In a 273rd aspect, the battery pack of aspect 266, wherein at least one sensor is a pressure sensor and the at least one characteristic is pressure, and wherein the status indicator is operable to not provide the at least one warning indication in response to variations in pressure over time associated with vibration or operational temperature of the multi-layer battery stack, or both.

In a 274th aspect, the battery pack of aspect 266, wherein the at least one warning indication is a haptic signal, a visual alert, an auditory alert, or any combination thereof.

In a 275th aspect, the battery pack of aspect 266, wherein the battery pack enclosure includes a relief valve configured to expel pressure accumulated in the battery pack enclosure that exceeds a threshold enclosure pressure.

In a 276th aspect, the battery pack of aspect 275, wherein the relief valve is configured to expel pressure accumulated in the battery pack enclosure upon detection of one or more thermal runaway events via the pressure sensor.

In a 277th aspect, the battery pack of aspect 266, wherein the at least one sensor is a pressure sensor and the at least one characteristic is pressure, the pressure sensor operable to distinguish between changes in pressure over time in the battery cell enclosure associated with vibration, temperature of the multi-layer battery stack, or both, and changes in pressure over time associated with the discharged matter from the vent valve of the at least one of the battery cells.

In a 278th aspect, the battery pack of aspect 266, wherein the at least one characteristic is pressure, and the change in pressure over time associated with the discharged matter from the vent valve of the at least one of the battery cells corresponds to a sudden change in pressure rate over a short time.

In a 279th aspect, the battery pack of aspect 278, wherein the sudden change in pressure rate is at least 50 Pascals per second and the short time is between and includes 3 seconds and 5 seconds.

In a 280th aspect, the battery pack of aspect 266, wherein each battery cell is provided in a form factor having a generally rectangular prismatic shape with an aspect ratio of cell length to cell height of between 3:1 to 6:1.

In a 281st aspect, the battery pack of aspect 266, wherein each battery cell is provided in a form factor having a generally rectangular prismatic shape with a cell length of 520±50 mm, a cell height of 120±10 mm, a cell thickness of 15±5 mm.

In a 282nd aspect, the battery pack of aspect 266, further including an air gap between the multi-layer battery stack and the battery pack enclosure, the at least one sensor being a gas sensor and the at least one characteristic being gas concentration, the gas sensor operable to detect a change in gas concentration of the air gap.

In a 283rd aspect, the battery pack of aspect 282, wherein the status indicator is operable to provide the at least one warning indication in response to the change in gas concentration in the battery pack enclosure exceeding a threshold concentration.

In a 284th aspect, the battery pack of aspect 283, wherein the status indicator is operable to not provide the at least one warning indication in response to the change in gas concentration in the battery enclosure being less than the threshold concentration.

In a 285th aspect, a method is provided, comprising: detecting a change in at least one characteristic over time in a space between a battery pack enclosure and a multi-layer battery stack in the battery pack enclosure with at least one sensor, the change in the at least one characteristic over time associated with discharged matter from a vent valve of at least one battery cell in the multi-layer battery stack during a thermal runaway event; and providing at least one warning indication with a status indicator in communication with the pressure sensor in response to the detected change in the at least one characteristic over time via the at least one sensor.

In a 286th aspect, the method of aspect 285, wherein the multi-layer battery stack includes a plurality of battery module layers stacked together with each battery module layer including a plurality of battery cells arranged in an array, and each battery cell including the vent valve configured to discharge matter upon a fault condition of the battery cell.

In a 287th aspect, the method of aspect 285, wherein the at least one sensor is a pressure sensor and the at least one characteristic is a pressure, and wherein the providing the at least one warning indication with the status indicator includes providing the at least one warning indication in response to a detected change in pressure rate that exceeds a threshold rate for at least a threshold duration.

In a 288th aspect, the method of aspect 287, wherein the threshold rate is between and including 50 Pascals per second and 150 Pascals per second.

In a 289th aspect, the method of aspect 287, wherein the threshold duration is between and including 3 second and 5 seconds.

In a 290th aspect, the method of aspect 287, wherein the at least one sensor is a pressure sensor and the at least one characteristic is a pressure, the method further comprising: not providing the at least one warning indication with the status indicator in response to a change in pressure less than the threshold rate, or less than the threshold duration.

In a 291st aspect, the method of aspect 285, wherein the at least one sensor is a pressure sensor and the at least one characteristic is a pressure, the method further comprising: not providing the at least one warning indication with the status indicator in response to variations in pressure associated with vibration or operational temperature of the multi-layer battery stack, or both.

In a 292nd aspect, the method of aspect 285, wherein at least one sensor is a pressure sensor and the at least one characteristic is a pressure, and wherein the providing the at least one warning indication with the status indicator includes providing the at least one warning indication in response to a detected change in pressure rate over a threshold value.

In a 293rd aspect, the method of aspect 285, further comprising: expelling pressure accumulated in the battery pack enclosure with a relief valve upon exceeding a threshold enclosure pressure.

In a 294th aspect, the method of aspect 285, further comprising: expelling pressure accumulated in the battery pack enclosure with a relief valve in response to detecting the thermal runaway event via the pressure sensor.

In a 295th aspect, the method of aspect 285, wherein the at least one sensor is a gas sensor and the at least one characteristic is a gas concentration, the detecting the change in the at least one characteristic over time including detecting a change in gas concentration of the air gap.

In a 296th aspect, the method of aspect 295, wherein the providing the at least one warning indication with the status indicator includes providing the at least one warning indication in response to the change in gas concentration in the battery pack enclosure exceeding a threshold concentration.

In a 297th aspect, the method of aspect 296, further comprising: not providing the at least one warning indication in response to the change in gas concentration in the battery enclosure being less than the threshold concentration.

### Additional Considerations

The devices, systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

Moreover, although aspects of the various embodiments have been described in the context of battery packs for commercial vehicles, such as long-haul tractors, it is appreciated that aspects of the embodiments of the battery packs and battery pack technology described herein, may be applicable to other applications, including, for example, personal vehicles and heavy duty industrial equipment.

In general, in the following claims, the terms used should not be construed to limit the claims to the specific embodiments disclosed in the specification and the claims, but should be construed to include all possible embodiments along with the full scope of equivalents to which such claims are entitled.

1. A method of regulating temperature of a battery pack that includes a plurality of battery cells arranged in an array and at least one heat exchanger associated with the array of battery cells, the method comprising:
supplying a heat exchange medium to the at least one heat exchanger in a first flow direction through a heat exchange passageway of the at least one heat exchanger such that a first subset of the battery cells located proximate to a first end of the heat exchange passageway is exposed to the heat exchange medium prior to a second subset of the battery cells located proximate to a second end of the heat exchange passageway; and
subsequently, supplying the heat exchange medium to the at least one heat exchanger in a second flow direction through the heat exchange passageway in an opposite direction of the first flow direction such that the second subset of the battery cells located proximate to the second end of the heat exchange passageway is exposed to the heat exchange medium prior to the first subset of the battery cells located proximate to the first end of the heat exchange passageway.

2. The method of claim 1, wherein the supplying of the heat exchange medium to the at least one heat exchanger in the first flow direction and the subsequent supplying of the heat exchange medium to the at least one heat exchanger in the second flow direction are periodically repeated to assist in balancing an average temperature to which each of the first subset of the battery cells and the second subset of the battery cells are exposed during operation.

3. The method of claim 1, wherein the supplying of the heat exchange medium to the at least one heat exchanger in the first flow direction and the subsequent supplying of the heat exchange medium to the at least one heat exchanger in the second flow direction is performed by a pump operating in a common direction and wherein a direction of flow through the heat exchange passageway is switchable by actuation of one or more control valves of a heat exchange medium supply system.

4. The method of claim 1, wherein the supplying of the heat exchange medium to the at least one heat exchanger in the first flow direction and the subsequent supplying of the heat exchange medium to the at least one heat exchanger in the second flow direction is performed without changing a pump's operation and wherein a direction of flow through the heat exchange passageway is switchable by actuation of one or more control valves of a heat exchange medium supply system.

5. The method of claim 1, wherein the supplying of the heat exchange medium to the at least one heat exchanger in the first flow direction and the subsequent supplying of the heat exchange medium to the at least one heat exchanger in the second flow direction are each carried out alternately over an extended period of time.

6. The method of claim 5, wherein the extended period of time exceeds 30 minutes, 1 hour, 2 hours, 3 hours, 4 hours, 5 hours, 6 hours, 8 hours, 10 hours, 12 hours, 24 hours, 36 hours or 48 hours, and/or is less than 1 hour, 2 hours, 3 hours, 4 hours, 5 hours, 6 hours, 8 hours, 10 hours, 12 hours, 24 hours, 36 hours or 48 hours.

7. The method of claim 1, wherein two or more pumps supply the heat exchange medium in opposite directions and the pumps are operated alternately to supply the heat exchange medium to the at least one heat exchanger.

8. The method of claim 1, wherein the battery pack includes a plurality of battery module layers that are stacked in a vertical direction, each battery module layer including a respective plurality of battery cells arranged in a planar array and a respective heat exchanger, and wherein the heat exchange passageway extends through each of the heat exchangers of the battery module layers.

9. The method of claim 8, wherein the first subset of the battery cells is located in a lowermost one of the battery module layers, and the second subset of the battery cells is located in an uppermost one of the battery module layers, or
wherein the first subset of the battery cells is located in an uppermost one of the battery module layers, and the second subset of the battery cells is located in a lowermost one of the battery module layers.

10. The method of claim 1, further comprising:
monitoring a temperature profile of the battery pack; and
switching from the supplying of the heat exchange medium to the at least one heat exchanger in the first flow direction to the supplying of the heat exchange medium to the at least one heat exchanger in the second flow direction based at least in part on said monitoring.

11. The method of claim 1, wherein the monitoring of the temperature profile of the battery pack includes measuring a temperature of the battery pack proximate to the battery cells at the first end of the heat exchange passageway and measuring a temperature of the battery pack proximate to the battery cells at the second end of the heat exchange passageway.

12. The method of claim 1, wherein the supplying of the heat exchange medium in a first flow direction and the supplying of the heat exchange medium in the second flow direction are performed alternately by a single bi-directional pump.

13. A system, comprising:
a battery pack including a plurality of battery cells arranged in an array and at least one heat exchanger, and wherein a heat exchange passageway extends through the at least one heat exchanger; and
a heat exchange media supply system including one or more heat exchange media supply conduits and one or more multi-way valves for reconfiguring the heat exchange media supply system between a first supply configuration, in which the heat exchange media supply system is configured to supply a heat exchange medium through the heat exchange media passageway of the battery pack in a first flow direction, and a second supply configuration, in which the heat exchange media supply system is configured to supply the heat exchange medium through the heat exchange media passageway of the battery pack in a second flow direction opposite the first flow direction.

14. The system of claim 13, wherein, during operation with the heat exchange media supply system in the first supply configuration, a first subset of the battery cells located proximate to a first end of the heat exchange media passageway is exposed to the heat exchange medium prior to a second subset of the battery cells located proximate to a second end of the heat exchange media passageway, and wherein, during operation with the heat exchange media supply system in the second supply configuration, the second subset of the battery cells located proximate to the second end of the heat exchange media passageway is exposed to the heat exchange medium prior to the first subset of the battery cells located proximate to the first end of the heat exchange media passageway.

15. The system of claim 13, further comprising:
a controller operable to periodically actuate the one or more multi-way valves to reconfigure the heat exchange media supply system from the first supply configuration to the second supply configuration, and vice versa.

16. (canceled)

17. The system of claim 13, further comprising:
one or more temperature sensors associated with one or more battery cells of the battery pack for monitoring a temperature profile of the battery pack; and
a controller in communication with the one or more temperature sensors and including a memory configured to store instructions and at least one processor configured to execute the instructions to:
detect, via the one or more temperature sensors, whether a temperature of a first subset of the battery cells proximate a first end of the heat exchange media passageway exceeds a temperature of a second subset of the battery cells proximate a second end of the heat exchange media passageway by a threshold value over time; and
periodically actuate the one or more multi-way valves to reconfigure the heat exchange media supply system from the first supply configuration to the second supply configuration, and vice versa, in response to the detecting.

18. The system of claim 13, wherein the one or more multi-way valves are manually actuatable to selectively reconfigure the heat exchange media supply system from the first supply configuration to the second supply configuration, and vice versa.

19. The system of claim 13, wherein the battery pack includes a plurality of battery module layers that are stacked in a vertical direction, each battery module layer including a respective plurality of battery cells arranged in a planar array and a respective heat exchanger and wherein the heat exchange media passageway extends through each of the respective heat exchanger of the battery module layers.

20. The system of claim 13, wherein the system includes a single four-way valve for reconfiguring the heat exchange media supply system between the first supply configuration and the second supply configuration.

21. The system of claim 13, wherein the system includes exactly two multi-way valves for collectively reconfiguring the heat exchange media supply system between the first supply configuration and the second supply configuration.
